(19) United States
(12) Patent Application Publication
(10) Pub. No.: US 2025/0322372 A1
(43) Pub. Date: Oct. 16, 2025

(54) COMPENSATION FOR A SERVICE ASSOCIATED WITH A HUMANOID ROBOT WITH ADVANCED KINEMATICS

(71) Applicant: Figure AI Inc., Sunnyvale, CA (US)

(72) Inventors: Dana Berlin, Sunnyvale, CA (US); Victor Ragusila, Sunnyvale, CA (US); Brett Adcock, Sunnyvale, CA (US)

(21) Appl. No.: 19/038,657

(22) Filed: Jan. 27, 2025

Related U.S. Application Data
(60) Provisional application No. 63/625,362, filed on Jan. 26, 2024.
(60) Provisional application No. 63/625,370, filed on Jan. 26, 2024.
(60) Provisional application No. 63/625,381, filed on Jan. 26, 2024.
(60) Provisional application No. 63/625,384, filed on Jan. 26, 2024.
(60) Provisional application No. 63/625,389, filed on Jan. 26, 2024.
(60) Provisional application No. 63/625,405, filed on Jan. 26, 2024.
(60) Provisional application No. 63/625,423, filed on Jan. 26, 2024.
(60) Provisional application No. 63/625,431, filed on Jan. 26, 2024.
(60) Provisional application No. 63/626,105, filed on Jan. 29, 2024.
(60) Provisional application No. 63/556,102, filed on Feb. 21, 2024.
(60) Provisional application No. 63/626,039, filed on Feb. 21, 2024.
(60) Provisional application No. 63/558,373, filed on Feb. 27, 2024.
(60) Provisional application No. 63/632,683, filed on Apr. 11, 2024.
(60) Provisional application No. 63/633,113, filed on Apr. 12, 2024.
(60) Provisional application No. 63/633,405, filed on Apr. 12, 2024.
(60) Provisional application No. 63/685,856, filed on Aug. 22, 2024.
(60) Provisional application No. 63/700,749, filed on Sep. 29, 2024.

(51) Int. Cl. G06Q 20/08; B25J 11/00

(52) U.S. Cl. CPC G06Q 20/0855; B25J 11/008

(57) ABSTRACT

Various systems and methods are described for obtaining compensation for tasks performed by a humanoid robot, where the humanoid robot is associated with a first party. The method includes a first party providing a humanoid robot for use in an operating location. The humanoid robot engaged in performing a plurality of tasks at the operating location. A third party compensates the first party with a specified amount of currency for a pre-determined time interval during which said humanoid robot has engaged in performing the plurality of tasks at the operating location.

### CROSS-REFERENCE TO RELATED APPLICATIONS

This application claims the benefit of and priority to U.S. Provisional Patent Application Nos. 63/625,362, filed Jan. 26, 2024, 63/625,370, filed Jan. 26, 2024, 63/625,381, filed Jan. 26, 2024, 63/625,384, filed Jan. 26, 2024, 63/625,389, filed Jan. 26, 2024, 63/625,405, filed Jan. 26, 2024, 63/625,423, filed Jan. 26, 2024, 63/625,431, filed Jan. 26, 2024, 63/626,105, filed Jan. 26, 2024, 63/632,683, filed Apr. 11, 2024, 63/633,113, filed Apr. 12, 2024, 63/633,405, filed Apr. 12, 2024, 63/556,102, filed Feb. 21, 2024, 63/626,039, filed Feb. 21, 2024, 63/558,373, filed Feb. 27, 2024, 63/685,856, filed Aug. 22, 2024, 63/700,749, filed Sep. 29, 2024, each of which is expressly incorporated by reference herein in its entirety.

Reference is hereby made to: (i) U.S. patent application Ser. Nos. 18/919,263, 18/919,274, 19/006,191, 19/000,626, (ii) U.S. Provisional Patent Application Nos. 63/557,874, 63/626,040, 63/696,533, 63/696,507, 63/706,768, 63/614,499, 63/617,762, 63/561,315, 63/573,226, 63/615,766, 63/620,633, 63/626,028, 63/626,030, 63/626,034, 63/626,035, 63/626,037, 63/564,741, 63/707,547, 63/708,003, and (iii) PCT Patent Application Nos. PCT/US25/12544, PCT/US25/11450, PCT/US25/10425, each of which is expressly incorporated by reference herein in its entirety.

### TECHNICAL FIELD

This disclosure relates to methods for a first party to obtain compensation from a third party for providing a service that may include or be related to a humanoid robot.

### BACKGROUND

The current workplace landscape is marked by an unparalleled labor shortage, evident in over 10 million unsafe or undesirable jobs within the United States. To counter this ever-expanding labor shortage, it has become imperative to design and integrate advanced robots capable of handling unappealing and even hazardous workplace tasks. With the goal of performing these tasks in an optimal and efficient manner, advanced robots are typically general-purpose humanoid robots tailored for human-centric environments. These general-purpose humanoid robots emulate human form and functionality with two legs, two arms, and a face-like screen. With the general-purpose humanoid robot's emulation of the human body, arises the necessity for various actuators arranged within the robot to closely replicate human movements and capabilities.

### SUMMARY

The presently disclosed subject matter is directed to a method of obtaining compensation for tasks performed by a humanoid robot associated with a first party. The method comprises providing a humanoid robot by a first party for use in an operating location. The humanoid robot engages in performing a plurality of tasks at the operating location. A third party compensates the first party with a specified amount of currency for a pre-determined time interval during which said humanoid robot has engaged in performing the plurality of tasks at the operating location.

The presently disclosed subject matter is also directed to a method of obtaining compensation for tasks performed by a humanoid robot associated with a first party. The method comprises a first party manufacturing, assembling, or acquiring a humanoid robot. A third party compensates the first party with a specified amount of currency for each pre-determined time interval, regardless of usage. The presently disclosed subject matter is further directed to a method of obtaining compensation for tasks performed by a humanoid robot associated with a first party. The method comprises a first party manufacturing, assembling, or acquiring a humanoid robot. A third party compensates the first party with a specified amount of currency for each task performed by the humanoid robot.

In some embodiments, the method further comprises determining a completion level of the plurality of tasks, wherein when the humanoid robot fails to perform a given task, there are no payment penalties. In other embodiments, the amount of currency is pre-determined at a fixed price, set to the cost associated with obtaining another person or robot to perform the task, or is variable based on local supply and demand. In further embodiments, the method further comprises determining a completion level of the plurality of tasks, wherein when the humanoid robot fails to complete a portion of the plurality of tasks, no payment is due until the humanoid robot completes the portion of the plurality of tasks, or no payment is due for the predefined time period.

In other embodiments, the humanoid robot prioritizes upper body dexterity and a wide range of motion within a compact and energy-efficient design. For example, the torso may house the majority of the actuators for both arms. Additionally, each arm has at least three degrees of freedom, further enhanced by arm axes angled between 1 and 45 degrees relative to both the transverse and coronal planes. Further, the arms may include co-linear upper and lower arm twist axes for efficient rotation, an offset elbow axis for enhanced manipulation, and a strategically positioned singularity above the transverse plane for optimal reach.

In further embodiments, the head may include at least one camera for visual perception and has two degrees of freedom-head nod and head twist—for directing the camera. While the legs may be interchangeable with one another, each with at least three degrees of freedom and are connected to the torso via a pelvis and hip joints. The leg design may also be optimized for efficiency with the leg twist actuator positioned closer to the ground than the hip actuators, optimizing weight distribution and movement.

In additional embodiments, over 70% of the robot's degrees of freedom (DoF) are concentrated in the upper portion, including the head, neck, torso, arms, and hands. For example, the left hand alone may account for over 25% of the total DoF. The robot may also lack a dedicated spine pitch actuator, and it may have a battery housed within the torso that provides a minimum of 4 hours of operational time. Also, the robot utilizes at least 36 electric actuators with less than 8 different types, which simplifies maintenance and potentially reduces costs. In some embodiments, most actuators are not coupled to linkages, further streamlining the design. Finally, the robot's arm span exceeds its total height, suggesting a design optimized for interacting with and manipulating objects within its environment.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a schematic showing a robot that is configured to perform robot tasks at an operating location, a first party, a third party, and the exchange of currency between the first and third parties;

FIG. 2 illustrates a process of obtaining human collecting motion data that is associated with a given set of robot tasks and a kinematic map that may be created from said motion data;

FIG. 3 shows a top view of the kinematic map of the left and right arms of the robot, which includes an indication of a location of singularity of the arms;

FIG. 4 shows a side view of the robot and the kinematic map of FIG. 3;

FIG. 5 is a cross-sectional view of the robot and the kinematic map, taken along line 5-5 of FIG. 4;

FIG. 6 is a cross-sectional view of the robot and the kinematic map, taken along line 6-6 of FIG. 4;

FIG. 7 is a perspective view of a schematic showing the kinematic chains contained within the robot and the commonalities associated with each element of said kinematic chains;

FIG. 8 is a perspective view of an arrangement of cross-roller bearings that was generated from the kinematic chains of FIG. 7, wherein the axis of rotation of an individual actuator is centered within the cross-roller bearing and is perpendicular to a plane defined by the cross-roller bearing;

FIG. 9 is a perspective view of a first embodiment of a robot generated from the arrangement of cross-roller bearings shown in FIG. 8, and wherein said robot is in an extended position and includes: (i) an upper portion having the following parts: (a) a head/neck, (b) a torso, (c) left and right shoulders, (d) left and right upper arm assemblies that each include an upper humerus, lower humerus, upper forearms, and lower forearms, (e) left and right wrists, and (f) left and right hands, (ii) a central portion having the following parts: (a) a spine, (b) a pelvis, (c) left and right hips, (d) left and right upper thighs, and (f) left and right lower thighs, and (iii) a lower portion having the following parts: (a) a left and right shins, (b) left and right talus, and (c) left and right feet;

FIG. 10 is a front view of the kinematic chains contained within the robot and shown in FIG. 7;

FIG. 11 is a front view of the arrangement of cross-roller bearings contained within the robot and shown in FIG. 8;

FIG. 12 is a front view of the robot of FIG. 9 in the extended position;

FIG. 13 is a rear view of the robot of FIG. 9 in the extended position;

FIG. 14 is a side view of the kinematic chains contained within the robot and shown in FIG. 7;

FIG. 15 is a side view of the arrangement of cross-roller bearings contained within the robot and shown in FIG. 8;

FIG. 16 is a side view of the robot of FIG. 9 in an initial position;

FIG. 17 is a perspective view of the robot of FIG. 9 in an initial position;

FIG. 18 is a perspective view of an extent of the robot of FIGS. 9, 12, 13, showing the torso and left upper arm assembly;

FIG. 19 is a zoomed in top view of the left shoulder of the robot of FIGS. 9, 12, 13, wherein the shoulder actuator couples the arm assembly to the torso;

FIG. 20 is a zoomed in side view of the left shoulder of the robot of FIGS. 9, 12, 13;

FIG. 21 shows the kinematic chains contained in the arm assembly and that are shown in FIG. 7;

FIG. 22 is a schematic of the movement limits of the left arm actuator (J1) and left shoulder actuator (J2);

FIG. 23 is a top view of the cross-roller bearings contained in the left arm assembly of the robot of FIGS. 8, 11, 15, wherein said actuators include J1-J7;

FIG. 24 is a left side view of the cross-roller bearings of the actuators J1-J7 contained in the left arm assembly of the robot shown in FIGS. 8, 11, 15;

FIG. 25 is a frontal view of the cross-roller bearings of the actuators J1-J7 contained in the left arm assembly of FIG. 5, wherein said frontal view is modified to be normal to the bearing plane of actuator J2;

FIG. 26 is a cross-sectional view of the cross-roller bearings contained in the left arm assembly taken along line 26-26 in FIG. 25;

FIG. 27 is a top view of the cross-roller bearings of the actuators J1-J7 contained in the left arm assembly of FIG. 5, wherein said top view is modified to be tangent to the bearing plane of actuator J2;

FIG. 28 is a cross-sectional view of the cross-roller bearings contained in the left arm assembly taken along line 28-28 in FIG. 27;

FIG. 29 is a top view of the torso and upper arm assemblies of FIG. 18, where the left arm actuator (J1) is rotated to a maximum position;

FIG. 30 is a front view of the torso and upper arm assemblies of FIG. 29;

FIG. 31 is a top view of the torso and upper arm assemblies of FIG. 18, where the left arm actuator (J1) is rotated to a minimum position;

FIG. 32 is a front view of the torso and upper arm assemblies of FIG. 31;

FIG. 33 is a top view of the torso and upper arm assemblies of FIG. 18, where the left shoulder actuator (J2) is rotated to a maximum position;

FIG. 34 is a front view of the torso and upper arm assemblies of FIG. 33;

FIG. 35 is a top view of the torso and upper arm assemblies of FIG. 18, where the left shoulder actuator (J2) is rotated to a minimum position;

FIG. 36 is a front view of the torso and upper arm assemblies of FIG. 35;

FIG. 37 is a front view of a second embodiment of an upper portion of the robot, which shows a kinematic map of the left arm of said robot;

FIG. 38 is a schematic of the movement limits of the left arm actuator (J1) and left shoulder actuator (J2) of the second embodiment of the robot shown in FIG. 37;

FIGS. 39-40 show the second embodiment of an upper portion of the robot and the associated singularity cone;

FIGS. 41-42 show a third embodiment of an upper portion of the robot and the associated singularity cone;

FIGS. 43-44 show a fourth embodiment of an upper portion of the robot and the associated singularity cone;

FIG. 45 is a lower perspective view that zoomed in on the central portion of the first embodiment of the robot of FIG. 1;

FIG. 46 is a front view of the central portion of the robot of FIG. 45;

FIG. 47 is a side view of the central portion of the robot of FIG. 45;

FIG. 48 is a front view of a portion of the robot of FIG. 1 in the extended position;

FIG. 49 is a side view of the portion of the robot of FIG. 48;

FIG. 50 shows the kinematic chains contained in the leg assembly and that are shown in FIG. 7;

FIG. 51 is a schematic of the movement limits of the hip flex actuator (J11) and hip pivot actuator (J12) of the robot shown in FIGS. 45-49;

FIG. 52 is a side view of the cross-roller bearings of the actuators J9-J14 and J16 of the central portion and left leg of the robot of FIG. 5;

FIG. 53 is a front view of the cross-roller bearings of the central portion and left leg of the robot of FIG. 52;

FIG. 54 is a schematic side view of the ranges of motion of the robot as said robot articulates its leg between the positions shown in FIGS. 55-58;

FIG. 55 is a side view of the portion of the robot of FIG. 49, and wherein the left leg is in a fully retracted posterior configuration;

FIG. 56 is a front view of the portion of the robot of FIG. 55;

FIG. 57 is a side view of the portion of the robot of FIG. 49, and wherein the left leg is a fully extended anteriorly configuration;

FIG. 58 is a front view of the portion of the robot of FIG. 57;

FIG. 59 is a schematic front view of the ranges of motion of the robot as said robot articulates its leg between the positions shown in FIGS. 60-61;

FIG. 60 is a front view of the portion of the robot of FIG. 49, and wherein the left leg is fully extended medially and the right leg is fully extended laterally;

FIG. 61 is a front view of the portion of the robot of FIG. 49, and wherein the left leg is a fully extended lateral configuration;

FIG. 62 is a front view of the portion of the robot of FIG. 49, and wherein the left leg is in a fully rotated medial configuration;

FIG. 63 is a front view of the portion of the robot of FIG. 49, and wherein the leg is in a fully rotated lateral configuration;

FIG. 64 is a bottom view of the portion of the robot of FIG. 49, wherein the left leg is in a partially rotated medial configuration;

FIG. 65 is a bottom view of the portion of the robot of FIG. 62;

FIG. 66 is a bottom view of the portion of the robot of FIG. 49, wherein the left leg is in a partially rotated lateral configuration;

FIG. 67 is a bottom view of the portion of the robot of FIG. 63;

FIG. 68 is a front view of the portion of the robot of FIG. 49, and wherein said robot's torso is fully rotated to the right;

FIG. 69 is a top view of the portion of the robot of FIG. 68;

FIG. 70 is a front view of the portion of the robot of FIG. 49, and wherein said robot's torso is fully rotated to the left;

FIG. 71 is a top view of the portion of the robot of FIG. 70;

FIG. 72 is a side view of the portion of the robot of FIG. 49, and wherein said robot's torso is fully leaned to the right;

FIG. 73 is a front view of the portion of the robot of FIG. 72;

FIG. 74 is a front view of the portion of the robot of FIG. 49, and wherein said robot's torso is fully leaned to the left;

FIG. 75 is a side view of the portion of the robot of FIG. 74;

FIG. 76 is a perspective view of a schematic showing the kinematic chains contained within a second embodiment of the robot and commonalities associated with each element of said kinematic chains, and wherein an axis of the hip flex actuator J12 actuator is parallel (e.g., not angled) with the horizontal or transverse plane;

FIG. 77 is a rear perspective view of the kinematic chains of FIG. 76;

FIG. 78 is a side view of a lower portion of the second embodiment of the robot generated from the kinematic chains shown in FIGS. 76-77;

FIG. 79 is a front perspective view of the lower portion of the robot of FIG. 78;

FIG. 80 is a rear perspective view of the lower portion of the robot of FIG. 78;

FIG. 81 is a perspective view of a schematic showing the kinematic chains contained within a third embodiment of a leg assembly of a robot;

FIG. 82 is a perspective view of a schematic showing the kinematic chains contained within a fourth embodiment of a leg assembly of a robot;

FIG. 83 is a perspective view of a schematic showing the kinematic chains contained within a fifth embodiment of a leg assembly of a robot;

FIG. 84 is a perspective view of a schematic showing the kinematic chains contained within a sixth embodiment of a leg assembly of a robot; and

FIG. 85 is a perspective view of a schematic showing the kinematic chains contained within a seventh embodiment of a leg assembly of a robot.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, the drawings contained herewith are considered exemplary. As such, said drawings are not intended to limit the broad aspects of the disclosed concepts. As will be realized, the disclosed methods and systems are capable of other and different configurations, and several details are capable of being modified without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. In summary, the drawings, flow charts and detailed descriptions are to be regarded as illustrative in nature, not restrictive or limiting.

### 1. Introduction

The current workplace landscape is characterized by an unprecedented labor shortage, particularly evident in over 10 million unsafe or undesirable jobs across the United States. To address this growing labor deficit, there is a need for advanced robots capable of performing unappealing and hazardous workplace tasks. However, conventional robots may have limitations in their ability to operate effectively in human-centric environments. This creates a need for a first party to provide services to a third party that may include: (i) advanced robots capable of handling undesirable and hazardous tasks, or (ii) advanced robots capable of generating data that can be utilized to develop cutting-edge artificial intelligence models (e.g., LLMs, VLMs, VLAS, and/or BAMs) to enable these robots to operate autonomously in human-centric environments.

To provide these services, the first party may design, source, purchase, assemble, manufacture, operate, control, and/or own advanced robots. These robots may include general-purpose humanoid robots specifically tailored for human-centric environments. General-purpose humanoid robots may emulate the human form and functionality, featuring two legs, two arms, and a face-like screen. This emulation may necessitate the integration of various actuators within the robot to closely replicate human movements and capabilities. The requirement for actuators extends beyond cosmetic resemblance, as they enable the robot to manipulate its arms, legs, and other assemblies to interact seamlessly with diverse objects in complex environments.

The challenge of enabling humanoid robots to execute human-like movements and capabilities may be compounded by the vast array of potential positions, locations, and states the robot could occupy in a dynamic operating environment. These permutations can be reduced through training methodologies, such as: (i) imitation learning or teleoperation, (ii) supervised learning, (iii) unsupervised learning, (iv) reinforcement learning, (v) inverse reinforcement learning, (vi) regression techniques, or (vii) other established methods for robotic training. While training can help minimize these permutations, improper or non-optimal configurations of parts, assemblies, and components may negate the benefits of such training and could render the performance of specific tasks infeasible. Therefore, it may be beneficial to optimize the arrangements of parts, assemblies, and components, particularly within the robot's kinematic chains, to ensure that the humanoid robot can reliably replicate human movements and successfully perform a wide range of tasks. Without such optimized kinematic configurations, even advanced robots may fail to meet the operational requirements of the third party. Thus, the inclusion of at least one optimized component or assembly, such as a single actuator, a hand, or an arm, may be desired for the effective performance of the service.

In addition to optimized kinematic configurations, the third party may benefit from services that include a robot featuring high-precision actuators paired with real-time sensor feedback loops. These sensors may be designed to continuously monitor the robot's orientation, speed, and the force being exerted on its limbs. The data collected by these sensors can be processed by an advanced computing architecture to further train the neural networks that enable the robot to perform its tasks (e.g., enabling it to walk more like a human, climb stairs, or traverse uneven terrain with enhanced fluidity and stability) or said data may be used to train other neural networks that are designed to control different robots. Additionally, the disclosed advanced robots may also address technical challenges related to dexterity and object manipulation, thereby furthering the services provided by the first party. For example, the advanced robots may include end effectors that feature multi-jointed designs with a high number of degrees of freedom, which enables the execution of complex and precise movements. Additionally, tactile sensors may be embedded in the said end effectors to provide detailed feedback on pressure, texture, and temperature, which again can be used to train local or remote neural networks that can be used to provide better or additional services.

The third party may also benefit from services performed by a robot with a cutting-edge computer vision system, which may be equipped with depth perception and object recognition capabilities. By integrating such sensory data with artificial intelligence algorithms, the robot may learn from its experience, thereby improving its ability to grasp and manipulate a wide variety of objects over time. Predictive algorithms may also enable the robot to anticipate the behavior of dynamic objects, such as catching a ball in mid-air or interacting with moving conveyor belts in industrial settings.

Also, the services provided by the first party may be enhanced by the incorporation of human-robot interaction (HRI) capabilities within the robot. Equipped with auditory sensors and advanced natural language processing (NLP) algorithms, the robot may engage in verbal communication, and it may be capable of understanding and generating speech in multiple languages. The robot may also process contextual information to generate appropriate responses and detect emotional nuances in human speech, enabling more meaningful and context-aware interactions. Additionally, the robot may integrate non-verbal communication cues, such as gestures and block-based expressions displayed on its screen, to create more intuitive and human-like interactions. These features may make the robot highly adaptable to a variety of social environments, including classrooms, eldercare facilities, and hospitality settings.

Finally, the services provided by the first party may be advanced by ensuring that the robots include redundant systems to help ensure continuous operation in the event of a component failure. For example, systems such as balance control and power management may be supported by backup circuits and secondary control algorithms. Advanced diagnostic tools may continuously monitor the robot's components, predicting potential failures before they occur and initiating self-repair routines or alerting users to the issue. These safety measures, combined with the robot's robust energy management systems, may ensure reliable performance in diverse and demanding applications.

### 2. Compensation for Robot Services

Disclosed herein is a method 950 for obtaining compensation for services that are provided by a first party or robot lessor 952. The robot lessor 952 may serve as the designer, component purchaser, assembler, manufacturer, operator, controller, and/or owner of one or more humanoid robots 1a, 1b, 1c that are used to deliver or facilitate the provision of services. These services may involve the utilization of the humanoid robots 1a, 1b, 1c in various capacities under a “robot-as-a-service” model. Such a model enables the robot lessor 952, either individually or in collaboration with a third party 954, or a combination thereof, to define, manage, and deliver services that incorporate the capabilities of these humanoid robots 1a, 1b, 1c.

The service provided can encompass a wide range of robot tasks 962 performed by the one or more humanoid robots 1a, 1b, 1c. These robot tasks 962 may include a single robot task 962 or multiple robot tasks 962, which may include dangerous, routine, and/or repetitive actions. Unlike traditional automation systems, the robot tasks 962 may be dexterous, human-like tasks that demand advanced motor skills, environmental adaptability, and decision-making processes. Examples of such robot tasks 962 include, but are not limited to, assembling components (e.g., automotive parts) in a production line, welding, painting, precision machining, or operating heavy machinery. The robots may also assist in logistics 958 by gathering and packing items from storage bins 966, or by transporting items between storage and staging areas. They may also serve in customer service roles by providing real-time assistance to human customers, such as giving directions, answering queries, and facilitating checkout processes. In other commercial or retail settings, the robots may perform tasks such as stocking shelves, unloading delivery vehicles, conducting inventory counts, rearranging displays, and sanitizing high-touch surface areas. In non-industrial settings, the robot tasks 962 may include tidying up spaces, putting away groceries, cleaning, folding clothes, making beds, preparing meals, organizing closets, and/or setting tables.

The service that is provided by the first party 952 may also include data collection and processing. The humanoid robot(s) 1a, 1b, 1c, when executing robot tasks 962, may generate valuable data 970 through onboard sensors, cameras, and other data acquisition systems. This data 970, which may encompass touch, visual, spatial, operational, or behavioral metrics, can be processed and transferred to a centralized cloud server 972 via wired or wireless communication methods. The cloud server 972 may be controlled, leased, or owned by the first party 952. Alternatively, the data 970 can be transmitted directly to the third party's 954 proprietary cloud infrastructure 974. Such data can be used for various purposes, including performance optimization, predictive maintenance, or the development of new neural network-based models for the robot(s) 1a, 1b, 1c, or for other robots. The first party 952 may offer access to this data as part of its service package or as a separate, monetized offering.

In scenarios where the services provided by the humanoid robot(s) 1a, 1b, 1c do not align with the specific needs of the third party 954, the first party 952 can facilitate the customization of the robot's capabilities. This process may involve obtaining or generating new training datasets, refining the robot's artificial neural networks, and deploying updated control algorithms to enable new task execution. These updates can be pushed to the robot(s) through either wired or wireless methods. Compensation models for such customizations may vary, with the first party 952 charging an additional fee for the service or including the cost within broader agreements, such as leases, rentals, and/or maintenance contracts for the humanoid robot(s) 1a, 1b, 1c.

The operating location 958 where the robot 1a, 1b, 1c performs the robot task 962 can be owned, leased, rented, and/or controlled by the first party 952, the third party 954, or a combination thereof. The operating location 958 can encompass a variety of environments tailored to the specific nature of the robot tasks 962. Industrial locations may include warehouses, factories, distribution centers, construction sites, shipping docks, power plants, and mining facilities. Non-industrial locations may include houses, apartments, offices, schools, hospitals, retail stores, airports, train stations, hotels, entertainment venues, and public parks. Additionally, robots may be deployed in specialized environments such as research laboratories, space stations, and hazardous zones for disaster response or chemical spill containment.

To compensate the first party 952 for the provided services, the third party 954 may provide currency to the first party 952. The specific form of the currency and the basis for said currency are discussed in detail below. At a high level, the currency may be in the form of US dollars, cryptocurrency, or other forms of digital and physical monetary exchange. Payment structures may include: (i) a time-of-use model, where charges are based on the duration the robots 1a, 1b, 1c are in operation, (ii) a task-based model, where payment is determined by specific tasks or combinations of tasks performed by the robots 1a, 1b, 1c; (iii) a subscription payment model, which enables recurring payments for consistent access to robot services, (iv) a dynamic pricing model, where payments fluctuate based on demand, urgency, or other market factors, (v) a performance-based model, where compensation is tied to the efficiency, accuracy, or success rate of completed tasks, (vi) usage caps with overage payments, where predefined thresholds trigger additional charges for extended usage, (vii) fair market value agreements, ensuring competitive pricing based on industry standards, (viii) profit-sharing or royalty arrangements, where the first party 952 receives a percentage of profits generated by the services, (ix) hybrid models that combine multiple payment approaches to suit specific operational needs, and/or (x) any other similar or customized payment model. To facilitate these currency exchanges, the third party 954 may utilize a currency processor or digital transaction platform 978 to streamline the payment processing. The currency processor may handle tasks such as invoicing, payment verification, and the distribution of funds to the first party 952, ensuring secure and efficient financial transactions.

### 3. Compensation Methods

Below is a non-exhaustive list of compensation models that may be implemented in order for the first party to obtain compensation from the third party. It should be noted that other compensation models are contemplated by this discloser, including the methods disclosed within or the methods that can be derived from U.S. Provisional Applications 63/625,362, 63/625,370, 63/625,381, 63/625,384, 63/625,389, 63/625,405, 63/625,423, 63/625,431, 63/626,105, 63/632,683, 63/633,113, 63/633,405, 63/556,102, 63/626,039, 63/558,373, 63/685,856, 63/700,749, each of which is expressly incorporated by reference herein in its entirety.

a. Payment Per Worked Time Period

The time-of-use rental method provides a flexible, on-demand approach to obtaining a service in exchange for compensating the first party based on the duration the humanoid robot 1a, 1b, 1c is performing a robot task 962. This method typically leverages embedded monitoring systems, such as internal timers and usage logs, to calculate active engagement periods. The humanoid robot's software may integrate real-time tracking mechanisms to measure precise operational intervals, which ensures accurate billing. Key technical components for this model include high-precision internal clocks that are synchronized with external systems, potentially via network protocols such as NTP (Network Time Protocol). Additionally, the robot's operational data is securely stored in cloud platforms, which allows for detailed usage reporting and enhances billing transparency. Variations of this model include micro-time payments (e.g., may be implemented in performing domestic robot tasks 962 in home environments) based on hours or minutes or macro-time payments (e.g., may be implemented in performing industrial robot tasks 962 in a factory setting) based on shifts, days, weeks, or years. In other words, the duration of operation may be any time period that ranges from minutes to years. To enhance efficiency, humanoid robots may feature energy management systems that record power consumption during both active and idle states, enabling a more granular time-use analysis. Furthermore, machine learning algorithms can be used to analyze usage patterns to predict costs, optimize scheduling, and improve resource allocation by preemptively identifying downtime opportunities or peak usage periods. As an alternative, hybrid time-based models can integrate a capped maximum cost for extensive use or include discounts for off-peak operational periods to incentivize resource-efficient utilization.

The operational duration of humanoid robots 1a, 1b, and 1c may be estimated based on the requirements of various robot tasks 962. For example, their operation may align with a standard 8-hour work shift or extend to multiple 8-hour shifts (e.g., up to three shifts). Compensation for their operation is typically provided on a biweekly basis, aligning with standard labor payment practices. Specifically, the humanoid robots 1a, 1b, and 1c can operate continuously over a two-week period, after which the first party receives compensation from the third party for the robots' performance during that time frame. This compensation structure effectively aligns operational costs with the measurable outputs delivered by the robots 1a, 1b, and 1c.

The rate at which this compensation is calculated may vary depending on several factors. For instance, the two-week compensation rate could be based on the annual cost that would be incurred by the third party for employing: (i) a single employee to work a single shift, (ii) a single employee to work multiple shifts, or (iii) multiple employees to work multiple shifts. The calculation may also incorporate adjustments to account for cost savings, specific efficiencies, and other cost expenditures that are introduced by the use of robots. These savings may include reductions in overhead costs that are typically associated with human labor and not with robots, such as healthcare benefits, training expenses, and liability insurance. Additionally, the robots' specific efficiencies (e.g., continuous work or overtime pay) may further warrant additional compensation. However, the total compensation may be reduced by cost expenditures (e.g., space, energy consumption, etc.) typically associated with a robot and not with human labor.

Moreover, the compensation model may also include provisions for performance-based adjustments. For example, if the humanoid robot 1a, 1b, or 1c fails to complete a portion of its assigned tasks (e.g., placing sheet metal in a jig), payment may be withheld until the robot successfully completes the unfinished tasks or until a predefined time period has elapsed. This mechanism ensures accountability and incentivizes the proper maintenance and programming of the robots to achieve optimal performance. To further refine the payment structure, additional considerations may be made for factors such as task complexity, resource consumption, and the wear-and-tear incurred by the robots during their operation. For example, tasks that require highly precise manipulations or high energy consumption could incur higher operational costs, which may be factored into the overall compensation rate. Conversely, tasks with minimal mechanical strain or resource usage might be billed at a lower rate, reflecting the reduced operational demand placed on the robots.

b. Payment Per Completed Task

In the task-based service method, payments are determined by the completion of discrete tasks performed by the humanoid robot, such as object manipulation, assembly, or data collection. This method requires task-recognition algorithms embedded in the robot's software stack, combined with verification systems such as sensors, cameras, or external validation from a supervisory control system. For instance, a humanoid robot that is engaged in part placement would utilize advanced machine vision to detect object dimensions, placement zones, and other environmental variables, thereby ensuring precise execution of the task. Feedback from tactile or force sensors further ensures task accuracy by identifying successful engagement with objects or surfaces. To support billing accuracy, each completed task is tagged with a unique identifier and may be logged in a blockchain ledger for tamper-proof validation. Variations of this model include tiered pricing for complex tasks that involve multi-step processes or higher cognitive demands, such as those requiring natural language processing or autonomous navigation in unstructured environments. Task-based systems benefit from the modular nature of humanoid robot components, which enables seamless reconfiguration for different task profiles. Customizable task libraries and pre-trained AI models further enhance the versatility of this payment model. Modifications to this method could include a subscription-like task bundle for repetitive workflows or a dynamic task-based pricing system that is determined by environmental factors such as task density or complexity.

In various examples, the third party compensates the first party with a specified amount of currency for each individual task performed by the humanoid robot. For example, the amount of currency can be pre-determined at a fixed price, set to the cost associated with obtaining another person or robot to perform the same task, and/or may be variable based on local supply and demand. Below is a non-exhaustive list of tasks that may be provided by the first party, and how the compensation for said service may be calculated:
Household Cleaning Tasks: A humanoid robot performing household cleaning tasks, such as vacuuming, mopping, or organizing items, could be compensated on a basis of discrete tasks. For instance, a fixed amount may be charged for vacuuming a room, while a variable rate may apply for deep-cleaning tasks that require navigating cluttered spaces or recognizing fragile items using advanced object detection algorithms.
Healthcare Assistance: In a hospital or care home setting, the robot could be tasked with specific actions like delivering medication, assisting patients with mobility, or sanitizing equipment. Payments could be tiered based on task complexity, with a higher rate for tasks involving direct human interaction compared to routine deliveries or cleaning.
Retail Assistance: In a retail environment, the robot may assist with inventory management by scanning and restocking shelves, guiding customers to specific products, or even managing checkout processes. The pricing model could involve fixed rates for basic tasks (e.g., shelf scanning) and dynamic pricing for higher cognitive tasks, such as real-time customer interaction using natural language processing.
Construction Support: In a construction setting, humanoid robots could perform tasks such as bricklaying, measuring and cutting materials, or inspecting structural elements. Payments could reflect the complexity and precision of the task, with higher fees for precision work like welding or bolting compared to simpler tasks like material transportation.
Education and Training: A humanoid robot acting as a teaching assistant might engage in activities such as tutoring, answering student questions, or setting up classroom equipment. Payment could depend on the cognitive demand of the task, for example, a higher rate for personalized tutoring sessions compared to delivering pre-recorded lectures.
Entertainment and Events: A humanoid robot that is hired for events could greet guests, serve drinks, or engage in interactive entertainment such as dancing or storytelling. Payments could include fixed rates for standard entertainment routines and premium charges for customized performances that are tailored to specific event themes.
Security and Surveillance: The robot could be tasked to patrol premises, identify potential intrusions, or perform routine safety checks. Payment rates for such tasks might depend on the duration of the patrol, the area covered, or the complexity of the threat detection algorithms required for the task.
Scientific Research: In research laboratories, robots can assist with tasks such as setting up experiments, handling hazardous materials, or collecting data. Payments could be scaled based on the level of precision and reliability required for the tasks, such as operating in highly controlled environments versus dynamic or hazardous ones.
Logistics and Delivery: The robot could be utilized to handle package sorting, loading and unloading, or last-mile deliveries. Payment for these services could depend on factors such as delivery distance, package size, or environmental challenges like navigating crowded urban areas versus open warehouses.
   c. Subscription Payment

The subscription payment model involves recurring fees that are charged for access to robot services, often independent of usage frequency. The following provides various examples of subscription services that may be provided by the first party. For example, the subscription payment model may be a fixed-interval subscription that is set at a predetermined time interval (e.g., monthly, quarterly, or annually). For instance, a manufacturing plant may pay a flat monthly fee of $10,000 for robotic assembly-line support, which ensures that the robots remain available even during periods of production downtime. Alternatively, the subscription payment model may be a premium tier subscription that offers higher payment tiers which include enhanced features such as advanced AI capabilities, extended warranties, dedicated support, or real-time performance analytics. As an example, a logistics company might opt for a premium tier that provides predictive maintenance and on-demand technical support for a fee of $15,000 per month. Further, the subscription payment model may be a scalable subscription that is structured so that costs increase or decrease based on the number of robots deployed, with additional units being activated automatically to meet peak demand. A warehouse, for example, could operate with five robots during normal operations at a cost of $2,000 per robot per month and then scale up to ten robots during the holiday season, bringing the total monthly cost to $20,000 during those peak periods.

Alternatively, the subscription payment model may be based on flat-rate bundles that are combined with training services. This model combines robot access with periodic training and customization to improve efficiency for user-specific tasks. For instance, a school might subscribe to robots for a flat fee of $8,000 per quarter, a fee which includes quarterly updates to their teaching algorithms to align with curriculum changes. In another example, the subscription payment model may be based on long-term leases that include predictable upgrades, which would involve a fixed subscription payment over several years and include hardware upgrades at predefined intervals to ensure the robots remain up to date with the latest technology. A retail chain, for example, could lease humanoid robots for customer service at a rate of $12,000 per year per robot, with guaranteed upgrades to their conversational AI every two years. A further example may be a Pay-As-You-Go hybrid subscription that includes a base fee to guarantee robot availability, with additional charges applied for tasks that exceed a predefined usage limit. For example, an entertainment company might subscribe to a robot for regular daily performances at a base cost of $7,500 per month and pay an additional $500 per event for any unscheduled appearances. The subscription payment model may be based on a shared access model concept, which would allow multiple users to share a single subscription by coordinating their scheduling or usage through a shared platform. Small businesses in a co-working space, for instance, could collectively subscribe to a humanoid robot for tasks like reception and cleaning at a shared cost of $4,000 per month, which would then be divided among the participating businesses. Moreover, the subscription payment model may be based on a customizable SLA-backed subscription that provides service-level agreements (SLAs) guaranteeing specific uptime percentages, maintenance response times, and defined performance levels that are tailored to client needs. For example, a hospital might pay a premium subscription fee of $20,000 per month to ensure 99.9% uptime and a two-hour maintenance response time for robots used in patient care roles. Finally, the subscription payment model may utilize a free-tier and add-on model that offers basic robot capabilities at a low subscription rate, with optional paid add-ons available for more advanced features. For instance, A small business might subscribe to a basic robot for cleaning at a cost of $1,000 per month and then pay an additional $500 per month to unlock marketing or customer interaction modules. It should be noted that the above are only exemplary and the exchange of currency may be based on any time period (e.g., days, months, or years), and can be calculated using any known methods, including the methods disclosed here.

d. Dynamic Pricing

Dynamic pricing introduces adaptive payment rates that are based on external factors such as demand, operating conditions, or time constraints. This method requires the use of advanced data analytics and environmental sensors that are integrated into the humanoid robot's ecosystem to assess variables such as peak usage hours, ambient conditions, or the availability of competing resources. Cloud-based algorithms enable real-time adjustments to pricing structures, thereby optimizing revenue generation while maintaining user satisfaction. For example, a humanoid robot that is deployed in a logistics hub may be subject to higher rates during periods of increased demand, such as the holiday season. The robot's onboard AI would continuously evaluate factors such as workload intensity, environmental complexity, and task urgency to recommend appropriate pricing adjustments. Variations of dynamic pricing can include capped surge rates or predictive discounts for off-peak usage, which provides a balanced approach to cost management for the user. Derivatives of this model might include environment-sensitive pricing, where the robot's ability to navigate hazardous or extreme conditions commands a premium rate, or multi-tiered dynamic pricing based on different robot capability levels and task criticality.

e. Performance-Based

Performance-based leasing combines a fixed baseline payment with variable bonuses that are tied to the robot's productivity or efficiency in completing its tasks. This model is underpinned by robust performance metrics that are derived from the robot's onboard sensors and integrated analytics software. Parameters such as task completion time, accuracy, and energy efficiency are continuously monitored and logged. For humanoid robots, advanced AI algorithms enable the real-time analysis of these metrics, which helps to identify opportunities for efficiency improvements. Bonuses may be triggered by exceeding predefined performance thresholds or by achieving exceptional outcomes, such as the accelerated completion of a project or exceeding established quality standards. Variations of this model include tiered bonuses for incremental improvements or penalties for underperformance, creating a comprehensive incentive structure. This approach leverages AI-based optimization algorithms to enhance the robot's operational output, thereby ensuring close alignment with user objectives. Alternatives to this method could include team-based performance models, where multiple robots working collaboratively would share in any earned bonuses, or long-term performance incentives that reward consistently high efficiency over extended leasing periods.

f. Caps/Overages

The caps/overages model involves a baseline payment for a predetermined usage limit, with additional charges applied for any usage that exceeds this threshold. This method relies on precise usage tracking systems that are integrated within the humanoid robot, such as operational hour counters or task frequency logs. The robot's software may incorporate predictive analytics to estimate when usage caps will likely be exceeded, which enables users to make informed decisions about adjusting their usage plans. For instance, a robot that is programmed for healthcare support may have a capped usage of 40 hours per week, with overage fees applied for any extended operation beyond that limit. Embedded maintenance scheduling tools can help ensure that overage periods do not compromise the robot's long-term performance or longevity. Variations of this model include tiered overage rates or progressive discounts for consistent overuse, which encourages efficient usage while still accommodating periods of peak demand. An alternative model could feature flexible cap adjustments based on real-time workload needs or dynamic scaling that allows for temporary increases in usage limits without requiring a full contract amendment.

g. Fair Market Value

The fair market value method establishes leasing rates based on the prevailing cost of obtaining equivalent services from competing providers in the market. This pricing approach necessitates detailed market analysis and the use of benchmarking systems, which are supported by data aggregation tools and competitive intelligence software. Humanoid robots that are equipped with self-assessment capabilities, such as operational benchmarking and efficiency metrics, enable transparent comparisons with established industry standards. These systems can integrate with external pricing APIs and historical market data to continuously update fair market value assessments. Variations of this model include periodic rate adjustments to reflect current market trends or dynamic comparisons that incorporate real-time pricing data from competitors. This method helps to ensure fairness and competitiveness while giving users confidence in the cost efficiency of the service. A derivative of this method could incorporate user customization, where specific features or performance metrics are priced individually, thereby offering more granular comparisons that are tailored to the user's specific operational priorities.

h. Profit Sharing/Royalty Rate

In the profit-sharing or royalty rate model, payments are calculated as a percentage of the revenue that is generated through tasks performed by the humanoid robot. This approach is particularly relevant in production or service-oriented industries where robot-driven outputs directly contribute to financial outcomes. The use of integrated revenue-tracking systems, potentially combined with blockchain-based smart contracts, can ensure transparent and accurate calculations of revenue shares. For example, in an automated retail setup, a humanoid robot's direct contribution to sales could be measured and billed accordingly. To enhance accountability, the robots may include features such as real-time sales attribution algorithms and customer interaction analytics. Variations of this model include fixed percentage rates or sliding scales that are based on performance metrics. Derivatives could involve a hybrid approach that combines a lower fixed rate with bonuses for surpassing revenue targets, or task-specific royalty rates where unique or specialized operations command higher percentages due to their value.

### 4. Introduction to the Robot

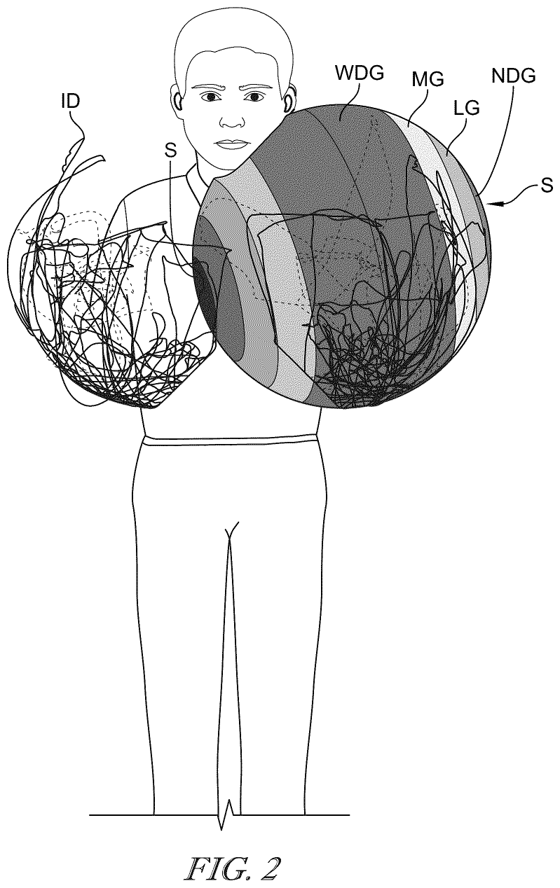

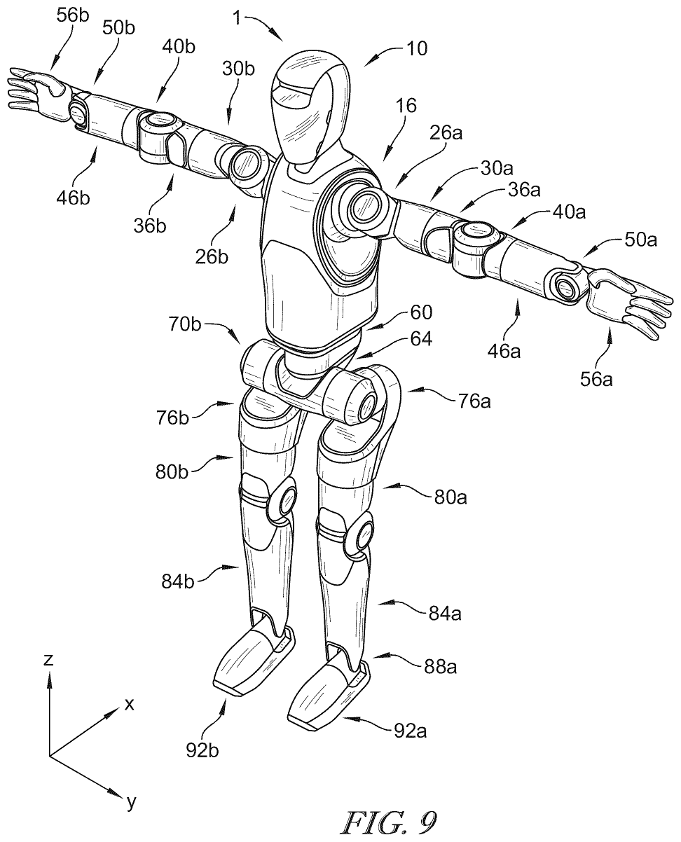

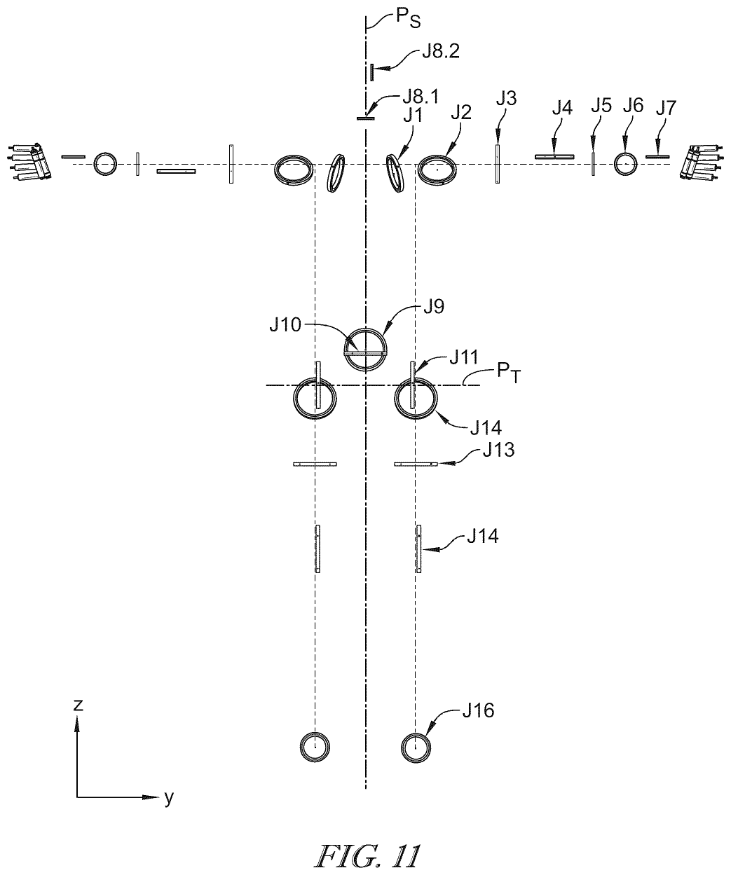

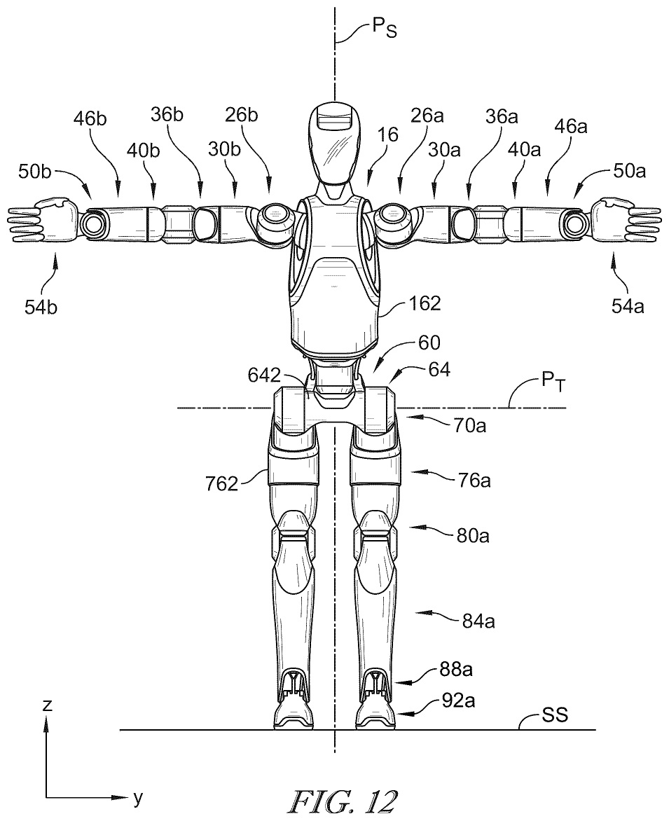

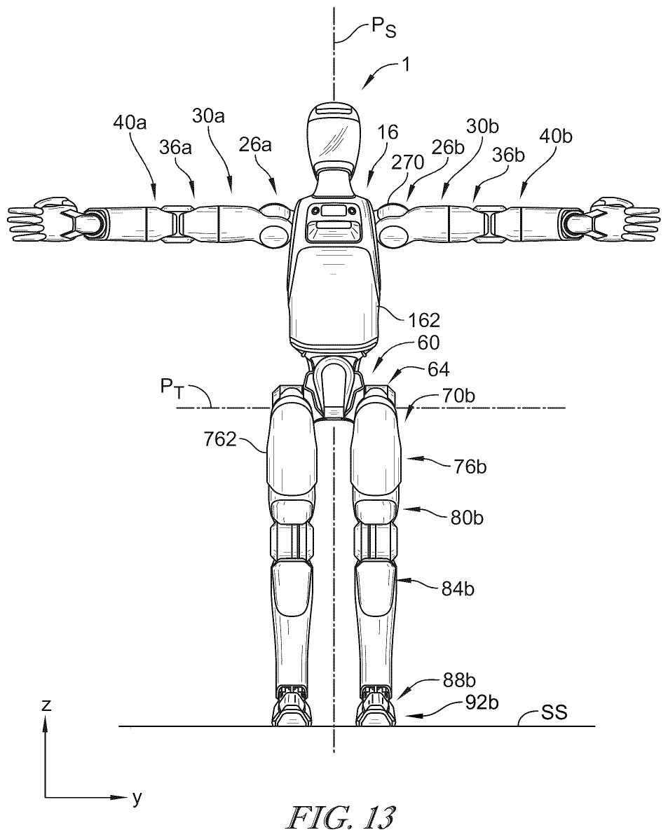

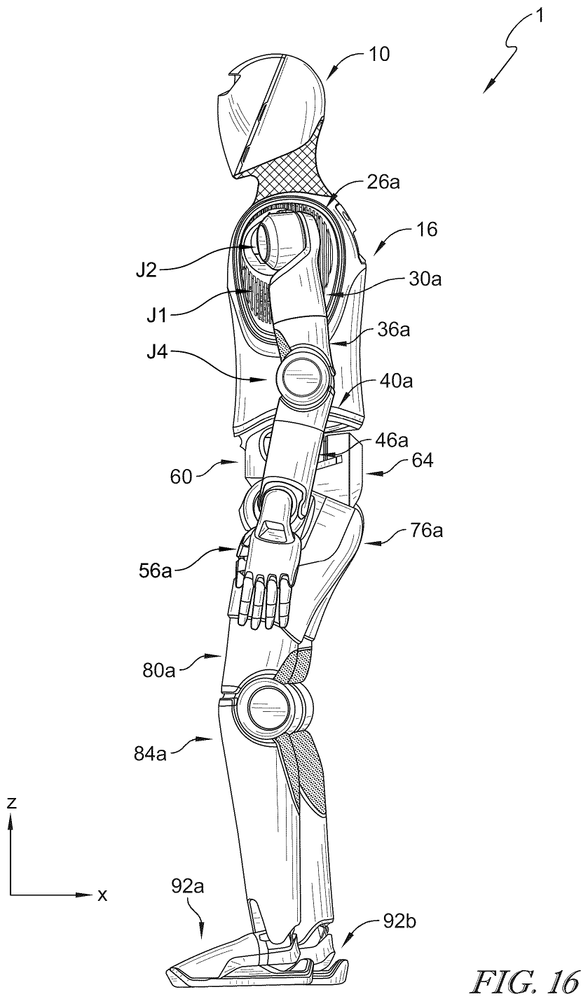

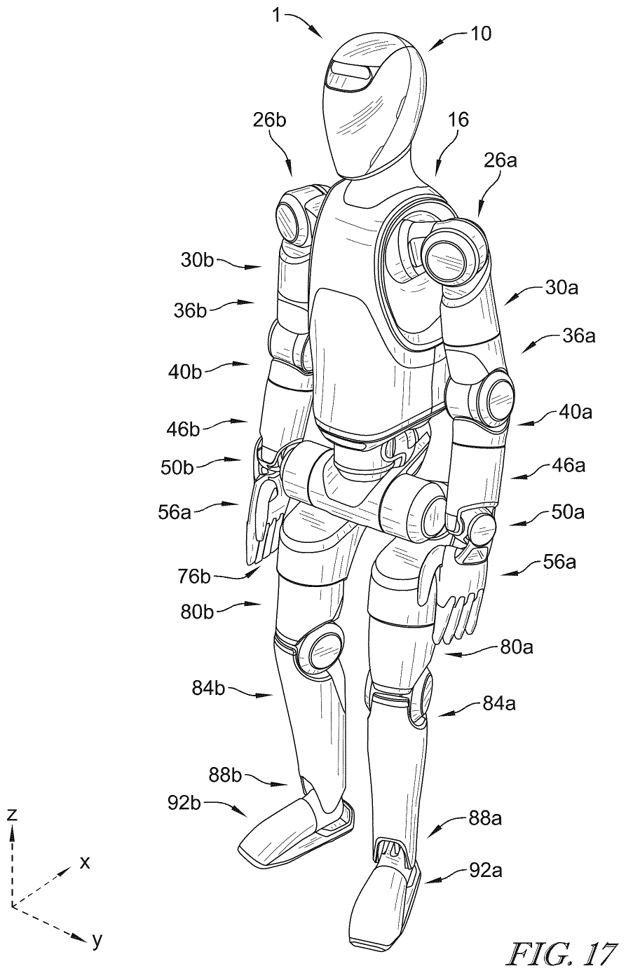

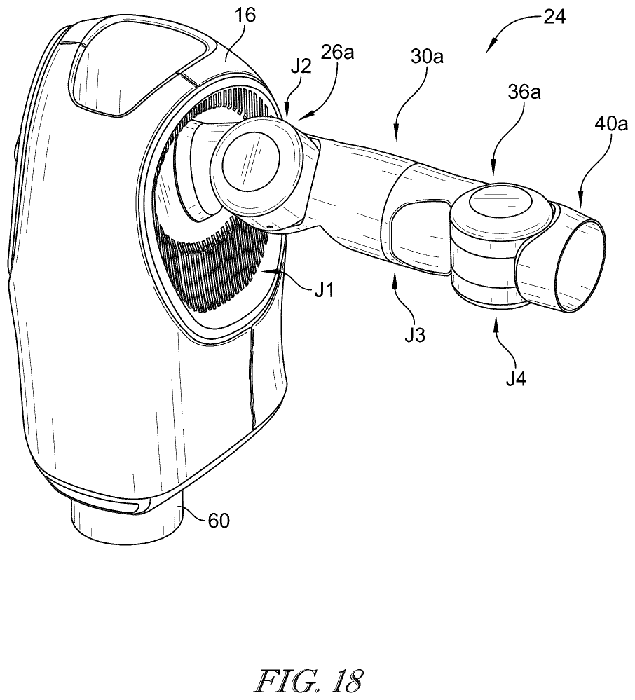

FIGS. 2-85 disclose various embodiments of versatile and highly-functional humanoid robots 1, 1001, 2001, 3001, 4001, 5001, and 6001. To simplify the following disclosure, this portion of the Application will primarily focus on the first embodiment of the robot 1 disclosed herein. However, it should be understood that most, if not all, of the following disclosure applies to other embodiments disclosed herein. FIGS. 9, 12, 13, and 16-17 show a humanoid robot 1 comprising multiple systems, assemblies, components and/or parts. Said systems, assemblies, components and/or parts may have anthropomorphic characteristics to enable said robot 1 to emulate the human form and perform a diverse set of tasks. These systems, assemblies, components and/or parts may include a head/neck 10, torso 16, left and right arms, which each include a shoulder 26, upper humerus 30, lower humerus 36, upper forearm 40, lower forearm 46, wrist 50, and hand 56. The robot 1 also includes a spine 60, pelvis 64, left and right hips 70, and left and right legs, which each include an upper thigh 76, lower thigh 80, shin 84, talus 88, and foot 92.

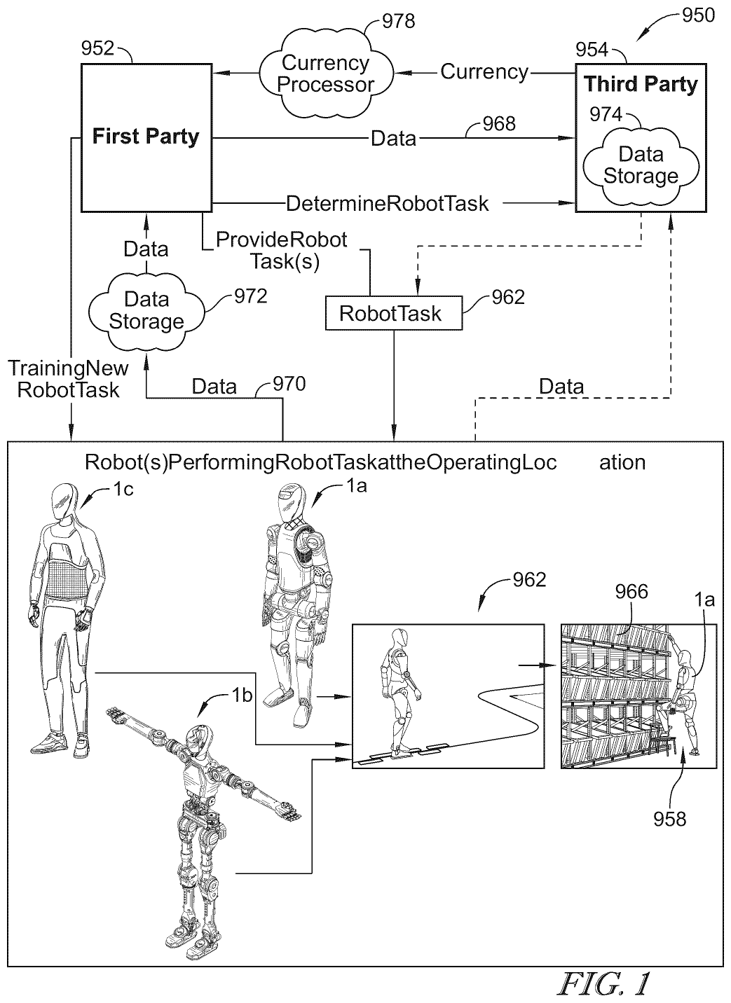

As shown in at least FIGS. 1, 9, 12, 13, 16-17 and explained below, the humanoid robot 1 includes 62 degrees of freedom (DoF). In particular, the 62 degrees of freedom are distributed within the robot 1 as follows: (i) 48 degrees of freedom are contained in the upper portion 2 of the robot 1, (ii) 10 degrees of freedom are contained in the central portion 3 of the robot 1, and (iii) 4 degrees of freedom are contained in the lower portion 4 of the robot 1. Stated another way, the 62 degrees of freedom are distributed within the robot 1 as follows: (i) 16 degrees of freedom are contained in each hand 56, (ii) 6 degrees of freedom are contained in each arm assembly 5, (iii) 6 degrees of freedom are contained in each leg assembly 6, and (iv) 2 degrees of freedom are contained in each of the upper torso, spine/pelvis, and neck 10, 16, 60, 64. The number and distribution of these degrees of freedom provide the robot 1 with several significant advantages over conventional robots. For example, positioning approximately 77% of the degrees of freedom in the upper portion 2 of said robot 1 allows it to perform complex, dexterous tasks that could not be performed without a substantial majority of the degrees of freedom being positioned in said upper portion. As another example, minimizing the number of degrees of freedom in the central portion 3 allows the robot 1 to have a larger torso 16, which in turn allows for the inclusion of a larger battery pack and additional computing power; thereby improving the performance and reliability of the robot 1. As a further example, including at least 5% of the degrees of freedom within the lower portion 4 of the robot 1 allows it to minimize the time and number of steps required for turning around, which allows the robot 1 to have more humanlike movements and increases the speed at which certain tasks can be accomplished.

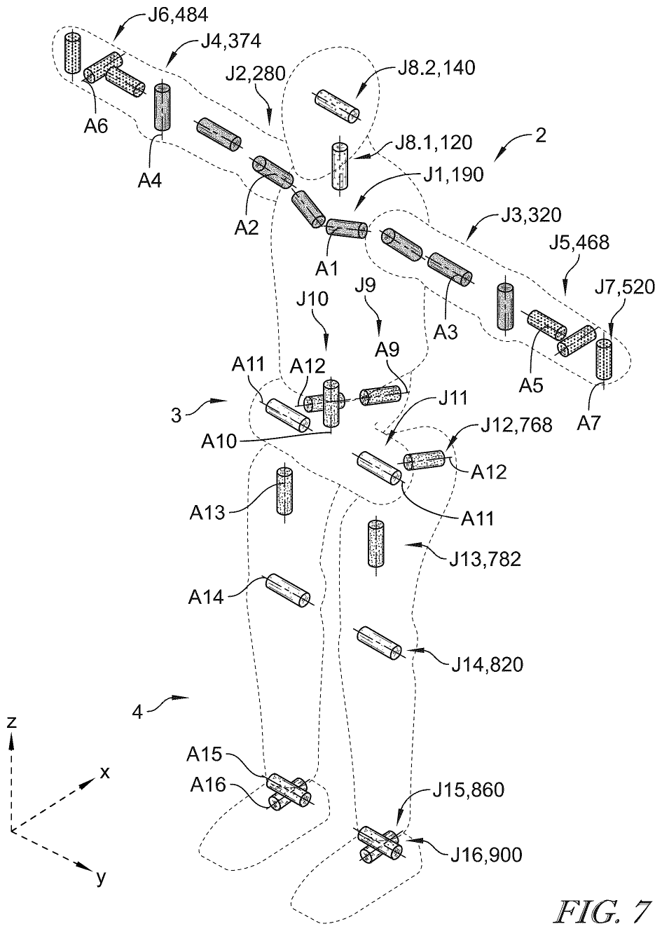

As shown in FIGS. 7-14, the 62 degrees of freedom of the inventive robot 1 are provided by a combination of 42 electric rotary and linear actuators (J1-J16), wherein an overwhelming majority (e.g., over 95%) of the actuators are electric rotary actuators as compared to linear actuators. In other words, the robot 1 only includes 2 linear actuators out of the 42 total actuators contained in said robot 1. Of these 42 electric actuators, a majority (e.g., over 60%) are not configured to drive a linkage; instead, said actuators are designed to directly drive the next part or parts of the robot 1. In particular, linkages are coupled to: (i) 14 rotary actuators of said 40 rotary actuators, and (ii) all of the linear actuators. In other words, 35% of the rotary actuators and 100% of the linear actuators are coupled to a linkage. These linkages allow: (i) the fingers and thumb to be under-actuated, or in other words, the fingers and thumb retain their ability to flex, curl, or rotate around an object while eliminating the need for an actuator to control each joint or degree of freedom, (ii) the wrist to have two degrees of freedom that not only interact with one another, but are also substantially perpendicular to one another, and (iii) the foot to pivot around an axis that is located well forward (e.g., more than 10% of the overall length of the foot) of the center of the drive linkage.

As shown in FIGS. 7, 21, and 50, the 42 electric rotary and linear actuators can be classified into seven primary types, wherein the different types of actuators can be identified by the different types of stippling in each of these Figures. Five of the seven types of actuators have structures that are substantially similar, are assembled in a similar manner, and include a number of common components. These similarities and commonalities reduce the need for specialized parts, increase assembly speeds, minimize cost, and simplify the debugging and documentation of the robot 1. As shown in these Figures and described in greater detail below, the seven types of actuators are not equally distributed within the robot 1. Instead, an unequal distribution is utilized throughout the robot 1. In particular, the robot 1 includes 12 actuators of a first type, 8 actuators of a second type, and 6 actuators of a third type. As such, over 60% of the actuators in the robot 1 are actuator types 1-3, while under 40% of the actuators in the robot 1 are of actuator types 4-7. The similarities and commonalities of the various actuators and their unequal distribution provide substantial benefits to the robot 1 over conventional robots that lack these features and this specific configuration. Additionally, the robot 1 exclusively uses electric actuators, whereby the robot 1 lacks any manual, hydraulic, or pneumatic actuators. The use of only electric actuators provides several advantages: (i) it reduces assembly complexity, maintenance requirements, overall weight, and cost, and (ii) it increases durability and enhances safety considerations related to operating the robot 1 within or around other humans.

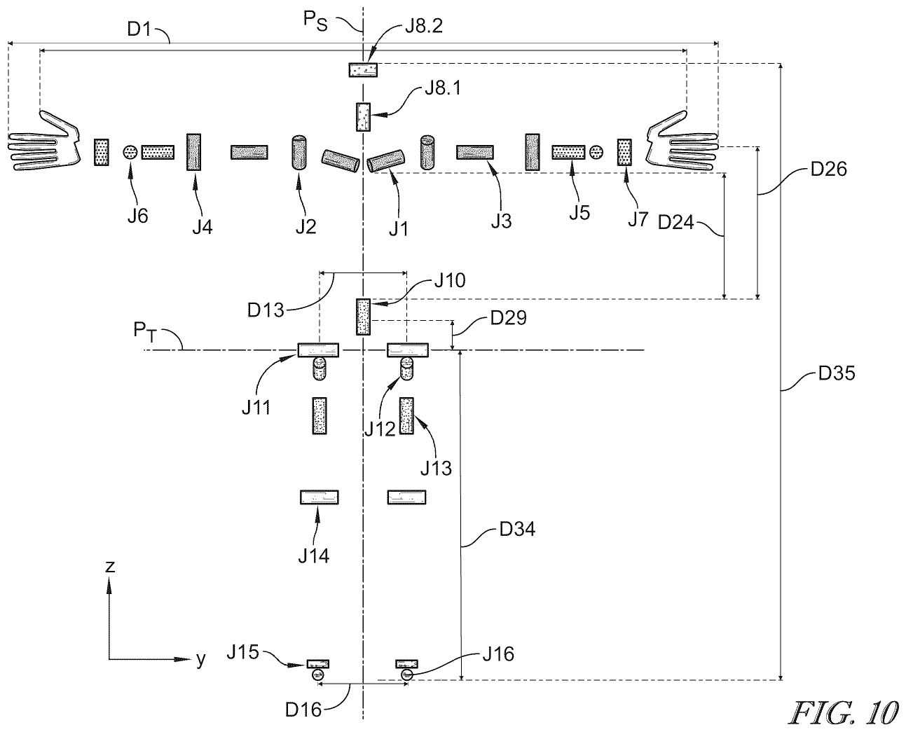

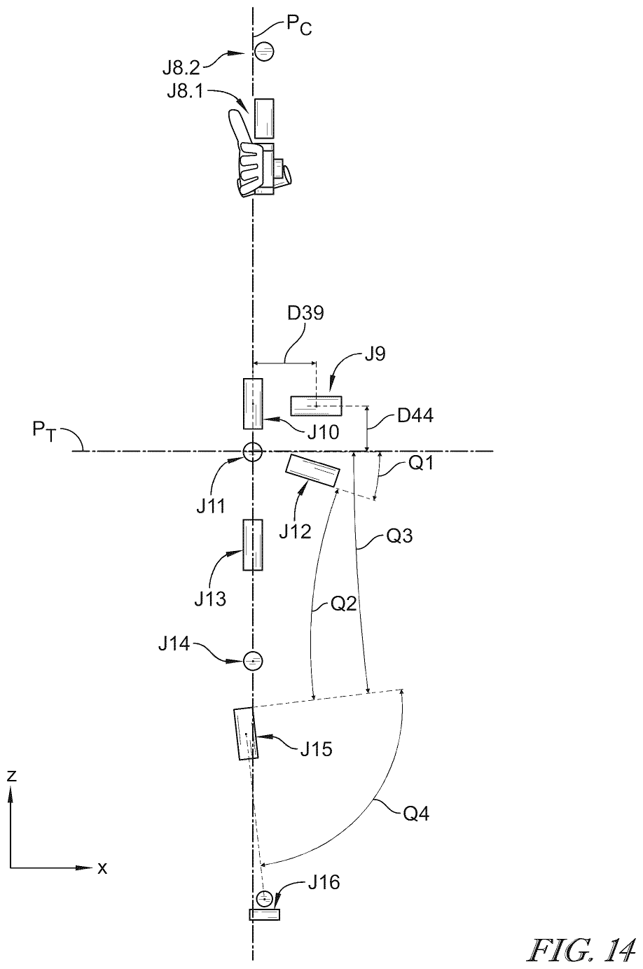

The positional relationship of the actuators within the robot 1 and their positional relationship to one another provide said robot 1 with a substantial advantage over conventional robots. These positional relationships may be identified relative to the sagittal, coronal, and transverse planes of the robot 1. Specifically, the sagittal plane (P_{S}) is defined as a vertical plane that contains the rotational axis A₁₀ of the torso twist actuator J10, which is located in the spine 60 of the robot 1, and it divides the robot 1 into left and right sides, as indicated in at least FIGS. 10-11. The coronal plane (P_{C}) is defined as a vertical plane that also contains the rotational axis A₁₀ of the torso twist actuator J10 located in the spine 60 of the robot 1, and it divides the robot 1 into front and back sections, as indicated in at least FIG. 14. The transverse plane (PT) is a horizontal plane that contains the rotational axes A₁₁ of the hip flex actuators J11, which are located in the hips 70 of the robot 1, and it divides the robot 1 into upper and lower halves, as indicated in at least FIGS. 10 and 14. Further, the arrangement of the individual actuators contained in the robot 1 is defined positionally by the cross-roller bearing plane (Bₙ) and/or the rotational axis (Aₙ) of the individual actuator (Jₙ) relative to one or more of the sagittal, coronal, or transverse planes (P_{S}, P_{C}, P_{T}), when the robot is in a static position (such as neutral or extended). In particular, the cross-roller bearing is a specific component of the individual actuator assembly (J1-J14, J16) that is ring-shaped with edge surfaces. The cross-roller bearing plane (Bₙ) is defined as a plane that is positioned at the mid-width of the cross-roller bearing and is perpendicular to the rotational axis (Aₙ), where the rotational axis (Aₙ) of the actuator is centered within the cross-roller bearing.

Aₙ additional unique configuration of the disclosed robot 1 relates to the fact that the arm actuator 190 (J1), and specifically the arm axis A₁ of the (J1) actuator, is positioned at an upward and rearward angle (e.g., more than 10 degrees) relative to both the transverse plane P_{T} and the coronal plane P_{C}. This specific configuration places the singularity of the robot's arm in a location that is outside of the normal range of use for the tasks that the robot 1 is designed to perform, as shown by FIG. 2. In addition, the arrangement of actuators contained within the central portion 3 of the robot 1 helps to ensure that the leg of the robot 1 cannot be put into a singularity. Further, omitting an actuator that is dedicated to controlling the spine pitch or torso pitch (i.e., bending forward at the robot's belly) reduces the total number of actuators required. Instead, the movement associated with pitching forward is controlled by the hips and legs of the robot 1. In other words, the robot 1 maintains the ability to bend forward or backward but eliminates the need for including one or more dedicated actuators to allow the robot 1 to perform this movement. Moreover, several actuators are offset relative to one another to provide the robot 1 with the range of motions disclosed below.

Unlike conventional robots, the hip flex actuator 720 (J11) is directly coupled to the pelvis 64 of the robot 1, and it is positioned closer to both: (i) the torso lean actuator 680 (J9), and (ii) the torso twist actuator 620 (J10), than all other actuators. Additionally, the hip pivot actuator 768 (J12) is not directly connected to the pelvis 64; instead, it is directly connected to the hip flex actuator 720 (J11). By coupling the hip pivot actuator 768 (J12) to the hip flex actuator 720 (J11) at an angle (e.g., more than 10 degrees) relative to the transverse plane P_{T}, the center of the cross-roller bearing 772.6 of the hip pivot actuator 768 (J12) is positioned below the center of the cross-roller bearings for each and every one of the following actuators: (i) the torso lean actuator 680 (J9), (ii) the torso twist actuator 620 (J10), and (iii) the hip flex actuator 720 (J11). This particular positional arrangement is beneficial because it increases the range of motion for the hip pivot actuator 768 (J12), allowing the robot 1 to bend further down (e.g., deep squat) than would be needed to engage an object resting on the floor or on a low shelf. Finally, the leg twist actuator 782 (J13) is positioned below all other actuators that perform hip or spine movements and is not directly coupled to the pelvis 64 of the robot 1.

The various actuators are purposely spatially located and arranged in the robot 1 to provide it with a humanoid configuration and to enable it to perform humanlike movements. The spacing between the actuators in the vertical direction enables said robot 1 to have a total or overall height that is less than 1700 mm, wherein the spacing between the actuators in the horizontal direction enables the robot 1 to have a wing span, as measured from fingertip to fingertip, that is greater than 1500 mm. Accordingly, the robot's wing span from fingertip to fingertip is appreciably greater than the total height of the robot 1. This configuration allows the robot 1 to reach items on a high shelf or to reach over an object to pick up another object. In addition, the length of each arm, which extends between the outermost extents of the wrist actuators, is less than 20% less than the length of each leg.

### 5. Generation of the Robot Model

The robot 1 may feature a capability to avoid, or substantially avoid, geometric configurations of the robot's joints in which one or more degrees of freedom are effectively lost due to the alignment or overlap of rotational or translational axes-namely, joint singularities S. These configurations can result in a reduction in the robot's ability to maneuver, exert force, or maintain precision during task execution. To mitigate these challenges, the robot's pre-determined range of motion requirements may be carefully analyzed and selected. For instance, during tasks that require the arms to be placed overhead, the control system may ensure that joint trajectories are planned to avoid positions that are within 5 degrees, and preferably not within 20 degrees, of a singularity S to reduce mechanical stress and maintain full operational control. However, to enable said control system to effectively avoid said singularities S, the robot 1 will typically need an optimized kinematic configuration that includes a properly chosen set of range of motion requirements. The following disclosure discusses how a design may be developed to generate such a configuration. However, it should be noted that the following steps may be skipped, performed out of order, revised, modified, and/or replaced as needed.

The process of defining a kinematic configuration that includes a set of range of motion requirements for the robot 1 may involve a multi-faceted approach that combines data collection techniques, computational modeling, iterative design optimization, and various implementation systems and/or methods. A motion capture system may be employed to capture the nuanced movements of human subjects who are performing various robot tasks 962 within a defined set of robot tasks (which may be defined by the first party, the third party, or a combination thereof). This system may utilize a network of high-speed cameras, potentially operating at frame rates exceeding 240 Hz, which are strategically positioned around a designated capture volume. Retroreflective markers, with diameters that may range from 3 to 14 mm, may be placed at key anatomical landmarks on the human subjects. To complement or replace the optical motion capture data, inertial measurement units (IMUs) may be integrated into the data collection protocol. These IMUs may incorporate tri-axial accelerometers with measurement ranges of ±16 g, gyroscopes capable of measuring angular velocities up to +2000 degrees per second, and magnetometers for obtaining an absolute orientation reference. The IMUs may be synchronized with the motion capture system using a common time base, which can potentially be achieved through wireless time synchronization protocols or via hardwired trigger signals. The fusion of optical and inertial data may enable robust tracking of body segments even in scenarios where optical markers may be temporarily occluded.

FIG. 2 shows the data that was captured and integrated from the motion capture, IMU, gyroscope, and/or magnetometer data sources. This collected data may then be used to create a comprehensive biomechanical model, which can include joint kinematics, skeletal structure, and/or muscle force-length-velocity relationships. This biomechanical model may be further developed by analyzing the multiple ways of performing the same task within the general set of tasks. For the example of picking up a bin from the ground, this analysis could involve investigating three distinct strategies: (i) knee bending with minimal to no bending of the torso 16, (ii) torso 16 bending with minimal, to no, knee bending, and (iii) a combination of both knee and torso 16 bending. Each strategy may be analyzed in terms of joint angles, velocities, accelerations, and torques throughout the entire movement sequence to further develop or increase the fidelity of the biomechanical model. Inverse kinematics algorithms, such as the Levenberg-Marquardt method or the Jacobian transpose method, may be used to determine the joint angles that are necessary to achieve the desired end-effector positions throughout the task. Additionally, inverse dynamics calculations may be performed to estimate the forces and torques that are exerted on each joint during the motion. These calculations may consider factors such as segment masses, moments of inertia, and external forces (e.g., the weight of the bin being lifted). The results of these calculations may then be used to inform the torque specifications for each actuator in the robot 1.

The developed or revised biomechanical model may then be analyzed to select a pre-determined set of range of motion requirements from a pre-defined set of such requirements, or to create a new set of range of motion requirements. In analyzing said developed or revised biomechanical model, the designer may consider: (i) the center of mass trajectory both with and without the bin, which may involve calculating the zero-moment point (ZMP) trajectory, (ii) the weight of the bin, its dimensions, and the various locations that the bin may need to be placed, (iii) the energy efficiency, mechanical wear on specific joints, robustness of the movement to external perturbations, and/or the aesthetic qualities of each movement strategy. Based on the above analysis, the following table of the maximum and minimum angles for each actuator and their associated range of motion can be generated. It should be understood that the below angles and ranges of motion are exemplary and are provided to show the ability of robot 1 to not only have a significant number of degrees of freedom (i.e., 62), but also to ensure that each degree of freedom is associated with a significant range of motion. This is in contrast to conventional robots that often lack such large ranges of motion, which prevents said conventional robots from completing the complex humanlike tasks that the disclosed robot 1 is capable of performing. However, said ranges of motion are not made unnecessarily large, which could generate additional training and performance issues.

TABLE 1

| | | | | | Preferred | Preferred |
|---|---|---|---|---|---|---|
| | | Second | Range of | Preferred | Second | Range of |
| Actuator | First Angle | Angle | Motion | First Angle | Angle | Motion |
| JI | −162 | 108 | 270 | −148.5 | 99 | 247.5 |
| J2 | −129 | 48 | 177 | −118.8 | 44 | 162.8 |
| J3 | −144 | 144 | 288 | 132 | 132 | 264 |
| J4 | −162 | 18 | 180 | −148.5 | 16.5 | 165 |
| J5 | −192 | 192 | 384 | −176 | 176 | 352 |
| J6 | −54 | 54 | 108 | −49.5 | 49.5 | 99 |
| J7 | −108 | 108 | 216 | −99 | 99 | 198 |
| J8.1 | −108 | 108 | 216 | −99 | 99 | 198 |
| J8.2 | −30 | 30 | 60 | −27.5 | 27.5 | 55 |
| J9 | −36 | 36 | 72 | −33 | 33 | 66 |
| J10 | −108 | 108 | 216 | −99 | 99 | 198 |
| J11 | −192 | 42 | 234 | −176 | 38.5 | 214.5 |
| J12 | −30 | 54 | 84 | −27.5 | 49.5 | 77 |
| J13 | −108 | 108 | 216 | −99 | 99 | 198 |
| J14 | −18 | 174 | 192 | −16.5 | 159.5 | 176 |
| J15 | −72 | 48 | 120 | −66 | 44 | 110 |
| J16 | −54 | 54 | 108 | −49.5 | 49.5 | 99 |

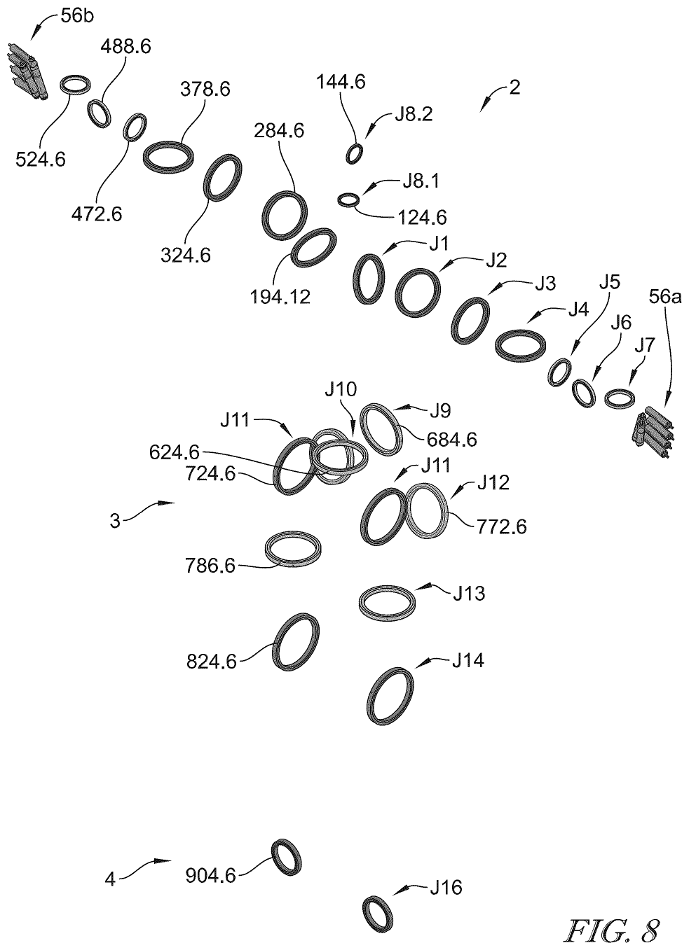

The developed or revised biomechanical model, along with the selected or defined range of motion requirements, can then be used to generate a high-level configuration or model of the robot 1, a portion of which is shown in FIG. 7. This high-level model of the robot (FIG. 7) can then be used in connection with the developed or revised biomechanical model and the selected or determined range of motion requirements to generate the cross-roller bearing arrangement or model, which is shown in FIG. 8. The cross-roller bearing model can then be used to generate a complete robot or robot model (FIG. 9), which includes actuator ranges, torque capacities, control system parameters, and the exterior surfaces of the robot.

It should be understood that additional actuators, cross-roller bearings, and/or rotational axes of the assemblies may be utilized in other embodiments of the robot. For example, an additional actuator may be added within the belly of the robot. In other embodiments, said robot 1 may include fewer actuators, cross-roller bearings, and/or rotational axes. For example, the torso lean actuator 680 (J9), the foot roll actuator 900 (J16), or an actuator located within the hand may be removed. It is understood that the number/location of actuators, the range of motion, and/or the arrangement of the axes of rotation associated with the disclosed humanoid robot materially and substantially differ from the number/location of actuators, range of motion, and/or arrangement of axes of rotation for a non-humanoid robot. As such, the structures, number/location of actuators, range of motion, and/or arrangement of axes of rotation associated with a non-humanoid robot cannot be simply adopted or implemented into a humanoid robot without careful analysis and verification of the complex realities of designing, testing, and manufacturing a general purpose humanoid robot. Theoretical designs that are an attempt to implement such modifications from a non-humanoid robot are often insufficient (and in some instances, woefully insufficient) because they can amount to mere design exercises that are not tethered to the complex realities of successfully designing, testing, and manufacturing a general purpose humanoid robot.

### 6. Component of the Physical Robot

A physical robot 1 can be manufactured from the complete robot or robot model. The robot model, and likely the physical robot 1, may include the following systems, assemblies, components, and/or parts. These systems, assemblies, components, and/or parts may include a head/neck 10 (100), a torso 16 (160), left and right arms, which each include a shoulder 26 (260), an upper humerus 30 (300), a lower humerus 36 (360), an upper forearm 40 (400), a lower forearm 46 (460), a wrist 50 (500), and a hand 56 (560). The robot 1 also includes a spine 60 (600), a pelvis 64 (640), left and right hips 70 (700), and left and right legs 6, which each include an upper thigh 76 (760), a lower thigh 80 (800), a shin 84 (840), a talus 88 (880), and a foot 92 (920). It should be understood that in other embodiments, some of these systems, assemblies, components, and/or parts may be omitted, combined, or replaced with alternative systems, assemblies, components, and/or parts.

a. Actuators

As Shown in at least FIGS. 7-17, the actuators contained within the physical robot 1 include actuators (J1-J16) that are housed within various components of the robot 1 to actuate the movement of the components of said robot 1. Below is a summary table showing the actuator reference names and numbers, actuator names, and their associated components from the high level configuration of the robot 1. In particular, the cross-roller bearing of individual actuators may help to define the motion of the component or structure that is attached to the output driven by the individual actuators.

TABLE 2

| | | | Cross-roller |
|---|---|---|---|
| | | | Bearing Plane |
| | | | B, and (Cross- |
| Actuator | Actuator Name | Actuator Axis | Roller Bearings) |
| JI | Arm Actuator | Arm Axis, A₁ | B₁ (194.12) |
| (190) | | | |
| J2 | Shoulder Actuator | Shoulder Axis, A₂ | B₂ (284.6) |
| (280) | | | |
| J3 | Upper Arm Twist, Upper Arm | Upper Arm Twist, Upper Arm X, or | B₃ (324.6) |
| (320) | X, or Upper Arm Roll Actuator | Upper Arm Roll Axis, A₃ | |
| J4 | Elbow, Arm Z, Arm Yaw, or | Elbow, Arm Z, Arm Yaw, or Lower | B₄ (378.6) |
| (374) | Lower Humerus Actuator | Humerus Axis, A₄ | |
| J5 | Lower Arm Twist, Lower Arm | Lower Arm Twist, Lower Arm X, | B₅ (472.6) |
| (468) | X, or Lower Arm Roll Actuator | or Lower Arm Roll Axis, A₅ | |
| J6 | Wrist Flex, Wrist/Hand Y, | Wrist Flex, Wrist/Hand Y, | B₆ (488.6) |
| (484) | Wrist/Hand Pitch, or Flick | Wrist/Hand Pitch, or Flick Axis, A₆ | |
| | Actuator | | |
| J7 | Wrist Pivot, Wrist/Hand Z, | Wrist Pivot, Wrist/Hand Z, | B₇ (524.6) |
| (520) | Wrist/Hand Yaw, or Wave | Wrist/Hand Yaw, or Wave Axis, A₇ | |
| | Actuator | | |
| J8.1 | Head Twist, Head No, or First | Head Twist, Head No, or First Head | B_{8.1} (124.6) |
| (120) | Head Actuator | Axis, A_{8.1} | |
| J8.2 | Head Nod, Head Yes, or | Head Nod, Head Yes, or Second | B_{8.2} (144.6) |
| (140) | Second Head Actuator | Head Axis, A_{8.2} | |
| J9 | Torso Lean Actuator, Spine X, | Torso Lean Actuator, Spine X, | B₉ (684.6) |
| (680) | Torso/Spine Roll, or First Spine | Torso/Spine Roll, or First Spine | |
| | Actuator | Axis, A₉ | |
| J10 | Torso Twist, Spine Z, | Torso Twist, Spine Z, Torso/Spine | B₁₀ (624.6) |
| (620) | Torso/Spine Yaw, or Second | Yaw, or Second Spine Axis, A₁₀ | |
| | Spine Actuator | | |
| J11 | Hip Flex, Hip Y, Hip/Leg Pitch, | Hip Flex, Hip Y, Hip/Leg Pitch, | B₁₁ (724.6) |
| (720) | Forward Kick, or First Hip | Forward Kick, or First Hip Axis, | |
| | Actuator | A₁₁ | |
| J12 | Hip Pivot, Hip X, Hip/Leg Roll, | Hip Pivot, Hip X, Hip/Leg Roll, | B₁₂ (772.6) |
| (768) | Sideways Kick, or Second Hip | Sideways Kick, or Second Hip | |
| | Actuator | Axis, A₁₂ | |
| J13 | Leg Twist, Hip Z, or Hip/Leg | Leg Twist, Hip Z, or Hip/Leg Yaw | B₁₃ (786.6) |
| (782) | Yaw Actuator | Axis, A₁₃ | |
| J14 | Knee, Lower Thigh, Lower Leg | Knee, Lower Thigh, Lower Leg Y, | B₁₄ (824.6) |
| (820) | Y, Lower Leg Pitch, or Rear | Lower Leg Pitch, or Rear Kick | |
| | Kick Actuator | Axis, A₁₄ | |
| J15 | Foot Flex, Foot Y, Foot Pitch, | Foot Flex, Foot Y, Foot Pitch, or | NA |
| (860) | or First Ankle Actuator | First Ankle Axis, A₁₅ | |
| J16 | Talus, Foot Roll, Foot X or | Talus, Foot Roll, Foot X or Second | B₁₆ (904.6) |
| (900) | Second Ankle Actuator | Ankle Axis, A₁₆ | |

The high-level configuration or model of the robot 1, the developed or revised biomechanical model, and the selected or defined range of motion requirements can be implemented using one or a combination of mechanical stops, software limits, and/or sensor-based monitoring systems. Mechanical stops that are integrated into the joint designs can physically limit motion, thereby preventing over-extension or collisions, and these stops may be adjustable or replaceable to suit specific applications. Software limits that are programmed within the control system may dynamically restrict joint movements to predefined ranges, adapting in real-time based on the arm's current configuration, specific task requirements, or environmental constraints. Said software limits may be determined using inverse kinematics algorithms to calculate the allowable joint angles and velocities. Sensor-based monitoring systems may also be used to continuously assess the position, velocity, and applied forces of the systems, assemblies, components, and/or parts, using integrated load cells, encoders, and inertial sensors to detect anomalies or potential hazards. In response to unexpected loads, collisions, or joint limit violations, the control system can initiate emergency stop procedures or switch to a compliant mode to mitigate any risk of damage or injury.

b. Robot Torso

The robot's torso 16 may function as a central hub, housing components such as the arm actuators 190 (J1), computing devices (GPUs and/or CPUs), a power supply/distribution system, and various sensors. The torso 16 may have a quasi-trapezoidal prism configuration, wherein the frontal extent of the torso 16 may be substantially smaller than the back extent of the torso 16, and the shrouds that extend between the frontal extent and back extent may be angled in relation to one another. This quasi-trapezoidal prism configuration may help to increase the robot's overall range of motion and, specifically, its ability to reach across its body. The torso 16 may have a volume greater than 19 liters and an uninterrupted internal height greater than 250 mm, and preferably over 300 mm. This increased volume may allow for the inclusion of a battery that is over 6 L in volume and a dedicated computing volume of over 2.5 L. Accordingly, said robot 1 may include a battery with a capacity of over 2.5 kWh and may provide a run time that is over 4 hours, and preferably over 6 hours.

The torso 16 of the robot 1 may incorporate a specific arrangement of actuators and structural components that are designed to enable complex, human-like movements while maintaining stability and operational efficiency. As such, the torso 16 may include an arm tube that is configured to receive and securely hold the arm actuators 190 (J1) within said torso 16. This configuration may help to efficiently distribute torque and other forces that are exerted on the robot's arms 5 to the robot's torso 16. While this positional relationship may help to efficiently transfer torques and loads from the shoulder 26 and the upper arm assembly to the robot's torso 16, it may also undesirably reduce the amount of space contained within said torso 16 for housing computing devices, batteries, and various sensors. In other embodiments, the arm actuators 190 (J1) may be positioned outside the torso 16.

The arm tube may be constructed from various materials such as metal alloys, carbon fiber composites, polymer-based materials, high-performance thermoplastics such as polyetheretherketone (PEEK), ceramic matrix composites (CMCs), metal matrix composites (MMCs) that incorporate reinforcing fibers or particles, fiber-reinforced polymers (FRPs), stainless steel, shape memory alloys (SMAs), self-healing polymers, graphene-enhanced composites, hybrid laminates, and/or nanomaterial-reinforced polymers. These materials may offer a balance of strength, weight, and thermal conductivity, which may be beneficial for dissipating the heat that is generated by the actuators during operation. The internal surface of the arm tube may be machined to certain tolerances, potentially ensuring proper alignment and support for the arm actuator 190 (J1). Additionally, the arm tube may incorporate internal channels or conduits for routing power cables, data lines, and cooling systems, potentially maintaining an organized internal structure while also protecting these components from mechanical stress and environmental factors.

The above described arm tube may be configured to receive the arm actuators 190 (J1), which are designed to provide the primary rotational movement for the entire arm assembly 5. The axis A₁ of the arm actuator 190 (J1) may be angled upward between 1 and 45 degrees, and (in some cases between 10 and 20 degrees) relative to the transverse plane P_{T}, and it may also be angled rearward between 1 and 45 degrees, and (in some cases between 10 and 20 degrees) relative to the coronal plane P_{C}. This specific orientation may allow the arm to achieve a range of motion that is similar to human shoulder movements, which attempts to avoid placing the associated singularity of the arm assembly 5 in a heavily used area of the workspace. It should be understood that other angles and positions for the arm actuators 190 (J1) are also contemplated by this application. For example, the axis A₁ of the arm actuator 190 (J1) may be angled upward between 1 and 45 degrees (in some cases between 10 and 20 degrees) relative to the transverse plane P_{T}, but may be parallel with the coronal plane P_{C}.

The output of each arm actuator 190 (J1) may be connected to its respective arm assembly 5 via a specialized mechanical interface that is designed for high durability and precision. This interface may integrate various types of high-performance bearings, including cross-roller bearings or any other type of bearing disclosed herein. To ensure a robust and reliable connection, the coupling mechanism between the actuator output and the arm assembly 5 may utilize splined shafts, polygon couplings, Oldham couplings, bellows couplings, jaw couplings, universal joints, magnetic couplings, or flexure couplings, all of which can provide high torque transmission efficiency and precise alignment. Additionally, damping elements, such as elastomeric bushings, may be incorporated into the design to absorb vibrations and reduce mechanical stresses on the system.

c. Robot Arm Assembly

Extending from the arm actuator 190 (J1), each arm assembly 5 may comprise a series of interconnected segments and actuators, including a shoulder 26 (260), an upper humerus 30 (300), a lower humerus 36 (360), an upper forearm 40 (400), a lower forearm 46 (460), a wrist 50 (500), and a hand 56 (560). In particular, the arm assembly 5 that is coupled to the arm actuator 190 (J1), may include: (i) the shoulder 26 having a shoulder actuator 280 (J2), (ii) an upper arm assembly 24 that comprises the upper humerus 30 with an upper arm twist actuator 320 (J3), and an elbow 39 with an elbow actuator 374 (J4), (iii) a lower forearm 46 with a lower arm twist actuator 468 (J5) and a wrist flex actuator 484 (J6), and (iv) a wrist 50 with a wrist pivot actuator 520 (J7).

The shoulder 26 forms the connection between the torso 16 and the upper arm assembly 24 and includes a shoulder housing 270. Said shoulder housing 270 may be designed with internal features such as reinforcement structures, materials (e.g., metal alloys), cooling channels, heat sinks, and/or any other material, structure, component, or assembly, part, or described above. The shoulder actuator 280 (J2) is positioned within the housing 270 and may utilize any motor, gearbox, sensors, bearings, encoders, and/or other components or parts that are discussed below in the actuator section.

The upper humerus 30 forms a connection between the shoulder 26 and the lower humerus 36 and includes an upper humerus housing 302. Said upper humerus housing 302 may be designed with internal reinforcement structures, materials (e.g., metal alloys), cooling channels, heat sinks, and/or any material, structure, component, assembly, part, or described above. The upper arm twist actuator 320 (J3) is positioned within the upper humerus housing 302 and may utilize any motor, gearbox, sensors, bearings, encoders, and/or other components or parts that are discussed in subsequent actuator sections. The upper arm twist actuator 320 (J3) is coupled to an extent of the lower humerus 36. This coupling may be achieved through a keyed interface or a splined shaft, which ensures proper alignment and facilitates efficient torque transmission. This connection point may also incorporate compliance mechanisms, for instance, elastomeric bushings, to absorb sudden impacts or overload conditions.

The elbow actuator 374 (J4) couples the lower humerus 36 and the upper forearm 40 and includes a lower humerus housing 362. Said lower humerus housing 362 may be designed with internal reinforcement structures, materials (e.g., metal alloys), cooling channels, heat sinks, and/or any material, structure, component, assembly, part, or described above. The elbow actuator 374 (J4) is positioned within the lower humerus housing 362 and may utilize any motor, gearbox, sensors, bearings, encoders, and/or other components or parts that are discussed in subsequent actuator sections, wherein such components may be optimized for elbow movements. The elbow actuator 374 (J4) may be coupled to an extent of the upper forearm 40, and potentially through a keyed interface or a splined shaft that ensures proper alignment and efficient torque transmission. This connection point may also incorporate compliance mechanisms such as elastomeric bushings or torsional springs to absorb sudden impacts or overloads.

The lower forearm 46 may be coupled to the upper forearm 40 and may house two actuators that provide additional degrees of freedom for movements of the wrist 50. The lower arm twist actuator 468 (J5) may be positioned within the housing 462 of the lower forearm 46. This lower arm twist actuator 468 (J5) may enable pronation and supination movements of the wrist 50, which may be useful for tasks that require reorientation of the hand 56. The housing 462 may feature a design that mimics human arm contours while providing mounting points for external sensors or tools. The robot 1 may also include a wrist flex actuator 484 (J6) that is contained within the lower forearm housing 462. Unlike the other actuators which may directly couple to the next segment, the wrist flex actuator 484 (J6) may utilize a drive linkage to transmit force to the wrist 50. This linkage system may incorporate ball joints or universal joints to allow for complex, multi-axis movements while maintaining a compact form factor. It should be understood that the lower arm twist actuator 468 (J5) and the wrist flex actuator 484 (J6) may utilize any motor, gearbox, sensors, bearings, encoders, and/or other components or parts that are discussed in subsequent actuator sections, which may be optimized for these movements.

The final segment of the arm assembly 5 may be the wrist 50, which may contain the wrist pivot actuator 520 (J7). This actuator may be housed within the structure 502 of the wrist 50 and provides the last degree of freedom before the hand or end effector 56. The wrist 50 may be coupled directly to an extent of the hand 56, potentially through a quick-release mechanism that allows for the rapid replacement of the hand or end effector 56.

The arrangement and orientation of these actuators within the arm assembly 5 may allow a wide range of motion while avoiding singularities and maximizing manipulability. As detailed in FIGS. 7, 10, 21, the rotational axes of these actuators (A₁ through A₇) may be aligned to create an optimal kinematic chain. The axis A₁ of the arm actuator 190 (J1) and axis A₂ of the shoulder actuator 280 (J2) may be angled relative to one another and to the subsequent axes A₃-A₇ of actuators 320 (J3)-520 (J7). This non-orthogonal arrangement may contribute to the dexterity and workspace of the arm assembly 5. The axis A₂ of the shoulder actuator 280 (J2) may be angled upward, between 20 and 70 degrees (in some cases around 45 degrees) relative to the transverse plane P_{T}. This inclination may be useful for expanding the workspace of the arm assembly 5 and allowing for overhead reaching motions. In some aspects, while axis A₂ may be angled relative to many other axes in the robot 1, a vertical plane containing axis A₂ may be perpendicular to a horizontal plane containing axis A₃. This geometric relationship may help ensure that the shoulder and upper arm movements remain coordinated and biomimetic. The non-orthogonal arrangement of these axes positions the arm's kinematic singularities away from the most common working positions.

The spatial arrangement and dimensional relationships between the actuators 320 (J3), 374 (J4), and 468 (J5) in the arm assembly 5 of the robot 1 may help achieve a biomimetic design that closely emulates human arm functionality while optimizing for robotic performance. As illustrated in FIG. 10, the axis A₃ of the upper arm twist actuator 320 (J3) and the axis A₅ of the lower arm twist actuator 468 (J5) may be co-linear, creating a continuous rotational axis that extends through the length of the arm assembly 5. In some embodiments, these axes A₃ and A₅ may not be co-linear; instead said axes may be offset from one another. In some embodiments, the offset may cause the axes A₃ and A₅ to be parallel with one another, and not parallel in other embodiments.

The cross-roller bearing 324.6 of the upper arm twist actuator 320 (J3) may be at least 10% larger, preferably at least 25% larger, and most preferably approximately 40% larger in radius than the cross-roller bearing 472.6 of the lower arm twist actuator 468 (J5). This size differential may address specific mechanical and functional requirements. For instance, the larger bearing 324.6 in the upper arm twist actuator 320 (J3) may accommodate the higher torque loads typically encountered in the upper arm assembly 24, while the smaller bearing 472.6 in the lower arm twist actuator 468 (J5) may facilitate a more compact and slender forearm design. This tapered configuration enhances the anthropomorphic appearance of the arm and reduces the moment of inertia, enabling faster and more energy-efficient movements during high-velocity operations.

The elbow actuator 374 (J4) may introduce an offset in the kinematic chain of the arm assembly 5, with its axis A₄ oriented perpendicular to both axis A₃ and axis A₅. This orthogonal configuration may mimic the primary degree of freedom of the human elbow, enabling flexion and extension motions. The center of the cross-roller bearing 378.6 of the elbow actuator 374 (J4) may be offset from the axis connecting the upper arm twist actuator 320 (J3) and the lower arm twist actuator 468 (J5) by at least 1 mm, and preferably between 5 mm and 10 mm, along the X-axis. This offset may represent 14% to 28% of the radius for the cross-roller bearing 378.6 of the elbow actuator 374 (J4). This offset may facilitate the hyperextension capability of the elbow 39, potentially enabling a −15-degree positioning angle, and may improve the versatility of the arm assembly 5 in confined spaces and tasks requiring backward reach. Structural accommodations, such as recessed areas in the lower humerus 36 and upper forearm 40, may ensure that such hyperextension does not compromise mechanical integrity. As an alternative, the cross-roller bearing 378.6 of the elbow actuator 374 (J4) may not be offset, and/or the elbow 39 could employ spherical plain bearings to allow for multi-axis rotation and provide additional flexibility. The cross-roller bearing plane B₄ is positioned along the mid-width of the cross-roller bearing 378.6 and may be offset along the Z-axis from the center of axes A₃ and A₅ by more than 10 mm, and preferably more than 30 mm, which is equivalent to 70% of the radius of the cross-roller bearing 324.6 of the upper arm twist actuator 320 (J3). This Z-axis offset may contribute to the humanoid appearance of the arm assembly 5, potentially aligning the upper humerus 30 with the lower forearm 46 to replicate natural human arm proportions. Also, the deliberate reduction in the size of the cross-roller bearing 472.6 of the lower arm twist actuator 468 (J5) to less than 60% of the radius of the cross-roller bearing 324.6 may help create a more slender forearm profile.

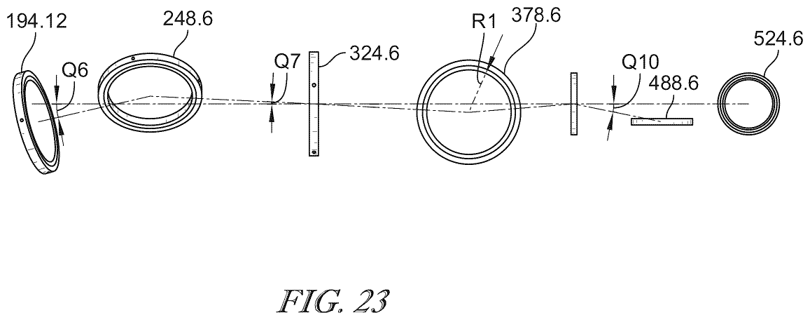

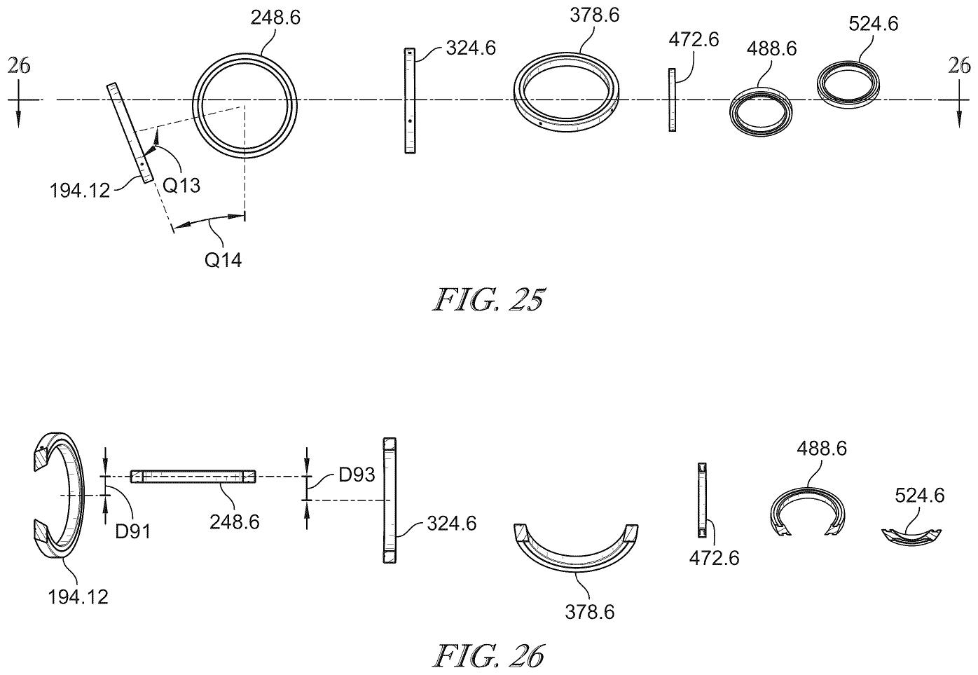

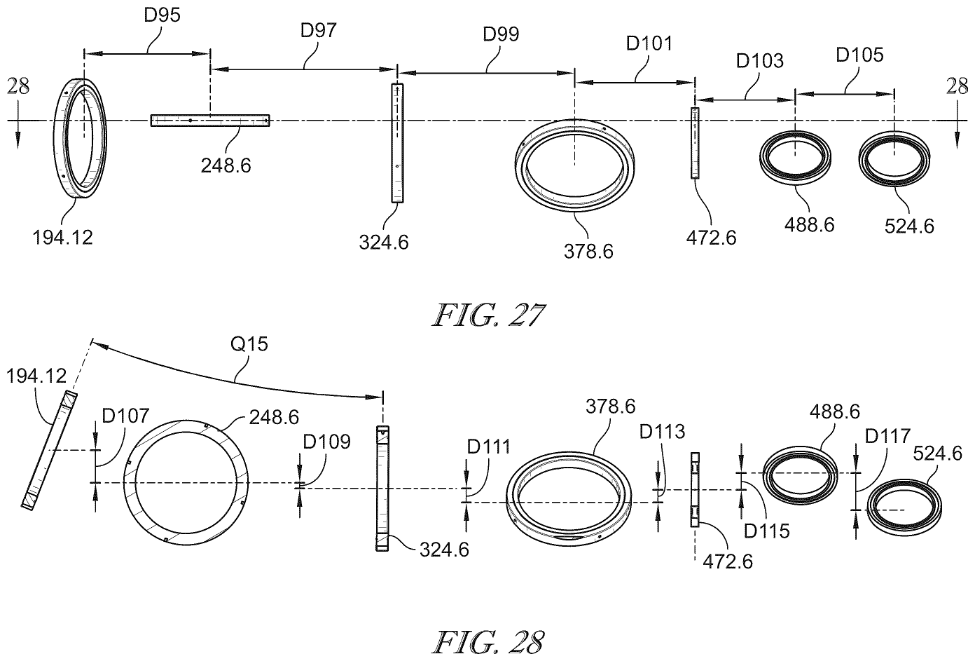

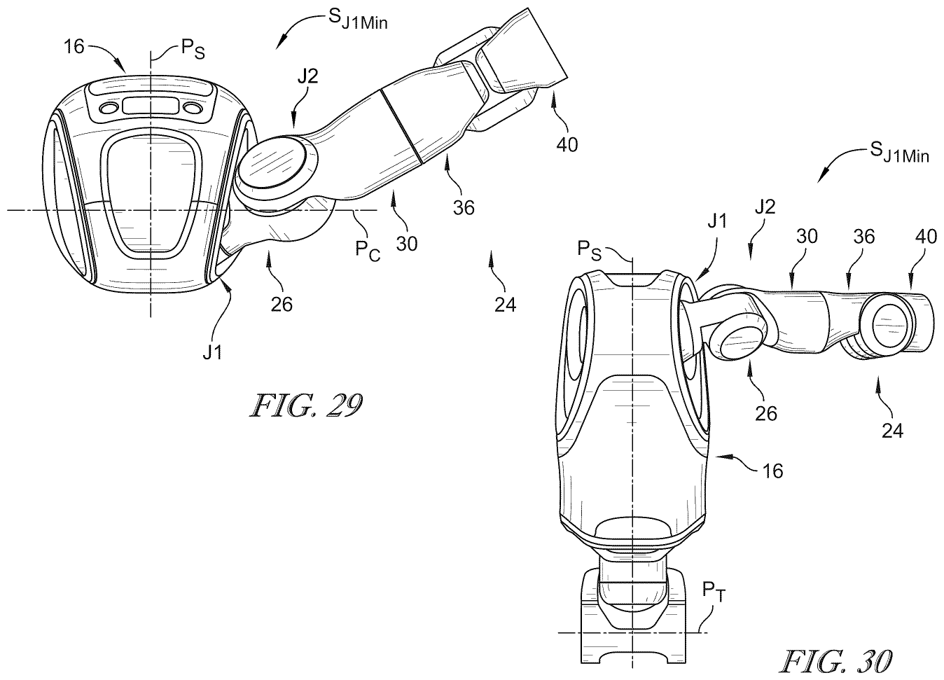

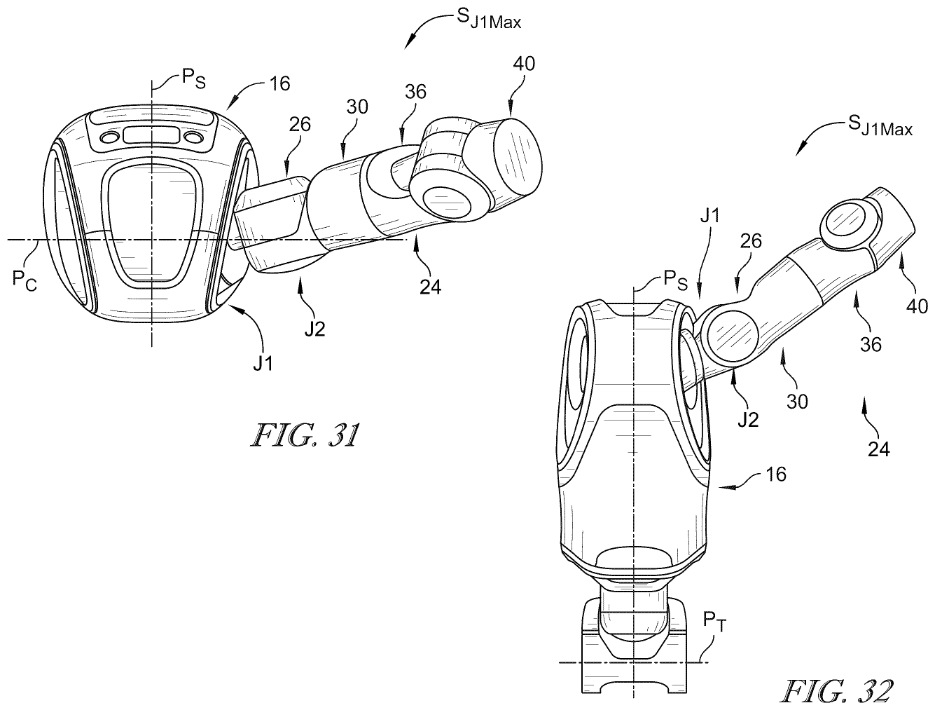

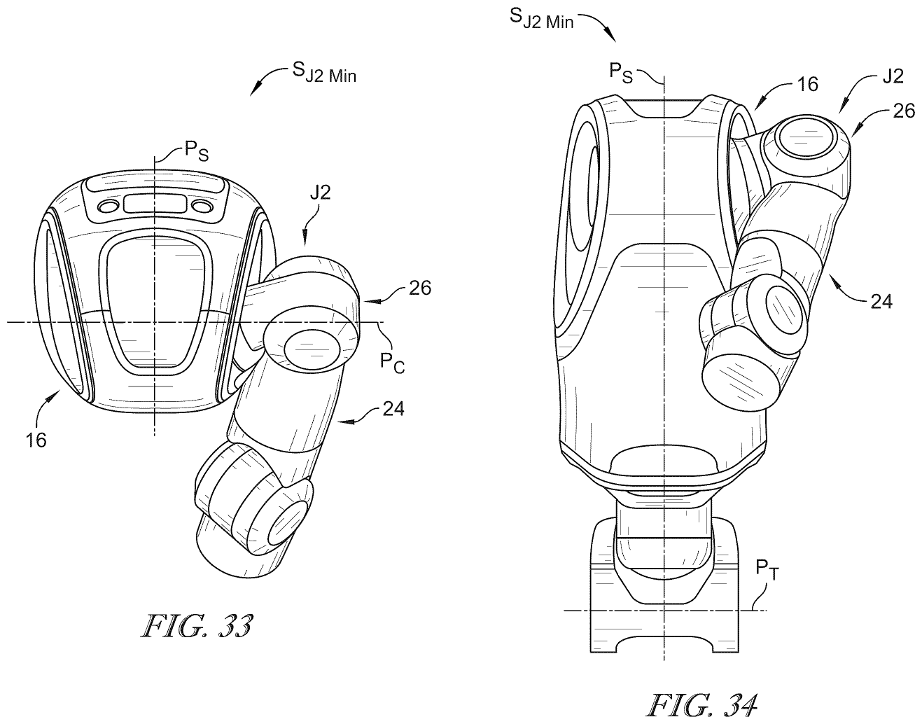

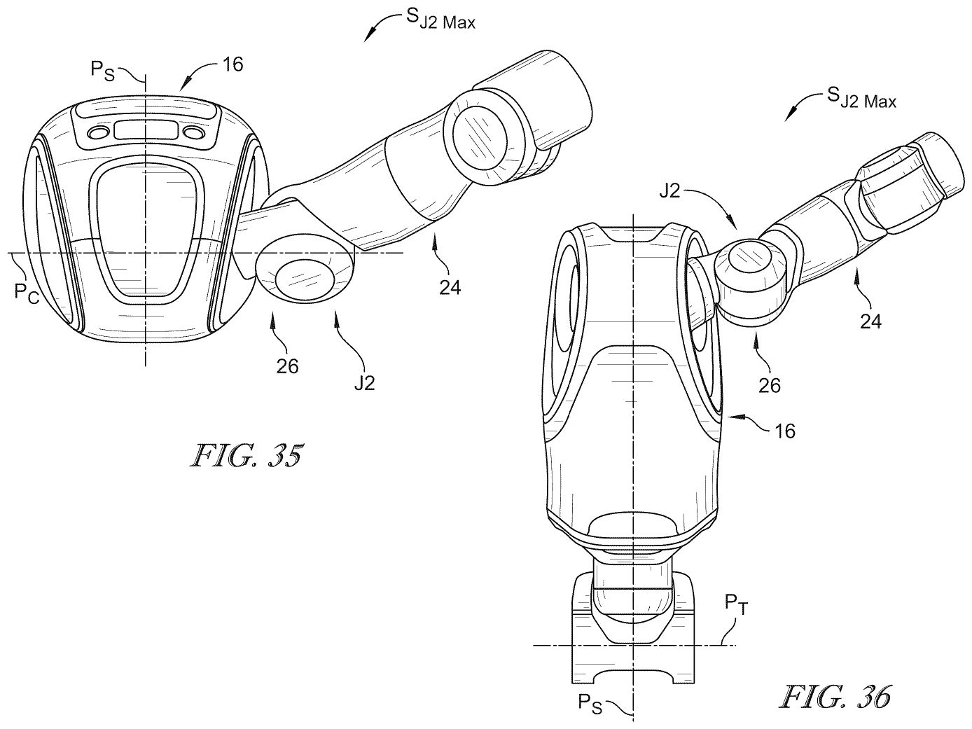

The spatial arrangement of actuators 468 (J5), 484 (J6), and 520 (J7) within the arm assembly 5 of the robot 1 represents a sophisticated kinematic design that optimizes functionality, range of motion, and biomimetic properties. As illustrated in FIGS. 23-28, the axis A₅ of the lower arm twist actuator 468 (J5) is perpendicular to the axis A₇ of the wrist pivot actuator 520 (J7). This design allows for independent control of forearm rotation and wrist pivoting, thereby enabling complex manipulations that closely mimic human wrist movements. Additional alternatives to this configuration could include the use of non-orthogonal axes to create asymmetric rotational ranges.

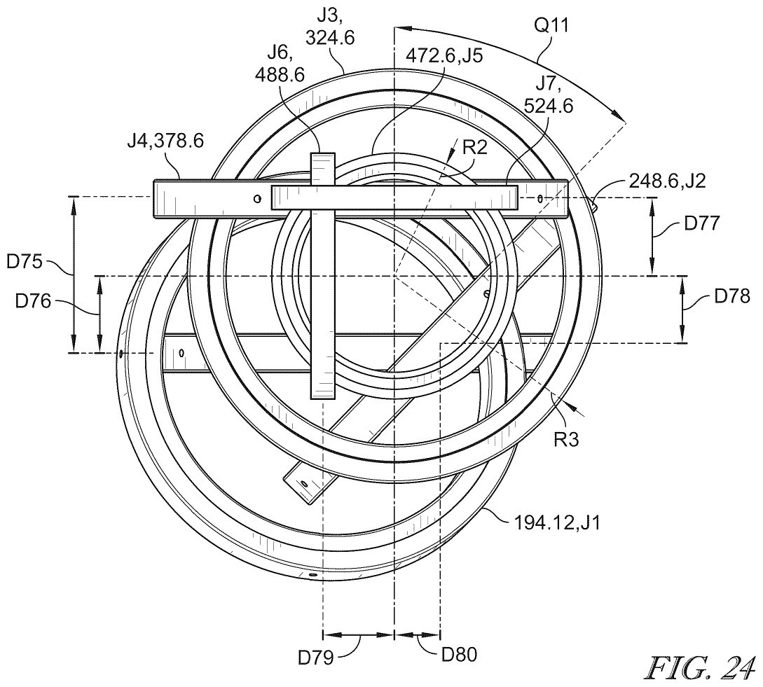

As shown in FIG. 24, the positioning of these actuators 468 (J5), 484 (J6), and 520 (J7) is further refined by a predefined offset along the Z-axis. Specifically, the cross-roller bearing plane B₇, which is positioned mid-width of the cross-roller bearing 524.6 of lower arm twist actuator 468 (J5), is offset from the center of axis A₅ of the lower arm twist actuator 468 (J5) by a distance of at least 1 mm, and preferably between 10 mm (40% of the radius of actuator 484 (J6)'s cross-roller bearing 488.6 of actuator 484 (J6) and 20 mm (which is 80% of the radius of the cross-roller bearing 488.6 of actuator 484 (J6). This offset serves multiple purposes. It allows for a more compact design of the wrist 50, provides enhanced mechanical clearance, and facilitates the integration of additional components such as sensors or actuation feedback systems. Variations of this configuration could include: (i) dynamic offset adjustment mechanisms, which may utilize actuated spacers or adaptive housing structures, (ii) flexible couplings or compliant interfaces within the offset mechanism to absorb vibrations and improve durability in high-stress applications, and/or (iii) any other structure or mechanism disclosed herein.

The non-alignment of axes A₅ and A₇ enhances the dexterity of the arm assembly 5. By offsetting these axes, the robot 1 can achieve a wider range of wrist positions without encountering mechanical interference between components. Variations of this design could include adjustable offsets using modular joints, incorporating telescopic mechanisms or angular adjustment modules that allow for dynamic realignment of the axes during operation, and/or passive compliance mechanisms, such as elastomeric or spring-damper systems.

An apparent feature of this design is the alignment relationship between the cross-roller bearing plane B₇ of the wrist pivot actuator 520 (J7) and the cross-roller bearing plane B₄ of the elbow actuator 374 (J4). These planes are substantially aligned and may be co-planar, with axis A₄ of the elbow actuator 374 (J4) being parallel to axis A₇ of the wrist pivot actuator 520 (J7). This alignment creates a kinematic linkage between the elbow and wrist movements, potentially allowing for more natural and coordinated arm motions. The spatial relationship between the elbow actuator 374 (J4) and the wrist pivot actuator 520 (J7) is such that if the cross-roller bearing of actuator 374 (J4) were translated along the Y-axis by just over 225 mm, moved rearward along the X-axis by between 5 and 10 mm, and reduced in size by approximately 25%, it would occupy nearly the identical position as the wrist pivot actuator 520 (J7). This relationship may facilitate simplified control algorithms and more intuitive motion planning for complex movements of the arm assembly 5.

The wrist flex actuator 484 (J6) introduces additional complexity and functionality to the wrist 50. Its axis A₆ is perpendicular to both axis A₅ of the lower arm twist actuator 468 (J5) and axis A₇ of the wrist pivot actuator 520 (J7), creating a three-dimensional rotational capability that closely mimics the range of motion of the human wrist. The center of the cross-roller bearing 488.6 of the actuator 484 (J6) is strategically offset from the axis connecting the centers of the cross-roller bearings 472.6 and 524.6 of actuators 468 (J5) and 520 (J7), respectively). This offset is at least 1 mm and preferably between 10 mm to 20 mm (which is 40% to 80% of the radius of the cross-roller bearing 488.6) along the X-axis. The wrist flex actuator 484 (J6) is positioned forward of both the lower arm twist actuator 468 (J5) and the wrist pivot actuator 520 (J7), which allows for the early coupling of its drive linkage to an outer extent of the wrist 50. This configuration may enable a greater range of wrist flexion and extension while maintaining a compact form factor. The drive linkage, which may be composed of high-strength materials such as metal alloys, carbon fiber reinforced polymers, or advanced thermoplastics like PEEK, can efficiently transmit force from the actuator to the wrist joint while accommodating the complex rotational movements of the wrist Additionally, the drive linkage may incorporate integrated torque and position sensors, thereby providing real-time feedback to the control system for enhanced precision and adaptability.

The overall arrangement of actuator axes A₃, A₅, and A₇ along a common chord creates a unified kinematic chain through the arm assembly 5. Axis A₃ and axis A₅ are co-linear, providing a continuous rotational axis for arm twisting movements, while axis A₇ is perpendicular to axis A₃ and axis A₅, enabling wrist pivoting. This configuration allows for smooth, coordinated movements that can seamlessly transition between different arm postures.

In alternative designs, additional actuators or passive compliance mechanisms could be integrated along these axes to provide enhanced adaptability or energy efficiency during operation. For example, spring-loaded mechanisms or dampers could be used to minimize energy consumption during repetitive tasks. The forward offset of axis A₄ from the common chord containing axes A₃, A₅, and A₇ is a design element that enhances the range of motion of the arm assembly 5, particularly in flexion and extension movements. While axes A₄ and A₇ are parallel with one another, their non-alignment in the same Z-plane contributes to the ability of the arm assembly 5 to achieve more human-like postures and movements. This offset may be adjusted in alternative configurations to accommodate specific task requirements, such as increased reach or compact storage profiles. Additionally, automated adjustment mechanisms could be integrated to modify the offset dynamically during operation, optimizing the performance of the arm assembly 5 in varying environments.

The perpendicular orientation of axis A₆ relative to axes A₃-A₅ and A₇, combined with its non-alignment with axes A₁-A₂, creates a complex rotational workspace for the wrist 50. This arrangement allows the wrist 50 to perform intricate movements that are necessary for fine manipulation tasks while avoiding kinematic singularities that could limit the dexterity of the arm assembly 5. Variations of this design may include modular actuators that can be easily replaced or reconfigured. The forward offset of the center of the cross-roller bearings for both axes A₄ and A₆ from the common chord is a design choice that may contribute to a more anthropomorphic arm profile while also potentially reducing the moment of inertia around the primary arm rotation axis.

The alignment and positioning of these actuators and bearings may be achieved through advanced manufacturing techniques such as five-axis CNC machining and coordinate measuring machine (CMM) verification. Tight tolerances, potentially on the order of +0.01 mm for mating surfaces, may be necessary to ensure proper function and longevity of the arm assembly 5. Advanced robotic assembly processes and real-time quality assurance systems could further optimize the alignment and integration of these components. In summary: (i) axes A₃, A₅, and A₇ may be substantially aligned along a common chord, wherein axes A₃ and A₅ may be co-linear and axis A₇ may be perpendicular to axes A₃ and A₅, (ii) axis A₄ may be offset forward of said common chord, (iii) axes A₄ and A₇ may be parallel with one another, but may not be aligned in the same Z-plane, (iv) axis A₆ may not be aligned with axes A₁-A₂ and may be perpendicular to axes A₃-A₅ and A₇, (v) the center of the cross-roller bearing for both axes A₄ and A₆ may be offset forward of said common chord, and (vi) any other calculations, ratios, comparisons, or information that can be gathered from the figures disclosed herewith.

d. Robot Head and Neck Assembly

The head and neck assembly 10 of the humanoid robot 1 may be designed to enhance its anthropomorphic characteristics while providing functional capabilities that support interaction, perception, and communication. Structurally, the head and neck assembly 10 may include two primary actuators: a head twist actuator 120 (J8.1), which is responsible for enabling rotational movement of the head 10 about the vertical axis (yaw), and a head nod actuator 140 (J8.2), which adjusts the pitch of the head 10 about the horizontal axis. Together, these actuators may provide two degrees of freedom (2 DoF) for the head 10, allowing it to perform movements that emulate human head motions. The head twist actuator 120 (J8.1) may typically be located at the base of the neck, where it interfaces with the torso 16, while the head nod actuator 140 (J8.2) may be positioned within the head 10 and enables forward and backward tilting of the head 10. The head twist actuator 120 (J8.1) and the head nod actuator 140 (J8.2) may utilize any motor, gearbox, sensors, bearings, encoders, and/or other components or parts that are discussed in subsequent actuator sections, wherein such components may be optimized for these movements.

The head 10 itself may serve as a multifunctional platform that may house a range of components within an impact-resistant polymer shell, such as high-resolution cameras, microphones, and displays. Cameras embedded within the head 10 may include RGB, depth-sensing, or thermal imaging capabilities, enabling the robot 1 to perform tasks such as object recognition, environmental mapping, and facial expression analysis. Microphones may be arranged in the neck of the robot 1 and may include an array to facilitate directional audio input and noise cancellation, thereby enhancing the ability of the robot 1 to understand and respond to verbal commands. Displays integrated into the head 10 could serve as user interfaces, providing visual feedback or conveying expressions to improve communication and user engagement. Functionally, the head and neck assembly 10 may be configured to support a variety of tasks, including directing the field of view of cameras embedded within the head 10. The head actuators (J8.1) and (J8.2) may work in coordination to position the head 10 accurately, enabling the robot 1 to track objects, focus on specific areas, or maintain eye contact during human-robot interactions. For example, the head twist actuator 120 (J8.1) may rotate the head 10 to follow a moving object, while the head nod actuator 140 (J8.2) adjusts the pitch to maintain an optimal viewing angle.

Although the head and neck assembly 10 may not be intended to contact or manipulate objects directly, it may play an important role in enhancing the interaction capabilities of the robot 1. Variations of this design could include the addition of a third actuator to provide roll motion, further increasing the range of movement of the head 10 to 3 DoF. This could enable more expressive head gestures, such as tilting the head sideways to convey curiosity or empathy. Alternatively, the actuators could be replaced with compact linear actuators or parallel-link mechanisms for specialized applications requiring higher precision or load capacity. Additionally, variations could include modular head designs that allow for quick customization or replacement of components.

e. Robot Central Region and Leg Assembly

The arrangement of actuators 680 (J9)-782 (J13) in the central portion 3 of the robot 1 may represent a biomechanical design that optimizes functionality, stability, and energy efficiency. These actuators J9-J13 are similar to, but higher torque than, the actuators that are included within the arm assemblies 5. Also, similar to the arm assemblies 5, the central portion 3 may be constructed from advanced materials to enhance mechanical properties, reduce weight, and improve durability. The torso lean actuator 680 (J9) may be positioned within the housing 642 of the pelvis 64, providing a stable base for torso movements. This positioning may allow for efficient force transmission and load distribution throughout the structure of the robot 1. The output adaptor 688 of the torso lean actuator 680 (J9) may be coupled to an extent of the spine 60, enabling precise control of the lean or roll motion of the robot 1. The torso twist actuator 620 (J10) may be located within the waist 174 of the robot 1, at a junction between the upper and lower body. The output adaptor of the torso twist actuator 620 (J10) may interface directly with an extent of the pelvis 64, facilitating rotational movement of the torso 16 relative to the lower body. The waist 174 itself may be coupled to a lower extent of the torso 16, creating a continuous kinematic chain from the pelvis 64 to the upper body.

The spatial arrangement of the torso lean actuator 680 (J9) and the torso twist actuator 620 (J10) may be engineered to maximize the range of motion of the robot 1 while maintaining structural integrity. Both actuators may be substantially centered along the sagittal plane of the robot 1, ensuring balanced force distribution and symmetrical movement capabilities. This centering may be important for maintaining the stability of the robot 1 during complex maneuvers and for preventing undesired torques that could compromise balance or efficiency. Variations of this design could include: (i) offsetting the actuators slightly from the sagittal plane to introduce asymmetrical capabilities, (ii) integrating active stabilization mechanisms, such as gyroscopic systems or dynamically adjustable counterweights, and/or (iii) a compliant actuator system with integrated spring-damping elements, which could provide passive shock absorption and energy recovery, improving the efficiency of the robot 1 during dynamic operations.

The 2 degrees of freedom (DoF) for the torso 16 (roll and yaw), which are provided by the torso lean actuator 680 (J9) and the torso twist actuator 620 (J10), may enhance the operational versatility of the robot 1. This configuration may allow the robot 1 to pivot its body to pick up items positioned at extreme angles, such as 90 degrees to its side, without the need for full body rotation. Additionally, it may enable the robot 1 to lean over obstacles, thereby expanding its reach and workspace. These capabilities may be valuable in dynamic environments where the robot 1 must interact with objects in various positions relative to its body. Variations of this setup could include: (i) integrating additional degrees of freedom, (ii) using a gimbal-like mechanism to replace the torso lean actuator 680 (J9) and the torso twist actuator 620 (J10), (iii) using sealed actuators with advanced thermal management systems, and/or (iv) using modular actuator designs.

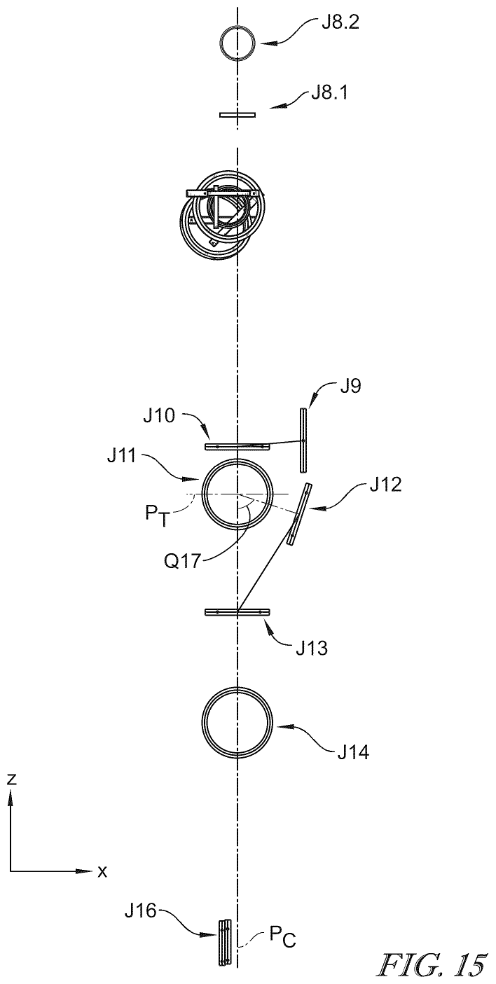

As illustrated in FIGS. 14-15, axis A₉ may be parallel with the transverse plane P_{T}, positioned within the sagittal plane P_{S}, and perpendicular to the coronal plane P_{C}. This orientation may allow for smooth rolling motions of the torso 16. Conversely, axis A₁₀ may be parallel with the coronal plane P_{C}, positioned within the sagittal plane P_{S}, and perpendicular to the transverse plane P_{T}, facilitating yaw movements. The perpendicular relationship between axes A₉ and A₁₀ may ensure independent control of roll and yaw motions, which minimizes mechanical interference and simplifies control algorithms. Variations or alternatives could include: (i) designing axes A₉ and A₁₀ with adjustable axes to provide customizable ranges of motion, and/or (ii) replacing the actuators with spherical joints driven by multi-axis actuators.

The spatial offset between the torso lean actuator 680 (J9) and the torso twist actuator 620 (J10) may be a design feature that optimizes the structure and functionality of the robot 1. The center of the cross-roller bearing 624.6 of the torso twist actuator 620 (J10) may be offset downward along the Z-axis from the cross-roller bearing 684.6 of the torso lean actuator 680 (J9) by a distance ranging from about 5 mm to 10 mm, representing 10% to 20% of the radius of the cross-roller bearing 684.6 of the torso lean actuator 680 (J9). This offset may allow for a more compact design of the waist 174 while maintaining the necessary range of motion for both actuators. Variations or alternatives to this design could include: (i) introducing dynamically adjustable offsets using linear actuators or telescoping mechanisms, (ii) utilizing rotary dampers or friction-based locking systems within the offset assembly, (iii) including compliant elements such as elastomeric couplings, and/or (iv) using magnetic or fluid-based bearings to replace traditional cross-roller bearings, offering smoother motion and reduced wear.

Furthermore, the center of the cross-roller bearing 684.6 of the torso lean actuator 680 (J9) may be offset rearward along the X-axis from the center of the cross-roller bearing 724.6 of the hip flex actuator 720 (J11) by a distance of at least 50 mm, and preferably between 80 mm and 120 mm, which is equivalent to 80% to 120% of the diameter of the cross-roller bearing 684.6 of the torso lean actuator 680 (J9). This rearward offset may allow the robot 1 to maintain its center of gravity within a stable range during forward-leaning motions. These carefully calculated offsets may result in the upper extents of the torso lean actuator 680 (J9) and the torso twist actuator 620 (J10) being substantially parallel to one another. This parallel configuration may be advantageous as it reduces the space required for spine roll and yaw movements, allowing for a more compact design of the central portion 3. The reduced space requirement in the waist 174 may directly translate to an increased volume in the torso 16, which can be utilized for larger battery capacity and enhanced computing capabilities, such as additional GPUs.

The design of the robot 1 may incorporate an approach to torso articulation that deviates from conventional humanoid robot architectures. Specifically, the robot 1 may lack a dedicated spine pitch actuator, a design choice that may yield advantages in terms of internal volume and power capacity. By eliminating this actuator, the volume within the torso 16 may be substantially increased, potentially by over 270%, from approximately 7 liters to over 19 liters. This expanded internal space may allow for the integration of larger power and computing systems, which may be beneficial for enhancing the operational capabilities and autonomy of the robot 1.

To further leverage the available internal volume, alternative configurations could incorporate modular battery packs that allow for hot-swapping during extended operations, ensuring near-continuous uptime. The design could also accommodate advanced energy storage technologies, such as solid-state batteries or supercapacitors, which provide higher energy densities and faster charging times. Additional variations might include segmented internal compartments for electromagnetic shielding, which would prevent interference between power systems and sensitive electronics. These adaptations may provide a scalable framework for enhancing the capabilities of the robot 1 while maintaining its overall efficiency and robustness.

While the omission of a dedicated spine pitch actuator may present certain limitations in terms of torso flexion, the robot 1 may compensate for this through an innovative use of its hip flex actuators 720 (J11). By coordinating the rotation of the hip flex actuators 720 (J11) in both legs 6, the robot 1 may achieve forward bending motions that approximate the functionality typically provided by a spine pitch actuator. This approach may represent a solution to maintaining forward bending capabilities while optimizing internal space utilization. The hip flex actuator 720 (J11) may be designed with enhanced torque and range-of-motion capabilities to accommodate this dual functionality. For instance, the hip flex actuator 720 (J11) may utilize any motor, gearbox, sensors, bearings, encoders, and/or other components or parts that are discussed in subsequent actuator sections, which may be optimized for these hip movements. In an alternative embodiment, the pelvis 64 may include integrated elastic elements or compliant mechanisms into the hip assemblies to provide passive assistance during bending motions, thereby reducing energy consumption. For environments requiring high durability, sealed bearing assemblies with integrated thermal management systems could ensure reliable operation under harsh conditions.

The structural configuration of the hip flex actuator 720 (J11) ensures optimized force transmission and enhanced stability. The direct coupling of the output adaptor 724 to both sides of the pelvis 64 forms a robust mechanical interface, effectively minimizing unnecessary motion loss and ensuring efficient torque transmission to the pelvis 64 and the lower limbs or leg assembly 6. By positioning the axis A₁₁ orthogonally to both axes A₁₀ and A₉, the design achieves an optimized distribution of forces and moments within the central portion 3 of the robot 1 . . . . This orthogonal relationship allows for independent and precise control of hip flexion/extension, spine yaw, and spine roll, mimicking the biomechanics of the human pelvis.

In an alternative embodiment, the output adaptor 724 could be replaced with a flexible or semi-flexible joint to introduce compliance that absorbs and dissipates external shocks during motion. Further, the robot 1 may include modular coupling systems that allow the pelvis 64 to be easily replaced or reconfigured. The orthogonal arrangement of axis A₁₁ with respect to axes A₁₀ and A₉ could also be adjusted to a skewed or angled configuration to address unconventional load paths or specialized tasks, such as navigating uneven terrain or executing non-linear movements. These modifications could integrate compliant or actively adjustable mechanisms to enable real-time reorientation of axis A₁₁ based on sensor feedback, thereby optimizing the adaptability of the system to dynamic environments. Further enhancements might include shock-dampening elements embedded within the adaptor assembly to mitigate wear and extend operational longevity. For example, these could include non-linear or helical geometries to simulate distinct gaits or stances.

The deliberate offset of axis A₁₁ along the Z-axis by over 30 mm, and preferably over 70 mm, increases the moment arm for hip movements. This may reduce the torque requirements for the actuator during certain operations while aligning the design with human anatomical structures to enable natural, human-like motion with an expanded range of movement. Variations of this configuration could involve modifying the offset to less than 70 mm. Adjustable mechanisms, such as telescoping mounts or modular inserts, could be implemented to allow for real-time customization for specific tasks. Further derivatives may include dynamic axis repositioning, facilitated by actuated linkages or compliant mechanisms, to adapt the Z-axis offset dynamically during operation, thereby optimizing the balance between high-torque and high-speed movements. Enhanced structural integration through the use of flexible composite joints or vibration-damping materials could also be introduced to improve movement precision and durability while mitigating wear during extended operation, ensuring the offset configuration remains versatile and beneficial across a wide range of humanoid robotic applications.

The alignment of axis A₁₁ in an axis plane that is parallel to the coronal plane P_{C} and aligned with axis A₁₀ is a feature contributing to the ability of the robot 1 to maintain balance and perform complex locomotion tasks. This configuration ensures consistency of the hip flexion/extension axis relative to the yaw axis of the spine 60, facilitating intuitive control algorithms and simplifying the inverse kinematics calculations required for precise leg movements. The co-planar relationship between axes A₁₁ and A₁₀ via a vertical plane parallel to the coronal plane P_{C} is particularly noteworthy, allowing for synchronized movements between hip flexion/extension and spine yaw. This enables fluid, human-like motions, such as turning while walking or reaching across the body, and enhances energy efficiency during locomotion by enabling more natural weight transfer between the legs 6. As an alternative, the alignment of axis A₁₁ could be adjusted to accommodate non-human gait patterns or specialized locomotion tasks, such as an asymmetric axis alignment to support navigation on uneven terrain. Such adjustments could utilize actuated mechanisms or compliant linkages driven by integrated sensor systems to maintain balance and optimize force distribution.

The direct coupling of the hip flex actuator 720 (J11) to the pelvis 64, which positions it closer to the torso lean actuator 680 (J9) and the torso twist actuator 620 (J10) than other actuators, represents an unconventional approach that offers several advantages. This compact configuration lowers the center of gravity of the robot 1, enhances stability, and simplifies the mechanical design of the hip joint, thereby improving reliability and reducing manufacturing complexity. The configuration of the hip pivot actuator 768 (J12) in relation to the hip flex actuator 720 (J11) and the pelvis 64 represents an advancement in humanoid robot kinematics. This arrangement, wherein the output adaptor 778 of the hip pivot actuator 768 (J12) is coupled to an extent of the housing of the hip flex actuator 720 (J11), creates an angular relationship between the axis A₁₂ and the transverse plane Pr. The angle, which may range between 1 and 45 degrees, preferably between 5 and 25 degrees, or more specifically between 10 and 20 degrees, is a design feature that enhances the overall range of motion and functionality of the robot 1. This angled configuration of axis A₁₂ relative to the transverse plane P_{T} offers several biomechanical advantages. Primarily, it allows for an increased range of motion in the hip Y or hip pitch direction. This expanded mobility is particularly beneficial in enabling the robot 1 to perform deep squats, facilitating easier transitions from a prone position to standing, and compensating for the absence of a dedicated spine Y actuator. The ability to achieve these complex movements is useful for a humanoid robot that is designed to operate in diverse environments and perform a wide array of tasks.

In alternative embodiments, the coupling mechanism between the hip pivot actuator 768 (J12) and the hip flex actuator 720 (J11) may incorporate a spherical joint, a custom-designed universal joint, or a semi-compliant pivot assembly to accommodate the angular offset while allowing for smooth, multi-axis motion. This joint could employ advanced bearing technologies, such as ceramic hybrid bearings, diamond-like carbon (DLC) coated surfaces, or polymer-based tribological coatings, to reduce friction and wear under high loads and frequent articulation. Furthermore, the angular range of axis A₁₂ could be dynamically adjustable through actuated linkages, compliant mechanisms, or shape-adaptive structures that leverage integrated micro-actuators. These features would enable the robot 1 to optimize its posture and movement for specific tasks, such as crawling, climbing, or navigating constrained spaces. Variations may also include modular configurations, where the hip pivot actuator 768 (J12) can be reoriented, adjusted in length, or swapped with alternative actuators. Additionally, the integration of smart materials, such as shape memory alloys or magnetorheological elastomers, could further enhance the adaptability and functionality of the hip pivot actuator 768 (J12) by allowing it to self-adjust based on load conditions or dynamic interactions with the environment. Advanced iterations might incorporate active damping mechanisms or energy recovery systems to improve efficiency and extend operational life under continuous high-stress movements.

The configuration of the hip pivot actuator 768 (J12) within the robot 1 represents a departure from conventional humanoid robot designs, offering benefits in terms of range of motion, structural integrity, and overall functionality. As highlighted, the axis A₁₂ of the hip pivot actuator 768 (J12) is not parallel or perpendicular to any other axis within the kinematic chain of the robot 1. This non-orthogonal arrangement creates a complex but highly versatile joint configuration that enhances the mobility and adaptability of the robot 1. Additional alternatives to this configuration could include introducing a hybrid mechanism that combines rotational and translational degrees of freedom to further expand the versatility of the hip pivot actuator 768 (J12). For example, a prismatic joint integrated along the axis A₁₂ could provide linear movement, enabling the robot 1 to extend or retract its leg laterally for tasks that require wide stances or precise positioning. Another variation might incorporate a cam-based system within the coupling mechanism to dynamically modify the angular orientation of axis A₁₂ in real time, optimizing the range of the actuator for specific tasks or environments. Further, a dual-axis actuator system could be employed, wherein the hip pivot actuator 768 (J12) is coupled to a secondary actuator that provides supplementary rotational or oscillatory motion, enhancing the agility of the robot 1 and its ability to perform complex maneuvers.

A vertical plane containing axis A₁₂ is perpendicular to a horizontal plane containing A₁₁, where A₁₁ represents the axis of another actuator, potentially the hip flex actuator 720 (J11) or the leg twist actuator 782 (J13). This geometric arrangement allows for a clear delineation of functions between the hip flex actuator 720 (J11) and the hip pivot actuator 768 (J12). To expand upon this design, alternative configurations could involve non-perpendicular alignments between these planes to introduce controlled coupling effects, enabling coordinated motions for complex tasks such as twisting while pitching. Another variation might include integrating a secondary, adjustable joint along axis A₁₂ to allow for dynamic modulation of its spatial orientation relative to axis A₁₁, thereby offering greater adaptability for varied terrains or task-specific requirements. Additionally, the use of compliant mechanisms or elastomeric connectors in the coupling of the hip pivot actuator 768 (J12) to other actuators could enhance energy absorption during rapid movements, which would reduce stress on structural components and improve durability in high-load scenarios. These alternatives further diversify the functional capabilities of the hip pivot actuator 768 (J12) configuration, broadening its applicability across various robotic applications.

As shown in the Figures, the hip pivot actuator 768 (J12) is not directly connected to the pelvis 64. Instead, it is directly coupled to the hip flex actuator 720 (J11). This configuration allows the hip pivot actuator 768 (J12) to be angled relative to both the hip flex actuator 720 (J11) and the pelvis 64, creating a unique kinematic chain that enhances the range of motion and load-bearing capabilities of the robot 1. The angled positioning of the hip pivot actuator 768 (J12) may be achieved through a specialized coupling mechanism, potentially incorporating a universal joint, a ball-and-socket joint, or a custom-designed interface that accommodates the non-orthogonal alignment while allowing smooth multi-axis motion. Alternative approaches could include a compliant linkage system, integrating elastomeric joints or flexure-based designs to absorb and redistribute dynamic loads, enhancing durability and range of motion.

Also, the center of the cross-roller bearing 772.6 of the hip pivot actuator 768 (J12) is located below, or closer to the support surface, than the cross-roller bearing centers of actuators 680 (J9), 620 (J10), and 720 (J11). This lower positioning of the hip pivot actuator 768 (J12) creates a unique load path through the structure of the robot 1, placing the main stresses for supporting the robot on an angled link that is not co-linear with other axes in the leg 6 or hip. The angled configuration of the hip pivot actuator 768 (J12) also has implications for the overall balance and stability of the robot 1. By positioning the hip roll actuator lower in the kinematic chain, the center of mass of the robot 1 during lateral movements may be more stable, potentially improving balance during single-leg support phases or when subjected to lateral forces. This configuration may allow for more human-like gait patterns and enhanced agility in multi-directional movements. Potential modifications to this design could involve an actively adjustable mounting system for the hip pivot actuator 768 (J12), which may utilize linear actuators or stepper-controlled pivots to dynamically adjust the axis orientation, further optimizing the performance of the robot 1 in complex environments or under varied load conditions.

Still referring to FIGS. 7-9 and 12-13, the leg twist actuator 782 (J13) may be positioned near the hip pivot actuator 768 (J12) within the hip housing 762, and its output adaptor 790 may be coupled to an extent of the lower thigh 80. The Leg twist actuator 782 (J13) provides the robot 1 with leg yaw or leg twist, and its axis A₁₃ may be parallel with axis A₁₀ of the torso twist actuator 620 (J10) and may be positioned perpendicular to axis A₁₁ of the hip flex actuator 720 (J11). This placement allows axes A₁₀, A₁₁, and A₁₃ to be positioned in a single vertical plane or a plane parallel with the coronal plane P_{C}. This placement helps to ensure that the weight of the robot 1 is supported by the hips/legs when the robot 1 is at rest. The cross-roller bearing 624.6 associated with the torso twist actuator 620 (J10) could be positioned in the location of the cross-roller bearing 786.6 of the leg twist actuator 782 (J13) by translating the cross-roller bearing 624.6 by approximately 250 mm in the downward Z direction and translating it in the Y direction to either one of the legs that contains the leg twist actuator 782 (J13).

The configuration of the hip pivot actuator 768 (J12) within the robot 1 represents a departure from conventional humanoid robot designs, offering benefits in terms of range of motion, structural integrity, and overall functionality. As highlighted, the axis A₁₂ of the hip pivot actuator 768 (J12) is not parallel or perpendicular to any other axis within the kinematic chain of the robot 1. This non-orthogonal arrangement creates a complex but versatile joint configuration that enhances the mobility and adaptability of the robot 1. Additional alternatives to this configuration could include introducing a hybrid mechanism that combines rotational and translational degrees of freedom to further expand the versatility of the hip pivot actuator 768 (J12). For example, a prismatic joint integrated along the axis A₁₂ could provide linear movement, enabling the robot 1 to extend or retract its leg laterally for tasks that require wide stances or precise positioning. Another variation might incorporate a cam-based system within the coupling mechanism to dynamically modify the angular orientation of axis A₁₂ in real time, thus optimizing the range of the actuator for specific tasks or environments. Further, a dual-axis actuator system could be employed, where the hip pivot actuator 768 (J12) is coupled to a secondary actuator that provides supplementary rotational or oscillatory motion, enhancing the agility of the robot 1 and its ability to perform complex maneuvers.

A vertical plane containing axis A₁₂ is perpendicular to a horizontal plane containing axis A₁₁, where axis A₁₁ represents the axis of another actuator, potentially the hip flex actuator 720 (J11) or the leg twist actuator 782 (J13). This geometric arrangement allows for a clear delineation of functions between the hip flex actuator 720 (J11), which provides hip/leg pitch, and the hip pivot actuator 768 (J12), which provides hip/leg roll. To expand upon this design, alternative configurations could involve non-perpendicular alignments between these planes to introduce controlled coupling effects, which would enable coordinated motions for complex tasks such as twisting while pitching. Another variation might include integrating a secondary, adjustable joint along axis A₁₂ to allow for dynamic modulation of its spatial orientation relative to axis A₁₁, offering greater adaptability for varied terrains or task-specific requirements. Additionally, the use of compliant mechanisms or elastomeric connectors in the coupling of the hip pivot actuator 768 (J12) to other actuators could enhance energy absorption during rapid movements, thereby reducing stress on structural components and improving durability in high-load scenarios. These alternatives further diversify the functional capabilities of the hip pivot actuator 768 (J12) configuration, broadening its applicability across various robotic applications.

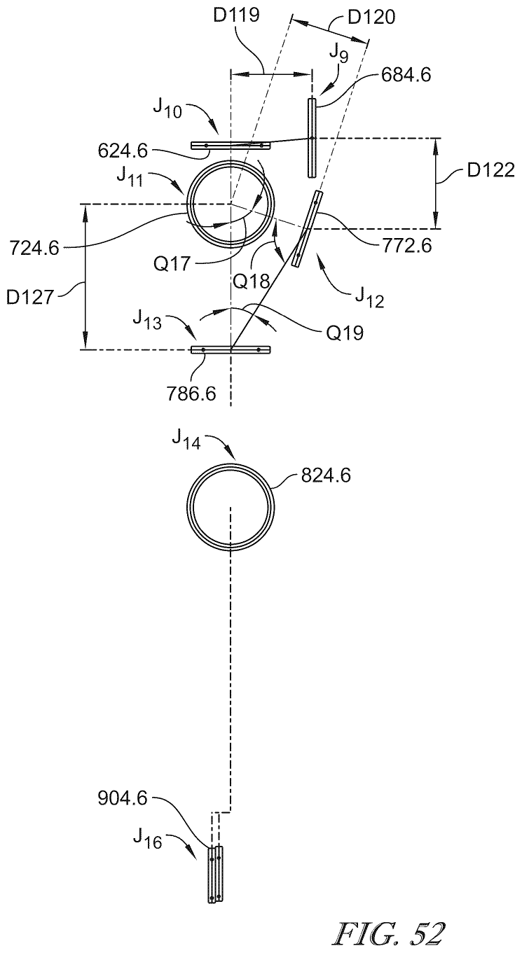

As shown in FIGS. 7-9 and 14-15, a knee actuator 820 (J14) may be housed in the lower thigh 80 and provides bending motion to the leg 6. Unlike other conventional robots, the knee actuator 820 (J14) may not be a linear actuator and may not be driven by a linkage. Instead, said knee actuator may be a rotary actuator that is coupled to the housings associated with the lower thigh 80 and the shin 84. As shown in FIG. 52, the cross-roller bearing 824.6 for the knee actuator 820 (J14) contained in both legs may be positioned on the left side of vertical planes that are parallel with the sagittal plane and aligned with axis A₁₃. This is unlike the position of all other cross-roller bearings contained within the robot 1, as said cross-roller bearing 824.6 of the knee actuator 820 (J14) may not be in a mirrored location across the sagittal plane P_{S} of the robot 1. This may be beneficial because it allows the lower thigh 80's and shin 84 to be identical to one another, which reduces manufacturing cost, unique parts, etc.

Finally, a foot flex actuator 860 (J15) may be housed in the shin 84 and may include a ballscrew linear actuator for pitch movement of the foot 92, and a foot roll actuator 900 (J16) may be housed within the talus 88 to allow a rolling motion of the foot 92. Placing the foot roll actuator 900 (J16) in the foot 92 may be an uncommon solution because it increases the torque requirements for other actuators contained in the leg 6, namely, actuators 720 (J11), 768 (J12), and 820 (J14). Unlike the conventional coupling of linear and rotary actuators, the housing of the foot roll actuator 900 (J16) may be designed to be directly coupled to the output of the foot flex actuator 860 (J15).

To further mimic human-like movement capabilities, the leg assemblies 6 may incorporate passive dynamic elements. For instance, spring-loaded mechanisms in the ankle or knee joints may store and release energy during the gait cycle, potentially improving efficiency and providing a more natural walking motion. These passive elements may work in conjunction with the active actuators to create a hybrid system that combines the benefits of both active control and passive dynamics. In some implementations, the leg assemblies 6 may include active cooling systems to manage heat generated by the actuators during prolonged or high-intensity operations. This may involve the integration of heat sinks, fluid cooling channels, or thermoelectric devices to dissipate heat efficiently and maintain optimal operating temperatures for the electronic and mechanical components. Functionally, the control system for the central region 3 and leg assemblies 6 of the robot 1 employs algorithms to coordinate the actions of multiple actuators, ensuring precise and efficient movement. These algorithms dynamically account for factors such as the posture of the robot 1, its intended motion, and environmental conditions to determine optimal actuation patterns. For instance, when climbing stairs, the system adjusts the timing and force of actuator engagements to lift the leg 6 and place the foot 92 accurately on each step.

By Incorporating machine learning techniques, such as reinforcement learning and evolutionary algorithms, the control system adapts over time by analyzing data from repeated movements and interactions with various environments. This adaptive capability enhances efficiency, stability, and natural movement, enabling the robot 1 to tackle increasingly complex locomotion tasks. Furthermore, prediction algorithms may leverage data from visual sensors, inertial measurements, and historical movement patterns to anticipate terrain changes or obstacles, allowing for preemptive gait adjustments for smoother and more efficient navigation across varied surfaces. The system integrates seamlessly with the overall balance and posture control of the robot 1, continuously adjusting actuator outputs to maintain stability during dynamic movements and external perturbations. By coordinating leg 6 motions with upper body actions, such as arm movements and torso 16 adjustments, the control system achieves whole-body balance and advanced locomotion strategies tailored to the robot's unique physical configuration and operational environments.

The robot 1 may also be equipped with an extensive suite of sensors and actuators that operate in unison to achieve human-like mobility and dexterity. Distributed sensors, which may include force sensors, capacitive tactile arrays, optical flow sensors, LiDAR sensors, ultrasonic sensors, infrared sensors, temperature sensors, magnetic field sensors, radar systems, and/or chemical sensors, may allow the robot 1 to perceive environmental stimuli with high resolution and accuracy. For instance, force sensors embedded in the hands 56 of the robot 1 may enable adaptive grip strength, allowing the robot 1 to handle objects of varying fragility, from delicate glassware to heavy tools. Meanwhile, inertial measurement units (IMUs) located in the torso 16 and legs 6 may work in conjunction with proprioceptive sensors to maintain balance and posture during motion. Further, the robot 1 may have a vision system that uses convolutional neural networks (CNNs) to analyze real-time visual data to aid in object recognition, obstacle avoidance, and spatial mapping. The motion planning system of the robot 1 may employ algorithms, such as model predictive control (MPC), deep neural networks (DNNs), convolutional neural networks (CNNs), recurrent neural networks (RNNs), transfer learning, and genetic algorithms. These algorithms may process sensory inputs and generate smooth, coordinated movements that replicate natural human motion, incorporating predictive adjustments for complex, multi-task scenarios.

### 7. Degrees of Freedom of the Robot

The high level configuration of the robot 1 may include 62 degrees of freedom (DoF). In particular, the 62 degrees of freedom may be distributed within the robot 1 as follows:
Upper Portion 2: 48 degrees of freedom (77% of the robot's total DoF)
   Head/Neck 10: 2 degrees of freedom (3% of the robot's total DoF)
   Upper Portion of the Torso 16: 2 degrees of freedom (3% of the robot's total DoF)
   Each Arm Assembly 5: 6 degrees of freedom (10% of the robot's total DoF)
      Each Shoulder 26: 1 degree of freedom (1% of the robot's total DoF)
      Each Upper Arm Assembly 24: 2 degrees of freedom (3% of the robot's total DoF).
         Each Upper Humerus 30: 1 degree of freedom (1% of the robot's total DoF)
         Each Elbow 39: 1 degree of freedom (1% of the robot's total DoF)
      Each Lower Forearm 46: 2 degrees of freedom (3% of the robot's total DoF)
      Each Wrist 50: 1 degree of freedom (1% of the robot's total DoF)
   Each Hand 56: 16 degrees of freedom (26% of the robot's total DoF)
      Each Finger: 3 degrees of freedom (5% of the robot's total DoF)
      Thumb: 4 degrees of freedom (6% of the robot's total DoF).
Central Portion 3: 10 degrees of freedom (16% of the robot's total DoF)
   Spine 60: 1 degree of freedom (1% of the robot's total DoF)
   Pelvis 64: 1 degree of freedom (1% of the robot's total DoF)
   Each Hip 70: 1 degree of freedom (1% of the robot's total DoF)
   Each Upper Thigh 76: 2 degrees of freedom (3% of the robot's total DoF)
   Each Lower Thigh 80: 1 degree of freedom (1% of the robot's total DoF).
Lower Portion 4: 4 degrees of freedom (6% of the robot's total DoF)
   Each Shin 84: 1 degree of freedom (1% of the robot's total DoF)
   Each Talus 88/Foot 92: 1 degree of freedom (1% of the robot's total DoF)
      The distribution of degrees of freedom throughout the structure of the robot 1 may be designed to optimize its capabilities for performing human-like tasks. For example, positioning approximately 77% of the degrees of freedom in the upper portion 2 of said robot 1 may allow said robot 1 to perform dexterous tasks that could be challenging without a substantial majority of the degrees of freedom being positioned in said upper portion 2. Additionally, having a relatively small number of degrees of freedom within the central portion 3 may allow the robot 1 to have a larger torso volume. Furthermore, including only about 6% of the degrees of freedom within the lower portion 4 of the robot 1 may help to minimize the torque placed on the knees and hips.

It should also be understood by those of skill in the art of designing humanoid robots that each portion of the robot 1 has a different number of degrees of freedom. It is understood that the number/location of degrees of freedom associated with the disclosed humanoid robot materially and substantially differ from the number/location of degrees of freedom for a non-humanoid robot. As such, the number/location of degrees of freedom from a non-humanoid robot cannot be simply adopted or implemented into a humanoid robot without careful analysis and verification of the complex realities of designing, testing, and manufacturing a general purpose humanoid robot. Theoretical designs that are an attempt to implement such modifications from a non-humanoid robot are insufficient (and in some instances, woefully insufficient) because they amount to mere design exercises that are not tethered to the complex realities of successfully designing, testing, and manufacturing a general purpose humanoid robot.

### 8. Commonality of Actuator Types

As noted above, the majority of actuators in the robot 1 are selected from types of similar actuators. As shown coded with selected stipple patterns in FIGS. 7, 10, and 14, (i) a first type of actuator includes hip flex actuator (J11) and the knee actuator (J14); (ii) a second type of actuator includes torso lean actuator (J9), the torso twist actuator (J10), the hip pivot actuator (J12), and the leg twist actuator (J13); (iii) a third type of actuator includes arm actuator (J1), the shoulder actuator (J2), the upper arm twist actuator (J3), and the elbow actuator (J4); (iv) a fourth type of actuator includes the talus actuator (J16); and (v) a fifth type of actuator includes lower arm twist actuator (J5), the wrist flex actuator (J6), and the wrist pivot actuator (J7). The head actuators (J8.1, J8.2) may also be a fifth type of actuator with a modified housing and/or drive size. As will be discussed in further detail, the first through fifth types may include brushless DC motors with a strain wave gearbox. Commonality between the actuators beneficially reduces costs, reduces assembly time, reduces the number of unique parts that are required, decreases debugging time, and increases modularity and serviceability. In fact, said commonality extends to the fact that the first through the fourth types of actuators have an identical arrangement of components, and the first three types of actuators utilize the exact same electronics.

The primary difference in the five common actuators is a change in drive size from the first to the fifth type. The first type of actuator (J11, J14) may have a momentary peak torque ranging from 265.6-398.4 N-m, and preferably from 298.8-365.2 N-m. The second type of actuator (J9, J10, J12, J13) may have a momentary peak torque ranging from 101.6-152.4 N-m, and preferably from 114.3-139.7 N-m. The third type of actuator (J1-J4) may have a momentary peak torque ranging from 72.8-109.2 N-m, and preferably from 81.9-100.1 N-m. The fourth type of actuator (J16) may have a momentary peak torque ranging from 48.8-73.2 N-m, and preferably from 54.9-67.1 N-m. The fifth type of actuator (J5-J7) may have a momentary peak torque ranging from 17.6-26.4 N-m, and preferably from 19.8-24.2 N-m. Additionally, a modified fifth type of actuator (J8.1, J8.2) may have a momentary peak torque ranging from 72.8-109.2 N-m, and preferably from 81.9-100.1 N-m. The sixth type of actuator (lower leg) may have a momentary peak torque ranging from 96-144 N-m, and preferably from 108-132 N-m. The seventh type of actuator (hands) may have a momentary peak torque ranging from 3.1-4.7 N-m, and preferably from 3.5-4.3 N-m. While the housing of the individual actuator types may also vary, the assembly of each type of actuator is substantially similar.

It should be noted that the actuators (J1)-(J16) may utilize a range and/or combination of advanced motor types, including, but not limited to, brushless DC motors, stepper motors, servo motors, coreless DC motors, synchronous AC motors, asynchronous induction motors, linear motors, piezoelectric motors, direct-drive motors, switched reluctance motors, permanent magnet synchronous motors (PMSMs), axial flux motors, and hybrid stepper motors. These motors may employ rare-earth permanent magnets, such as neodymium-iron-boron (NdFeB) alloys, samarium-cobalt (SmCo) magnets, ferrite magnets, alnico magnets, flexible magnets, bonded rare-earth magnets, and high-temperature permanent magnets, to achieve high torque density and energy efficiency. Motor windings may include high-conductivity copper wire with advanced ceramic or polyimide insulation for superior thermal and electrical performance. The motors may be coupled with various high-reduction gear mechanisms that are designed for precision and load handling. Examples of such mechanisms include, but are not limited to, strain wave gearboxes (e.g., Harmonic drives), cycloidal reducers, planetary gearboxes, bevel gear systems, worm gears, parallel shaft helical gear mechanisms, spur gear assemblies, crossed helical gear systems, double-enveloping worm gears, herringbone gears, hypoid gears, rack-and-pinion systems, bevel hypoid gears, epicyclic gear trains, and differential gear systems. Additionally, some implementations may incorporate custom gear profiles that are optimized for torque transfer efficiency, backlash reduction, and noise minimization.

Examples of these alternative combinations include the arm actuator 190 (J1) or the shoulder actuator 280 (J2) utilizing a synchronous reluctance motor (SynRM) coupled with a compound planetary gearbox. In contrast, the wrist pivot actuator 520 (J7) might employ a coreless DC motor paired with a strain wave gearbox. This system could achieve reduction ratios in the range of 1:50 to 1:160, depending on the specific performance requirements. For actuators requiring a balance between speed and torque, such as the elbow actuator 374 (J4), a hybrid stepper motor combined with a cycloidal drive might be employed. This combination could achieve reduction ratios (e.g., 1:30 to 1:87), offering a good compromise between speed and force. In applications where backdrivability is useful, such as in the knee actuator 820 (J14), a direct-drive torque motor might be used in conjunction with a cable-driven differential mechanism. The cable system could be designed to achieve modest reduction ratios (e.g., 1:5 to 1:15) while maintaining high efficiency and low friction. For joints that require extreme precision, like the head nod actuator 140 (J8.2), a closed-loop stepper motor system coupled with a micro-harmonic drive could be implemented. This configuration allows for micro-stepping capabilities and ultra-high reduction ratios (potentially exceeding 1:1000), enabling very fine angular adjustments. In scenarios where weight reduction is paramount, such as in distal joints like the wrist flex actuator 484 (J6), a flat or pancake-style brushless DC motor might be combined with a strain wave gearbox. This ultra-compact design could achieve reduction ratios from 1:50 to 1:160 while minimizing the added mass at the end of the arm assembly 5. For actuators that experience widely varying loads, like the hip flex actuator 720 (J11), a variable transmission system could be employed. This might involve a continuously variable planetary (CVP) gearbox coupled with a high-torque AC servomotor. The CVP allows for dynamic adjustment of the reduction ratio (e.g., from 1:1.5 to 1:120) based on real-time load conditions, which optimizes performance across different operating scenarios.

In applications that require high power density and thermal management, such as the torso twist actuator 620 (J10), a liquid-cooled axial flux permanent magnet motor could be paired with a multi-stage epicyclic gearbox. This setup allows for high continuous torque output while achieving reduction ratios of up to 1:500 or more through the cascaded planetary stages. For joints that benefit from inherent compliance, like the foot roll actuator 900 (J16), a series elastic actuator (SEA) configuration might be used. This could involve a standard brushless DC motor coupled with a ball screw mechanism and a torsional spring element. The effective reduction ratio of this system can vary based on the spring stiffness and the ball screw pitch, potentially ranging from 1:10 to 1:100. In scenarios where extremely high reduction ratios are required, such as in a fine manipulation end-effector, a combination of different gearing types might be employed. For example, a worm gear (providing a reduction of 1:50) could be coupled with a cycloid reducer (1:87 reduction), resulting in a compound reduction ratio of 1:4350.

Additionally, to achieve exceptional positional accuracy and ensure reliable operation, each motor may be equipped with advanced encoders. These encoders could be of various types, including, but not limited to, optical, magnetic, capacitive, inductive, resistive, piezoelectric, hall-effect, potentiometric, or ultrasonic. These encoders may facilitate sub-millimeter-level accuracy, which is helpful for applications that require meticulous movement control. To complement positional data, said actuator may include integrated torque sensors, which may be of types such as strain gauges, piezoresistive sensors, magnetoelastic sensors, capacitive sensors, fiber-optic sensors, or rotary transformers. Additionally or alternatively, the actuators may include current sensors, such as Hall-effect sensors, shunt resistors, fluxgate sensors, Rogowski coils, or magnetoresistive sensors. Furthermore, the system may incorporate micro-electromechanical systems (MEMS) gyroscopes and/or accelerometers, which provide additional sensory data related to orientation, angular velocity, and linear acceleration. This sensory integration enhances the ability of the robot 1 to navigate complex environments and maintain stability during operation.

Further, the actuators or the output of the actuators may include bearing housings constructed using advanced materials. Examples of such materials include carbon-fiber-reinforced polymers (CFRPs), fiberglass-reinforced polymers (FRPs), metal alloys, polyetheretherketone (PEEK), thermoplastic composites, and ultra-high-molecular-weight polyethylene (UHMWPE). Additionally, the manufacturing processes for CFRPs, such as filament winding or automated fiber placement, allow for precise control over fiber orientation, further optimizing the mechanical performance of the housings. The bearings themselves can be fabricated from, include, or be processed using materials such as high-grade steel alloys (e.g., AISI 52100, M50, or 440C stainless steel), high-performance nickel-based superalloys (e.g., Inconel 718 or Hastelloy), cobalt-based alloys (e.g., Stellite), advanced ceramics (e.g., alumina or zirconia-based composites), and polymer matrix composites reinforced with carbon or aramid fibers. These materials may also benefit from advanced heat treatments (e.g., vacuum hardening or cryogenic treatment), surface engineering processes (e.g., ion implantation or physical vapor deposition), or specialized coatings.

To further optimize performance, the rolling elements of the bearings may be composed of advanced ceramic materials (e.g., silicon nitride, tungsten carbide, or zirconia), sapphire, or composite materials that combine ceramic with metal or polymer matrices. In another embodiment, the assembly may incorporate cylindrical roller bearings, angular contact ball bearings, or hybrid bearings that combine steel races with ceramic rolling elements. Additionally, the assembly may incorporate spherical roller bearings, tapered roller bearings, needle roller bearings, magnetic bearings, or hybrids or combinations thereof. Cutting-edge manufacturing techniques, including additive manufacturing methods like selective laser melting (SLM), could be employed to create complex bearing geometries. These geometries may integrate features such as internal cooling channels, lubrication reservoirs, or textured surfaces to enhance lubrication retention and minimize wear.

The incorporation of such features allows for improved thermal management, reduced friction, and consistent lubrication distribution, even under challenging operating conditions. Additive manufacturing also enables the production of customized bearing designs with minimal material waste, which aligns with sustainable manufacturing practices. In addition to additive manufacturing, other advanced processes like precision machining, laser hardening, or chemical vapor deposition (CVD) coatings may be applied to enhance the surface properties of the bearings. These techniques can improve wear resistance, reduce friction, and provide protection against corrosion, further extending the operational life of the components. The integration of smart sensors within the bearing housing is another potential enhancement, which would allow for real-time monitoring of parameters such as temperature, vibration, and load. This data can be used to predict maintenance needs and prevent unexpected failures, thereby ensuring optimal performance and reliability in various applications.

### 9. Angles and Distances of the Robot

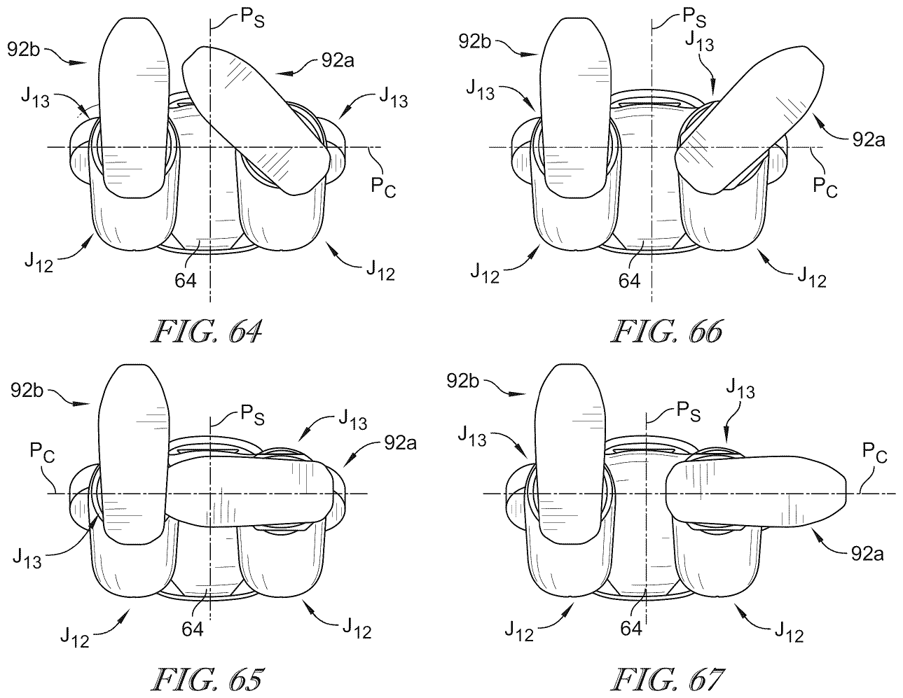

As best shown in FIGS. 63-64, the actuators contained in the robot 1 are spaced apart from one another and provide said robot 1 with a humanoid configuration. While this configuration is not limiting, it can be generally seen that the disclosed robot 1 has the following features. For example, the arm span that extends from a fingertip on a first hand to the opposed fingertip on the second hand is greater than the actuator height that extends from the foot roll actuator 900 (J16) to the uppermost head actuator. The length of each arm, which extends between the outermost extents of the wrist actuators (J7) is less than, or up to 20% less than, the length of each leg 6, which extends from the center point on the hip flex actuator (J11) to the bottom of the foot roll actuator 900 (J16). The center hip distance, which extends from the center point on a hip flex actuator 720 (J11) to the center point on an opposed hip flex actuator (J11), is 30% less than the distance between the center point on a shoulder actuator 280 (J2) and the center point on an opposed shoulder actuator 280 (J2). Other ratios, calculations, or information can be gathered from the figures in connection with the tables included herein.

TABLE 3

| | Lower | Upper | Preferred Lower | Preferred Upper |
|---|---|---|---|---|
| Distance (mm) | Bound | Bound | Bound | Bound |
| D1 | 1429 | 2144 | 1608 | 1965 |
| D2 | 1302 | 1953 | 1465 | 1790 |
| D13 | 176 | 265 | 199 | 243 |
| D16 | 182 | 274 | 205 | 251 |
| D17 | 19 | 29 | 22 | 27 |
| D24 | 232 | 348 | 261 | 319 |
| D26 | 303 | 454 | 340 | 416 |
| D29 | 60 | 89 | 67 | 82 |
| D34 | 690 | 1036 | 777 | 949 |
| D35 | 1289 | 1933 | 1450 | 1772 |
| D39 | 89 | 134 | 100 | 123 |
| D42 | 175 | 263 | 197 | 241 |
| D44 | 64 | 96 | 72 | 88 |
| D75 | 26 | 39 | 29 | 36 |
| D76 | 13 | 19 | 14 | 18 |
| D77 | 13 | 20 | 15 | 18 |
| D78 | 11 | 17 | 13 | 15 |
| D91 | 10 | 16 | 12 | 14 |
| D93 | 13 | 20 | 15 | 18 |
| D95 | 73 | 110 | 82 | 101 |
| D97 | 109 | 163 | 122 | 150 |
| D99 | 103 | 155 | 116 | 142 |
| D101 | 70 | 105 | 79 | 96 |
| D103 | 58 | 88 | 66 | 80 |
| D105 | 58 | 86 | 65 | 79 |
| D107 | 18 | 27 | 20 | 25 |
| D109 | 3 | 5 | 4 | 5 |
| D111 | 8 | 12 | 9 | 11 |
| D113 | 7 | 11 | 8 | 10 |
| D115 | 9 | 14 | 11 | 13 |
| D117 | 21 | 31 | 23 | 28 |
| D119 | 79 | 119 | 89 | 109 |
| D120 | 78 | 118 | 88 | 108 |
| D122 | 88 | 132 | 99 | 121 |
| D127 | 142 | 214 | 160 | 196 |

TABLE 4

| Angle | Lower | Upper | Preferred Lower | Preferred Upper |
|---|---|---|---|---|
| (Degrees) | Bound | Bound | Bound | Bound |
| Q1 | 14 | 22 | 16 | 20 |
| Q2 | 20 | 30 | 22 | 27 |
| Q3 | 6 | 8 | 6 | 8 |
| Q4 | 69 | 103 | 77 | 94 |
| Q6 | 10 | 16 | 12 | 14 |
| Q7 | 2 | 4 | 3 | 3 |
| Q10 | 9 | 14 | 10 | 13 |
| Q11 | 35 | 53 | 40 | 48 |
| Q13 | 66 | 98 | 74 | 90 |
| Q14 | 17 | 26 | 19 | 24 |
| Q15 | 17 | 25 | 19 | 23 |
| Q17 | 58 | 86 | 65 | 79 |
| Q18 | 61 | 91 | 68 | 83 |
| Q19 | 26 | 39 | 29 | 36 |

TABLE 5

| | Lower | Upper | Preferred Lower | Preferred Upper |
|---|---|---|---|---|
| Radius (mm) | Bound | Bound | Bound | Bound |
| R1 | 28 | 42 | 32 | 39 |
| R2 | 20 | 31 | 23 | 28 |
| R3 | 34 | 52 | 39 | 47 |

### 10. Kinematics of the Upper Portion

The following includes a discussion of various kinematic movements, elements, and aspects of the arm assemblies of a robot. The specific details set forth through the figures and examples provide a thorough understanding of the relevant teachings. The present teachings can be practiced, however, without such details and/or in alternative embodiments or configurations. In some instances, known methods, procedures, components, and/or circuitry have been described at a relatively high level, without detail, to avoid unnecessarily obscuring aspects of the present disclosure. The combination of the pictorial disclosure and written disclosure of the spine and lower body assemblies are examples of the principles of the disclosed assemblies, methods, and systems, and are not intended to limit the broad aspects of the disclosed concepts to the illustrated embodiments.

Based on the above described component locations and positions, the arm actuator 190 (J1) has a range of motion that is between 180 degrees and 270 degrees, and preferably between 210 degrees and 240 degrees. This corresponds to an angle between 72 degrees forward from the coronal plane to 162 degrees rearward from the coronal plane. Likewise, the shoulder actuator 280 (J2) has a range of motion that is between 120 degrees and 180 degrees, and preferably between 140 degrees and 155 degrees. This corresponds to an angle between 32 degrees forward from the sagittal plane to 129 degrees rearward from the sagittal plane. The upper arm twist actuator 320 (J3) has a range of motion that is between 190 degrees and 360 degrees, and preferably between 220 degrees and 360 degrees. This corresponds to an angle between 120 degrees forward from the coronal plane to 120 degrees rearward from the coronal plane. Finally, the elbow actuator 374 (J4) has a range of motion that is between 120 degrees and 180 degrees, and preferably between 140 degrees and 160 degrees. This corresponds to an angle between 162 degrees forward from the coronal plane to 12 degrees rearward from the coronal plane.

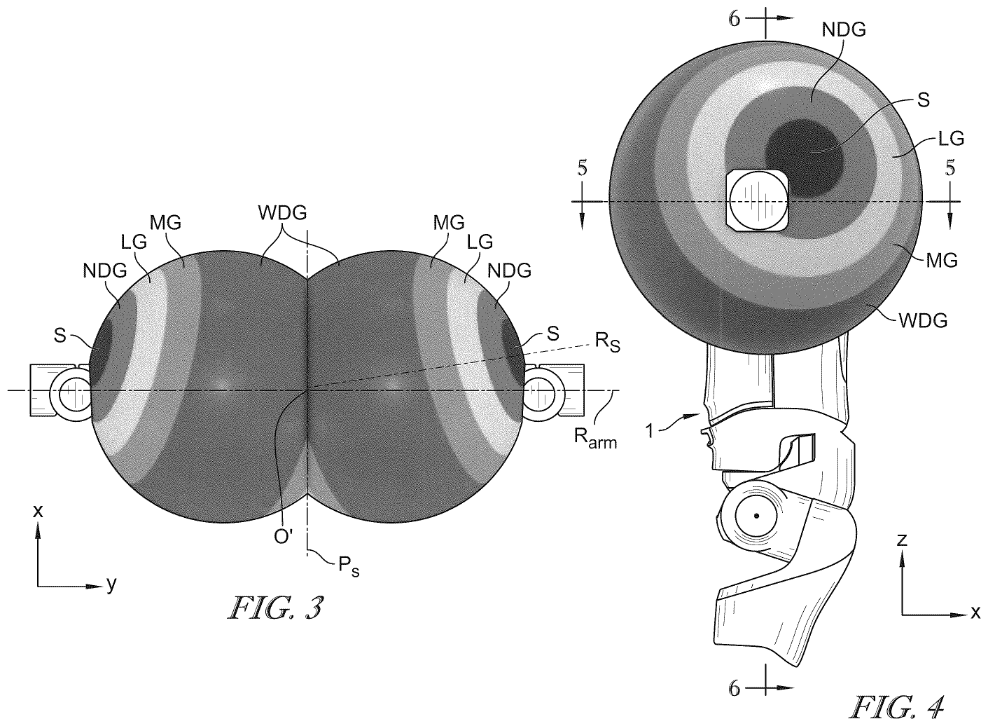

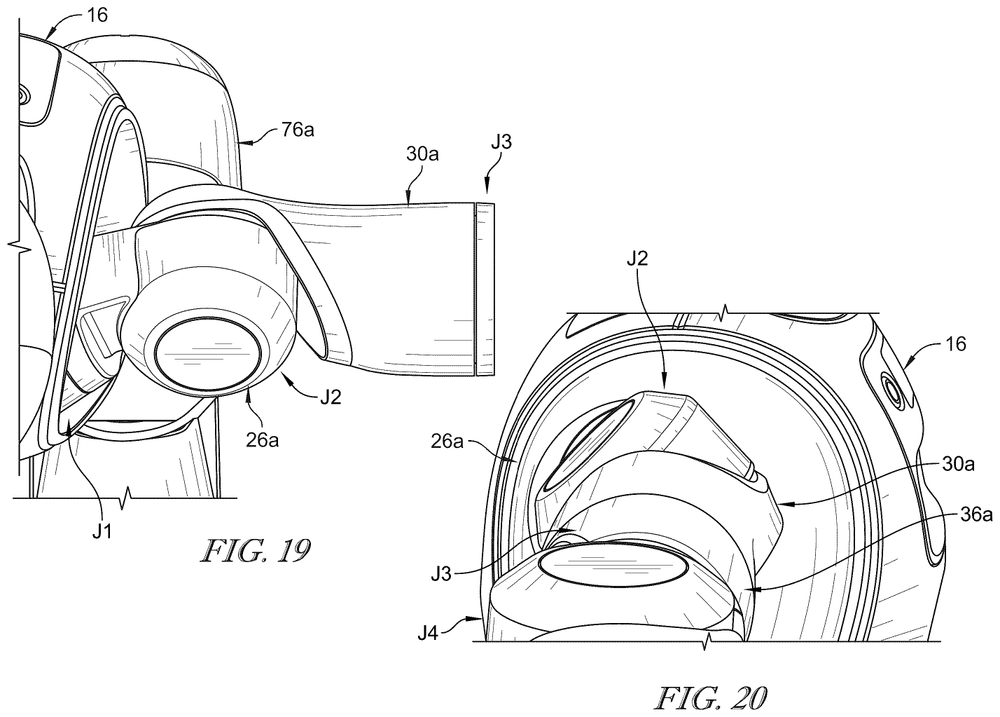

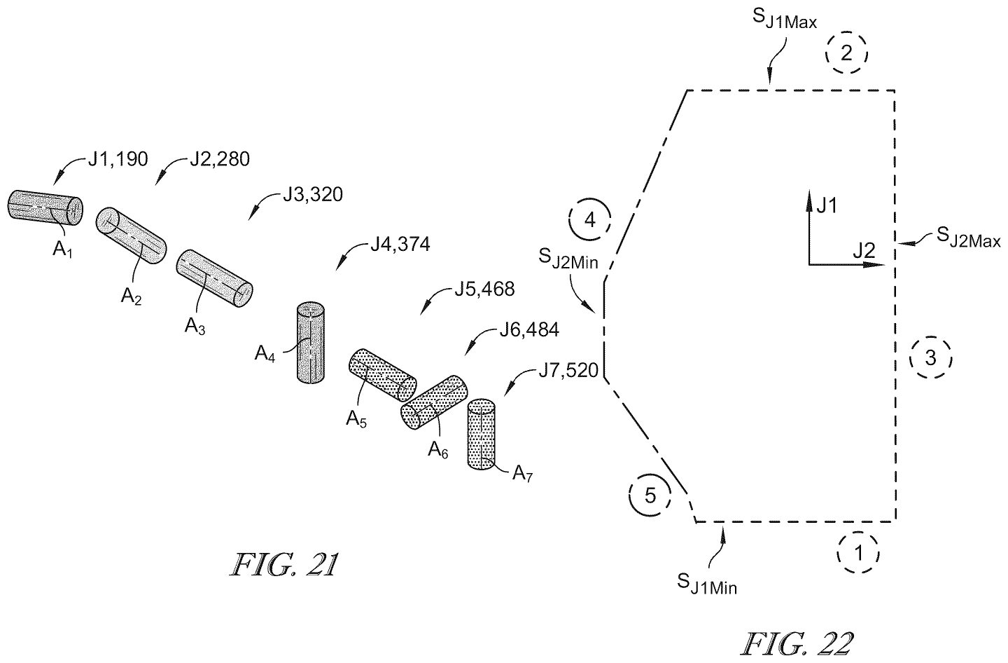

Referring to FIG. 22, the above information is shown in a pictorial format. In particular, point 1 represents the forward-negative hardstop—for J1 at an angle that is between −115 and −155 degrees. Point 2 represents the backward-positive hardstop—for J1 at an angle that is between 60 and 110 degrees. Point 3 represents the outward-positive hardstop—for J2 at an angle that is between 25 and 65 degrees. Point 4 represents the position of the bumpstop of the torso 16, while point 5 represents the clearance area needed around the head 10 of the robot 1. It should be understood that the range of motion of the arm assembly 5 is also disclosed in FIGS. 3-6. To the extent that the information contained in those figures contradicts the language found here, it should be understood that the disclosure contained in the figures is the primary embodiment and the disclosure contained herein may be treated as an alternative embodiment. Further, other ranges of movement and associated angles are contemplated by this disclosure.

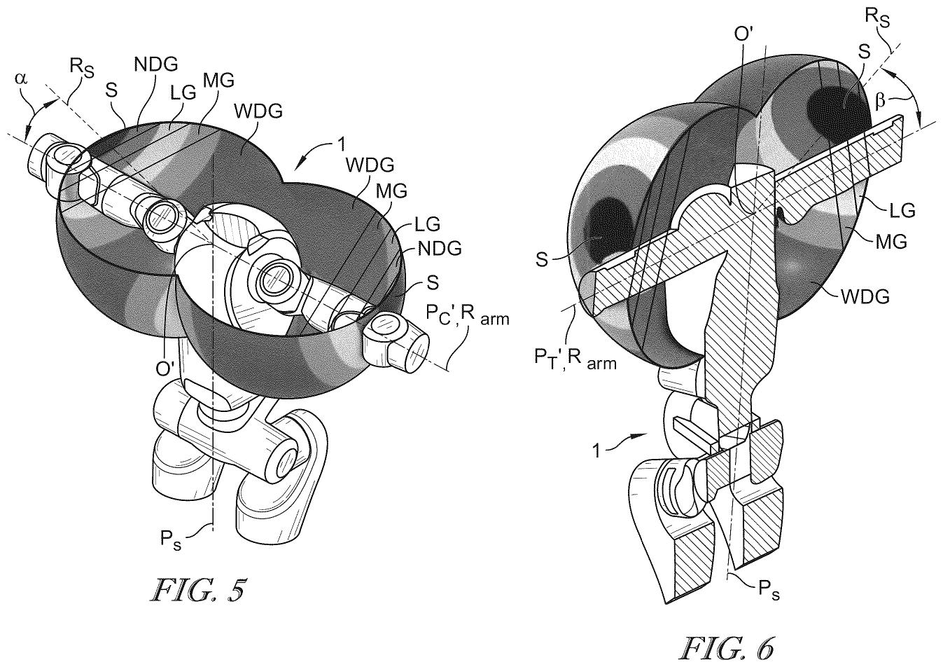

In light of the above and as shown in FIGS. 5-6, the location of the singularity is positioned at a rearward angle alpha α from the arm coronal plane (P_{C}′). Said angle alpha α may be between 1 and 45 degrees, preferably between 5 and 25 degrees, and most preferably between 10 and 20 degrees. Further, the location of the singularity S is positioned at an upper angle beta β from the arm transverse plane (P_{T}′). Said angle beta β may be between 1 and 45 degrees, preferably between 5 and 25 degrees, and most preferably between 10 and 20 degrees. For simplicity, the arm reference planes (P_{T}′, P_{C}′) are shifted from the reference planes (P_{T}, P_{C}) of the robot 1 (P_{T}, P_{C}) to include an arm reference axis Rₐᵣₘ defined as an axis that is colinear with a central axis of the upper arm (i.e., axis A₃ of the arm twist actuator J3) when in the extended arm position. The arm transverse plane (P_{T}′) is parallel to the transverse plane (P_{T}) of the robot 1, and an arm coronal plane (P_{C}′) is parallel to the coronal plane (P_{C}) of the robot 1. Accordingly, the mounting angle of the arm actuator 190 (J1) directly influences the location of the singularity because said singularity will occur when the axis A₁ of the arm actuator (J1) is aligned with the axis A₃ of the upper arm twist actuator (J3). It should also be understood that: (i) the wide dark gray circles represent the best workable area, (ii) the mid-tone gray circles represent the workable area, (iii) the light gray circles represent areas that are workable, but are coming close to being undesirable, (iv) the narrow dark gray circles represent an undesirable area, and (v) black represents the singularity. In other words, it is desirable to maintain the arms of the robot 1 within the dark gray circles and to keep them from entering the black circles.

### 11. Kinematics of the Central and Lower Portions

The following includes a discussion of various kinematic movements, elements, and aspects of the spine and lower body assemblies of a robot. The specific details set forth through the figures and examples provide a thorough understanding of the relevant teachings. The present teachings can be practiced, however, without such details and/or in alternative embodiments or configurations. In some instances, known methods, procedures, components, and/or circuitry have been described at a relatively high level, without detail, to avoid unnecessarily obscuring aspects of the present disclosure. The combination of the pictorial disclosure and the written disclosure of the spine and lower body assemblies are examples of the principles of the disclosed assemblies, methods, and systems, and are not intended to limit the broad aspects of the disclosed concepts to the illustrated embodiments. While various angle ranges are provided herein, this disclosure contemplates altering all angles and dimensions of any component by any number between about 1% and about 30%. In one example provided below, an angle of about 18 degrees is formed between the rotation axis of the hip pivot actuator (J12) 768 and the transverse plane Pr. This disclosure contemplates, for example, at least altering this angle of about 18 degrees to any angle that is between about 12 degrees and about 24 degrees relative to the transverse plane P_{T} (in addition to larger ranges that may be explicitly disclosed below).

As shown in the figures, the hip flex actuator 720 (J11) can move the leg 6 forward and backward relative to the torso 16 and/or coronal plane P_{C} of the robot 1, while the hip pivot actuator 768 (J12) can move the leg 6 left/right or sideways relative to the torso 16 of the robot 1 or in the coronal plane P_{C}. The leg twist actuator 782 (J13) can rotate the leg 6 relative to the torso 16 of the robot 1, while the knee actuator 820 (J14) can bend the knees or leg 6 of the robot 1. Moreover, the torso lean actuator 680 (J9) can allow the torso 16 of the robot 1 to lean to its left or right relative to its feet 92, and the torso twist actuator 620 (J10) can allow the torso 16 of the robot 1 to rotate or twist relative to its feet 92.

a. Neutral Position

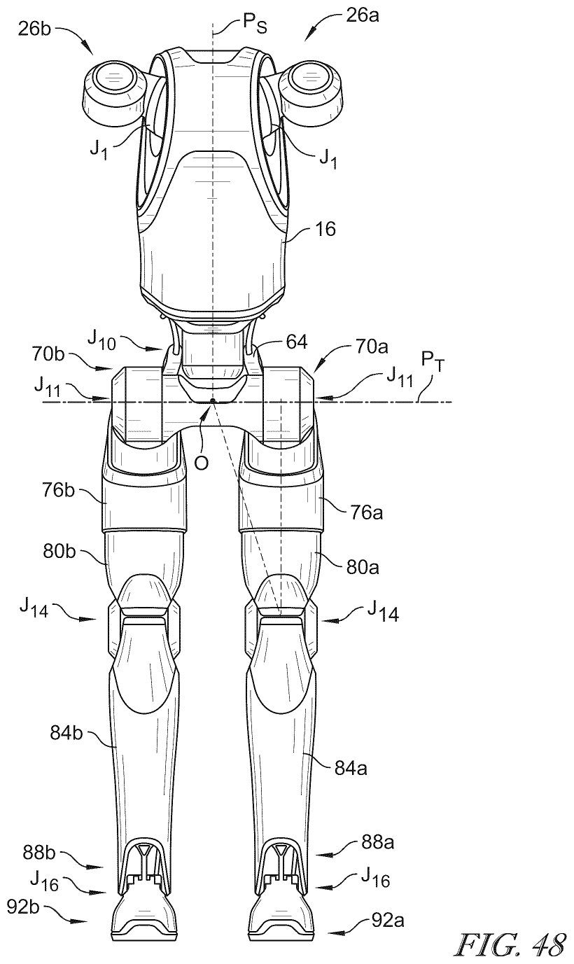

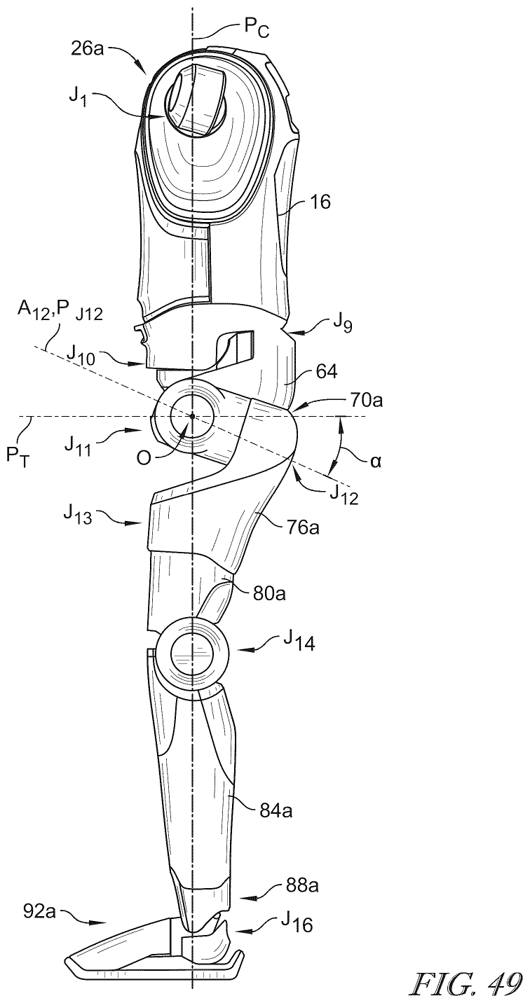

FIGS. 48 and 49 illustrate a portion of the robot 1 of FIG. 1 in a neutral position where it is standing with its torso 16 facing forward and stacked over its pelvis 64 and legs 6 on a support surface SS. In this configuration, points where the axes of rotation A₁₁ and A₁₄ for the hip flex actuator 720 (J11) and the knee actuator 820 (J14), respectively, intersect the sagittal plane (which is the plane of the page in FIG. 49) can define a vertical axis Q.87 that lies in the coronal plane P_{C}. The axis Q.87 also passes through the origin point O of the robot 1, which is aligned with axis Aₙ of the hip flex actuator 720 (J11) and axis A₁₀ of the torso twist actuator 620 (J10). Further, axis A₁₃ of the leg twist actuator 782 (J13) can align with the axis Q.87 in the view of FIG. 49, which means that the leg twist actuator 782 (J13) is centered over the knee to form a vertical plane aligned with axis Q.87. Positioning the components of the robot 1 in the manner shown in these figures can produce a neutral position whereby the weight of the robot 1 is balanced over its feet 92 and its position can be maintained without the application of torque from any actuator. That is, the legs 6 are straight with knees under hips and above ankles to form a configuration where the robot is self-supporting.

b. Hip and Leg Movement Axes

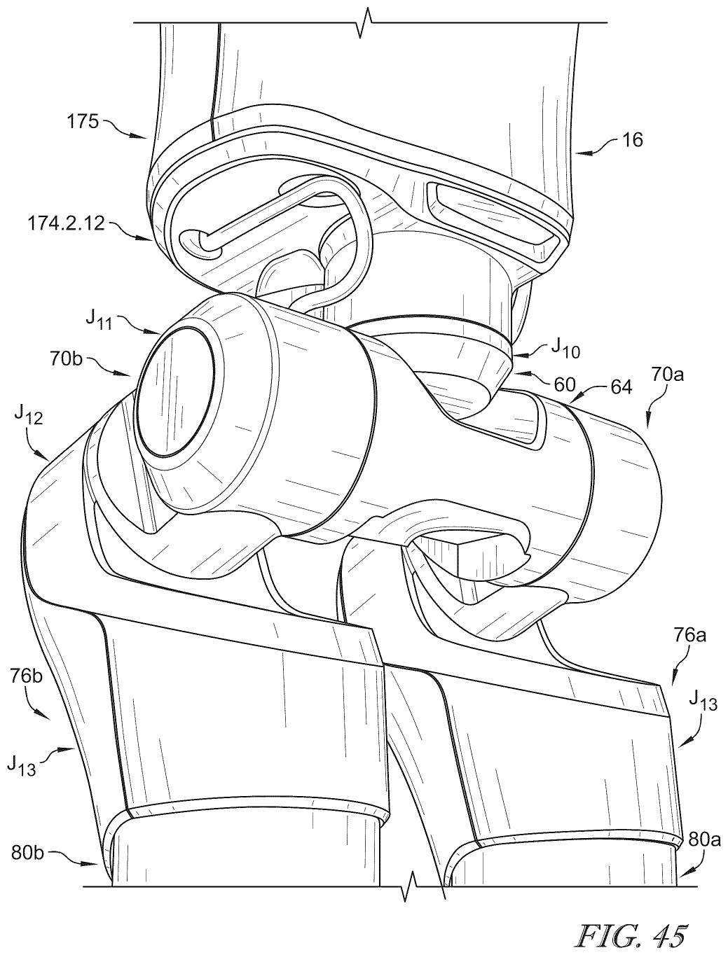

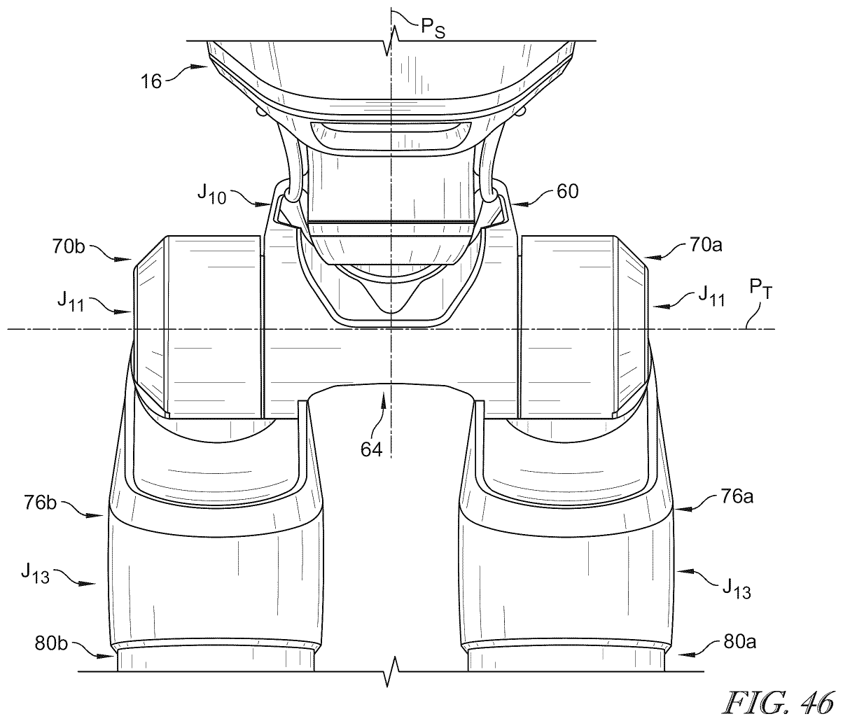

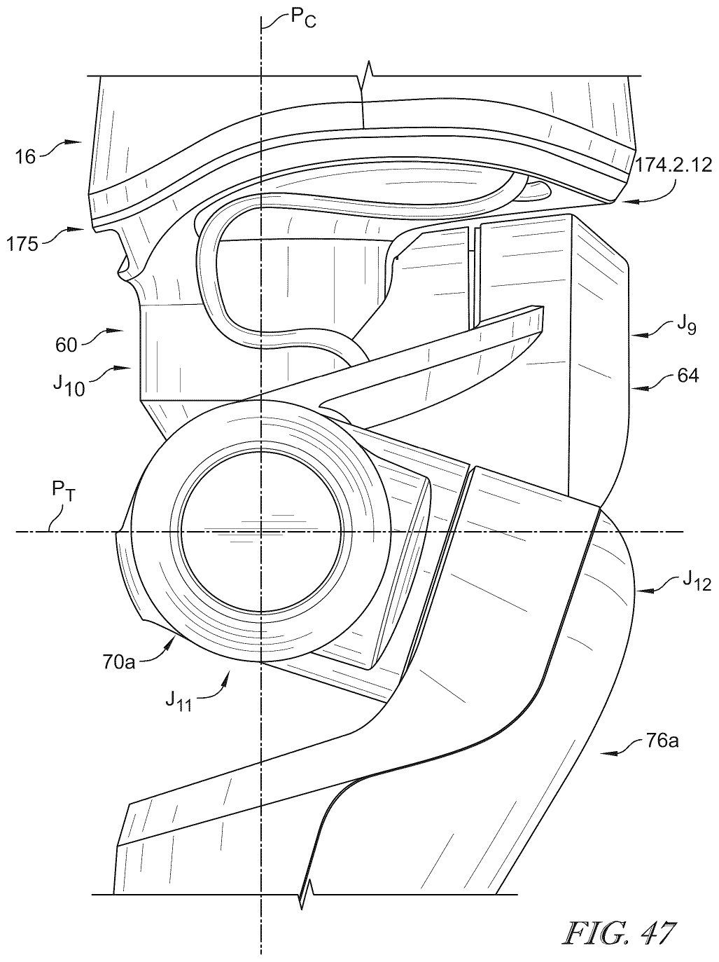

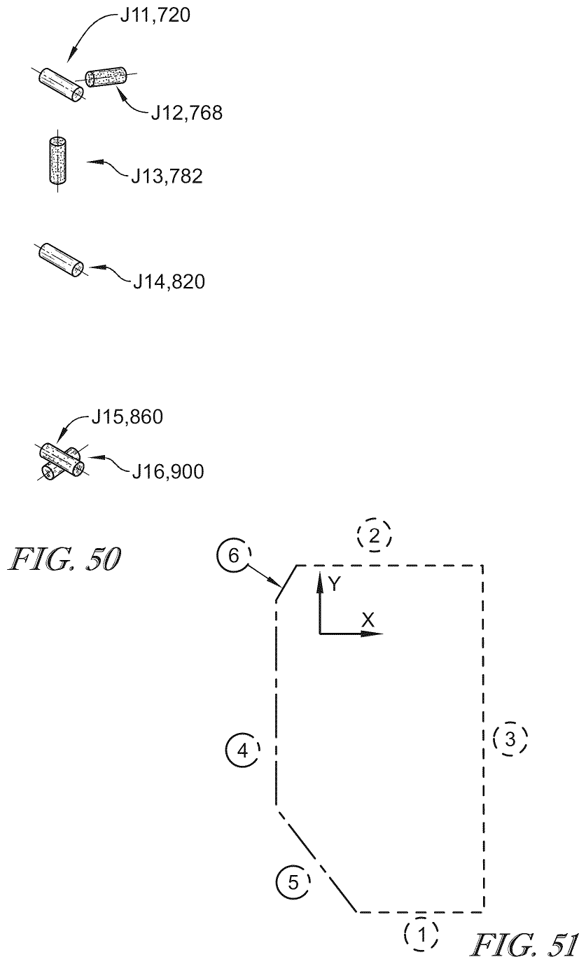

FIGS. 45-47 show the hip assembly in the central portion 3 of the robot 1, where the left and right legs 6 extend from the pelvis 64. The hip flex actuator 720 (J11), the hip pivot actuator (J12) 768, and the leg twist actuator 782 (J13) respectively provide the leg 6 with axes of rotation A₁₁, A₁₂, and A₁₃ for Y-axis (pitch), X-axis (roll), and Z-axis (yaw or twist) at the hip and upper leg. The leg twist actuators 782 (J13) are located below the hip flex actuator 720 (J11) and the hip pivot actuator 768 (J12) and provide yaw motion for the legs 6. The hip pivot actuators 768 (J12) are located below the hip flex actuators 720 (J11) and provide roll motion for the legs 6. The hip flex actuators 720 (J11) provide pitch motion for the legs 6 and they are located above the hip pivot actuators 768 (J12) and the leg twist actuators 782 (J13). In the illustrated FIG. 50, the hip pivot actuator 768 (J12) for rolling movement is shown as cylinder Cb.89, the hip flex actuator 720 (J11) for pitch movement is shown as cylinder Co.89, and the leg twist actuator 782 (J13) for yaw movement is shown as cylinder Cg.89. The movement of the leg 6 attributed to the hip pivot actuator 768 (J12) is shown as the line Lb.89 below the cylinders, the movement attributed to the hip flex actuator 720 (J11) is shown as the line A.89, and the movement attributed to the leg twist actuator 782 (J13) is shown as the line Lg.89.

This hip assembly design, which has the Y-axis hip flex actuator 720 (J11), a middle X-axis hip pivot actuator 768 (J12), and a lower Z-axis leg twist actuator 782 (J13) can offer benefits. For example, having the hip flex actuator 720 (J11) in the pelvic structure of the robot 1 can be beneficial because this can be the actuator that is most used for the forward walking movements of the robot 1. On the other hand, the inertia of the pitch movements of the leg 6 can be increased because the mass of both the hip pivot actuator 768 (J12), and the leg twist actuator 782 (J13) move when the robot 1 walks. Having the actuators high up in the legs 6, however, can minimize the effects of the increased inertia for movement in the Y-axis degree of freedom (DOF) for pitch movements of the legs 6 during walking and running.

c. Leg Pitch Movement

FIG. 54 is a schematic side view of ranges of motion of the robot 1 of FIG. 48. Axis A.87 is the vertical axis from FIG. 49 that intersects axis A₁₁ of the hip flex actuator 720 (J11) and axis A₁₄ of the knee actuator 820 (J14), among others, when the robot 1 is in the neutral position. The axis A.90.1 can represent a maximum posterior retraction or flexion of the leg of the robot 1 using the hip flex actuator 720 (J11) and can form an angle Q.90.1.a of about 35 degrees relative to the axis A.87. The axis A.90.2 can represent an anterior advancement or extension of the leg of the robot 1 using the hip flex actuator 720 (J11) and can form an angle Q.90.2.a of about 135 degrees relative to the axis A.87 (i.e., relative to the lower portion of axis A.87 representing the position of the leg 6 in the neutral position). Note that, in some embodiments, a maximum anterior advancement or extension of the leg of the robot 1 using the hip flex actuator 720 (J11) can be about 160 degrees relative to the axis A.87, but this can require simultaneous movement of the leg 6 laterally outward by about 20 degrees using the hip pivot actuator 768 (J12) to avoid interference between the leg 6 and the torso 16. This concept of achieving greater extension of a leg 6 about the hips by utilizing simultaneous laterally outward movement of the leg 6 is similar to how humans move, e.g., when performing a deep squat. Returning to FIG. 54, also shown are intermediate positions of leg extension. In particular, axis A.90.3 can form an angle Q.90.3.a of about 90 degrees relative to the axis A.87, and axis A.90.4 can form an angle Q.90.4.a of about 45 degrees relative to the axis A.87. FIGS. 53-58 show the robot 1 of FIG. 48 in the positions that are represented by these axes, as described in more detail below.

d. Leg Flexion

The hip flex actuator 720 (J11) can allow the robot 1 to move its leg 6: (i) backward between about 5 degrees and about 55 degrees, preferably between about 25 and about 45 degrees, and most preferably between about 30 and about 40 degrees, and (ii) forward between about 25 and about 210 degrees, preferably between about 80 and about 190 degrees, and most preferably between about 145 and about 175 degrees. In other words, the hip flex actuator 720 (J11) can move the leg 6 backward at least about 5 degrees, preferably at least about 25 degrees, and most preferably at least about 30 degrees. Likewise, the hip flex actuator 720 (J11) can move the leg 6 forward at least about 25 degrees, preferably at least about 80 degrees, and most preferably at least about 145 degrees. Thus, the hip flex actuator 720 (J11) can have a range of motion that is at least about 30 degrees, preferably at least about 105 degrees, and most preferably at least about 175 degrees. In some embodiments, the hip flex actuator (J11) can have a range of motion that is approximately 200 degrees.

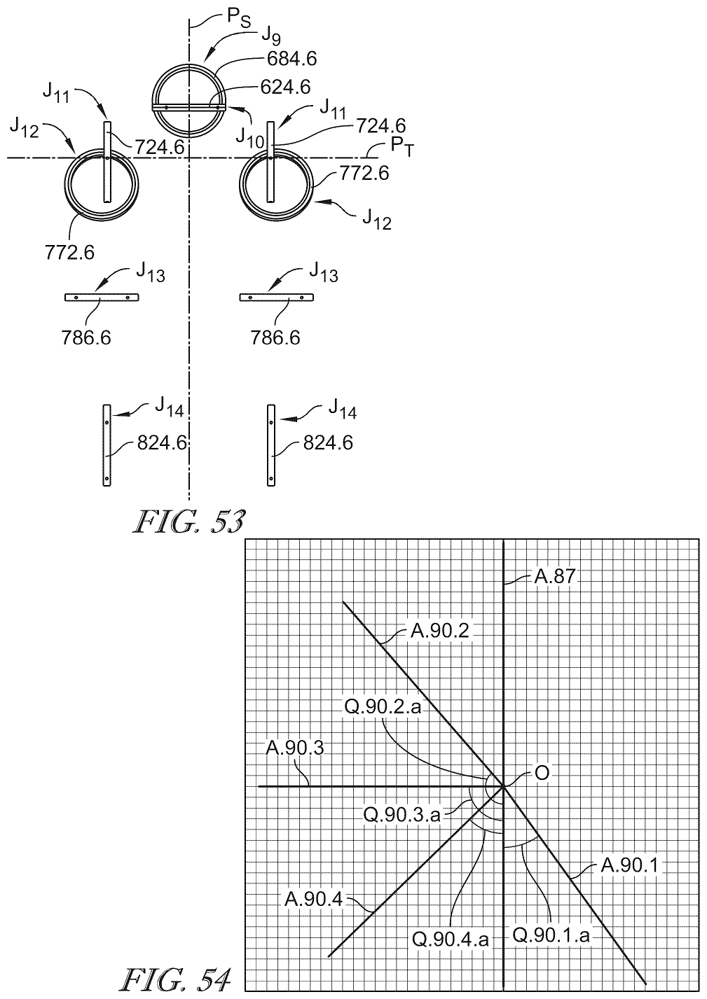

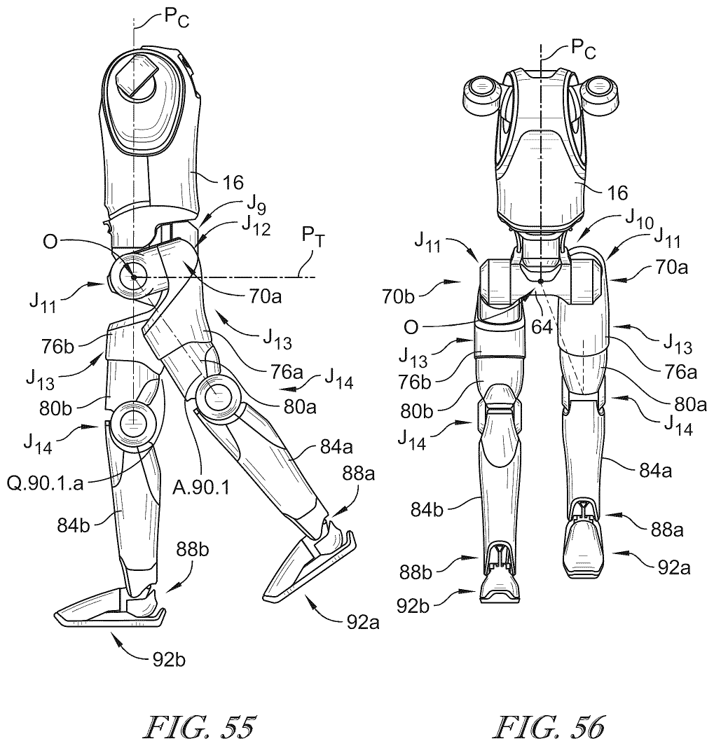

FIGS. 55 and 56 show the leg 6 in a rearmost position, i.e., a maximum rearward movement of the hip flex actuator 720 (J11) that can substantially avoid interference with other components of the robot 1 while the torso twist actuator 620 (J10) is fully rotated in one direction and the torso lean actuator 680 (J9) is leaning fully to that one direction. In such a position, there can be some interference between the parts, but placing all three actuators at their maximum position is rare and there is no specific use case that has been developed to date for why the robot 1 would be placed in this configuration. It should be understood that the torso lean actuator 680 (J9) can be placed at the maximum lean and the hip flex actuator 720 (J11) can be placed at a maximum rearward position. In this configuration, the components of the body will not contact each other, which is due in part to the design of the hip, pelvis 64, and the waist bucket of the torso 16 . . . . Potential interference might only occur if the torso 16 were then twisted fully using the torso twist actuator 620 (J10) from this position but, as noted above, this is a rare configuration that is not typically desired. Accordingly, the spine and lower body assemblies include uniquely shaped structures that position the actuators associated therewith in specific locations in order to allow the robot 1 to move in the designed manners.

e. Leg Extension

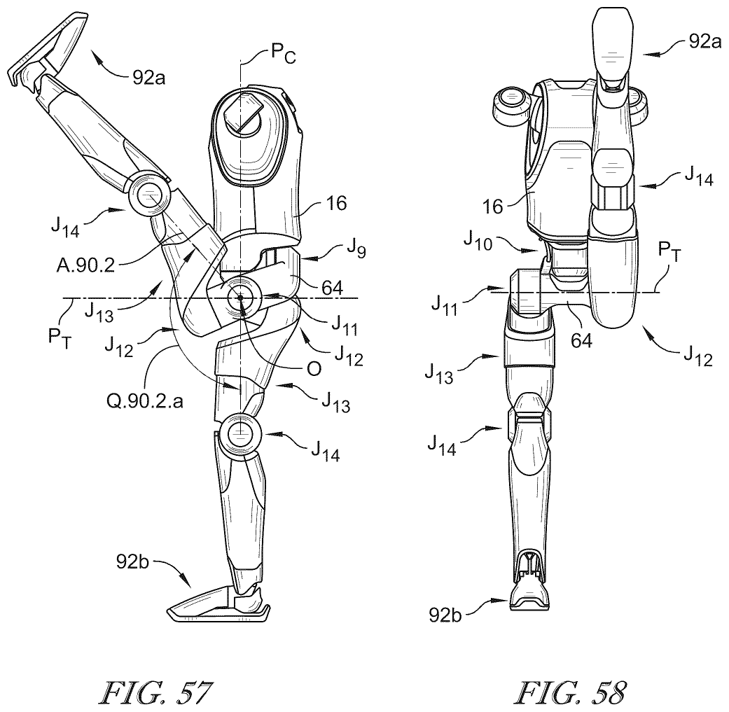

FIGS. 57 and 58 show side and front views of the robot 1 of FIG. 48 in a position where its left leg is extended anteriorly forward by 135 degrees using the hip flex actuator 720 (J11). Of course, the robot 1 can be capable of achieving any other degree of forward leg extension between these illustrated neutral and extended positions. Further, and as noted above, additional degrees of leg extension beyond that shown in FIGS. 57 and 58 are possible when combined with lateral outward movement of the leg 6 using the hip pivot actuator 768 (J12) in combination with the hip flex actuator 720 (J11).

For example, when the hip flex actuator 720 (J11) is moved to a maximum forward position (e.g., about 160 degrees relative to the axis A.87), it can place the knee right next to the chest of the torso 16. In this configuration, however, the leg 6 can contact the torso 16 and be stopped prior to achieving the maximum forward extension of the hip flex actuator 720 (J11). To address this, when the hip flex actuator 720 (J11) is moved to the maximum forward position, the hip pivot actuator 768 (J12) can move the leg 6 slightly to the side or laterally outward (e.g., about 20 degrees in one embodiment). In other words, the leg 6 can be angled outward relative to the sagittal plane P_{S}. This positional relationship can be beneficial if the robot 1 is lifting a weight or getting off the ground. In particular, the angle of the hip pivot actuator 768 (J12) can be at least 5 degrees, preferably at least 10 degrees, and most preferably at least 15 degrees, and, in one embodiment, can be about 20 degrees from being parallel with the sagittal plane P_{S} in order to allow the torso 16 to clear the leg 6 when said leg 6 is in the maximum forward position. It can be desirable to allow for the clearance of the leg 6 in this maximum forward position with the least amount of rotation needed by the hip pivot actuator 768 (J12). As such, the leg 6 can be designed to clear the torso 16 in the maximum forward position when the hip pivot actuator 768 (J12) is rotated less than 40 degrees, preferably less than 30 degrees, and most preferably less than 25 degrees from being parallel with the sagittal plane P_{S}. In other words, said rotation of the hip pivot actuator 768 (J12) can be positioned between 5 degrees and 40 degrees, preferably be between 10 degrees and 30 degrees, and most preferably between 15 degrees and 25 degrees from being parallel with the sagittal plane P_{S} in order to minimize the amount of rotation needed from the hip pivot actuator 768 (J12) while allowing for the leg 6 to be fully forward and clear the torso 16 without interference.

f. Leg Roll Movement

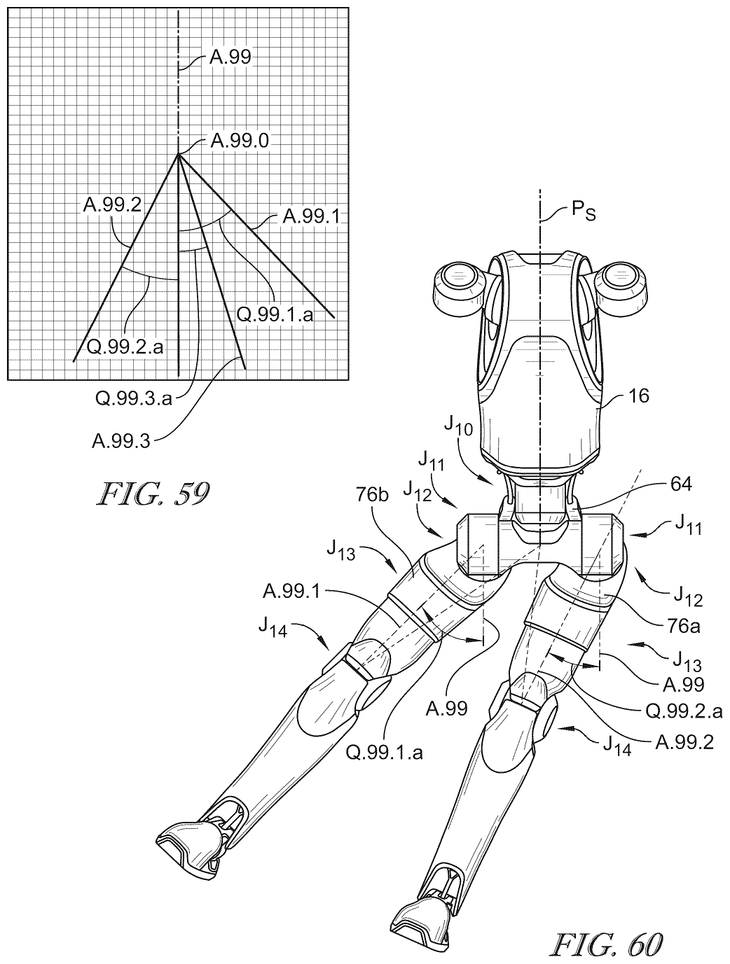

The hip pivot actuator 768 (J12) controls movement of the legs 6 from side to side, i.e., leg roll movement. FIG. 59 schematically illustrates the range of motion of the hip pivot actuator 768 (J12) and assumes a front view of the left hip pivot actuator (J12) of the robot 1. Axis A.99 is a vertical axis that extends parallel to the axis A.87 and a sagittal plane P_{S} of the robot 1, and passes through an axis of rotation A.99.o of the hip pivot actuator 768 (J12). Axis A.99.1 represents a maximum lateral outward movement of the leg 6 and defines an angle Q.99.1.a of about 45 degrees relative to the axis A.99. Axis A.99.2 represents a maximum medial inward movement of the leg 6 and defines an angle Q.99.2.a of about 25 degrees relative to the axis A.99. Also shown is an intermediate lateral outward movement position, which is denoted by axis A.99.3, that defines an angle Q.99.3.a that is about 20 degrees. Of course, the hip pivot actuator 768 (J12) can achieve any angle of rotation between the positions of axes A.99.1 and A.99.2. Further, in certain embodiments the robot 1 can be configured to achieve different degrees of rotation and different ranges of motion, all of which are contemplated to be within the scope of the present disclosure.

FIGS. 60-61 illustrate the robot 1 of FIG. 48 in the various positions of leg roll that are schematically shown in FIG. 59. FIG. 60, for example, shows a front view of the robot 1 of FIG. 48 in a position where its right leg (i.e., thigh 76b) is rolled laterally outward by about 45 degrees (i.e., angle Q.99.1.a) and its left leg (i.e., thigh 76a) is rolled medially inward by about 25 degrees (i.e., angle Q.99.2.a) using the hip pivot actuators 768 (J12). This configuration simultaneously shows one example of maximum laterally outward roll and maximum medially inward roll for the legs 6 of the robot 1. FIG. 61 shows a front view of the robot 1 of FIG. 48 in a position where its left leg (i.e., thigh 76a) is at an intermediate position of about 20 degrees of laterally outward roll (i.e., angle Q.99.3.a) using the hip pivot actuator 768 (J12) while its right leg (i.e., thigh 76b) remains in a neutral position (i.e., no roll relative to axis A.99). Finally, FIG. 61 shows a front view of the robot 1 of FIG. 48 in a position where its left leg (i.e., thigh 76a) is at a maximum of about 45 degrees of laterally outward roll (i.e., angle Q.99.1.a) using the hip pivot actuator 768 (J12) while its right leg (i.e., thigh 76b) remains in a neutral position (i.e., no roll relative to axis A.99). Of course, the robot 1 can be capable of achieving any other degree of medial or lateral roll between these illustrated example positions.

g. Leg Yaw Movement

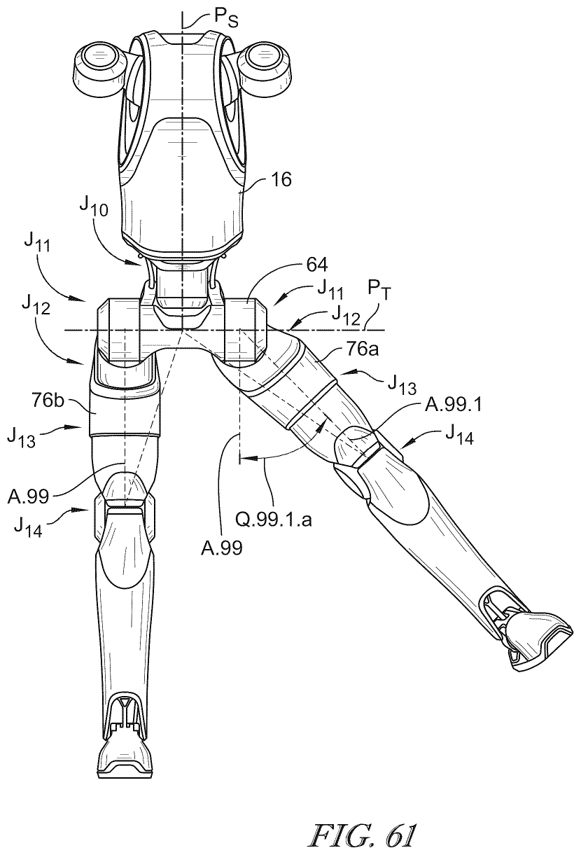

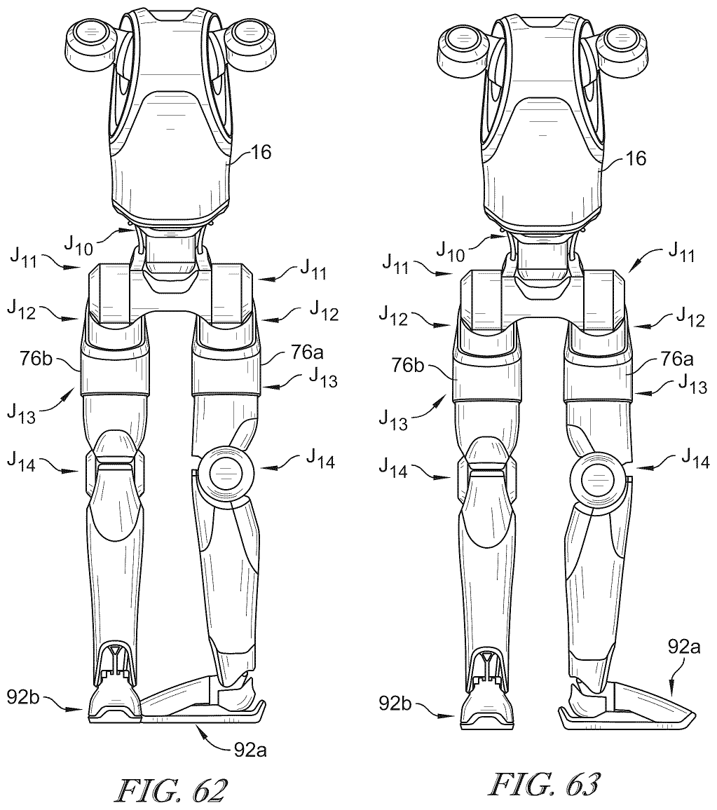

As shown in FIGS. 62-67, the leg twist actuator 782 (J13) is positioned below the torso lean actuator 680 (J9), the torso twist actuator 620 (J10), the hip flex actuator 720 (J11), and the hip pivot actuator 768 (J12). The leg twist actuator 782 (J13) is designed to allow the robot 1 to turn in place and provides up to about 90 degrees of rotation in either direction from the neutral position. This range of movement can allow the robot 1 to turn in place, in particular, by turning one leg 6 about 90 degrees, stepping on it, turning the whole robot 1 around about 180 degrees, and then twisting the other leg 6 about 90 degrees. This is beneficial because the robot 1 can turn 180 degrees (i.e., reverse direction) by only taking two steps and, in some situations, only a single step. Stated another way, said robot 1 can turn around and start walking in the other direction by only taking two (and sometimes one) steps. This represents a significant advantage over many prior designs that can require many steps to reverse direction.

The configuration of the leg 6 and its associated actuators (i.e., actuators J11, J12, and J13) also ensures that said leg 6 cannot be placed in a singularity, which is a state where two or more actuator axes of rotation are parallel with one another). This is because the hip pivot actuator 768 (J12) cannot be rotated outward by 90 degrees, which would be required in order to place the axis A₁₁ of the hip flex actuator (J11) parallel with the axis A₁₃ of the leg twist actuator (J13). Additionally, there is very little use for rotating or rolling the leg laterally outward more than about 55 degrees from the sagittal plane. Thus, said configuration of the actuators provides the robot with a significant range of motion without a singularity. In other words, said singularity is positioned outside of the usable working range of the robot's legs.

FIGS. 62-67 illustrate the robot 1 of FIG. 48 in various example positions of leg yaw. FIG. 64, for example, shows a bottom view of the robot 1 of FIG. 48 in a position where its lower left leg (i.e., foot 92a) is twisted medially inward by about 45 degrees using the leg twist actuator 782 (J13) and its right leg (i.e., foot 92b) is in a neutral (i.e., forward facing) position. FIG. 65 shows a bottom view of the robot 1 of FIG. 48 in a position where its lower left leg (i.e., foot 92a) is twisted medially inward by about 90 degrees using the leg twist actuator 782 (J13) and its right leg (i.e., foot 92b) is in a neutral (i.e., forward facing) position. FIG. 66 shows a bottom view of the robot 1 of FIG. 48 in a position where its lower left leg (i.e., foot 92a) is twisted laterally outward by about 45 degrees using the leg twist actuator 782 (J13) and its right leg (i.e., foot 92b) is in a neutral (i.e., forward facing) position. Finally, FIGS. 63 and 67 show front and bottom views of the robot 1 of FIG. 48 in a position where its lower left leg (i.e., foot 92a) is twisted laterally outward by about 90 degrees using the leg twist actuator 782 (J13) and its right leg (i.e., foot 92b) is in a neutral (i.e., forward facing) position. Of course, the robot 1 can be capable of achieving any other degree of medial or lateral yaw between these illustrated example positions.

h. Spine Movement

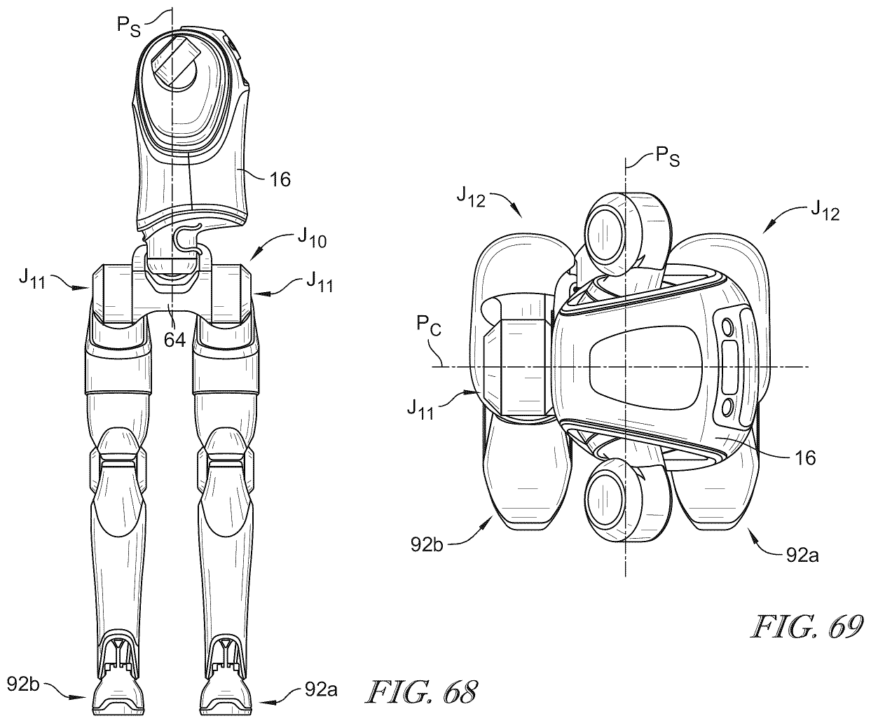

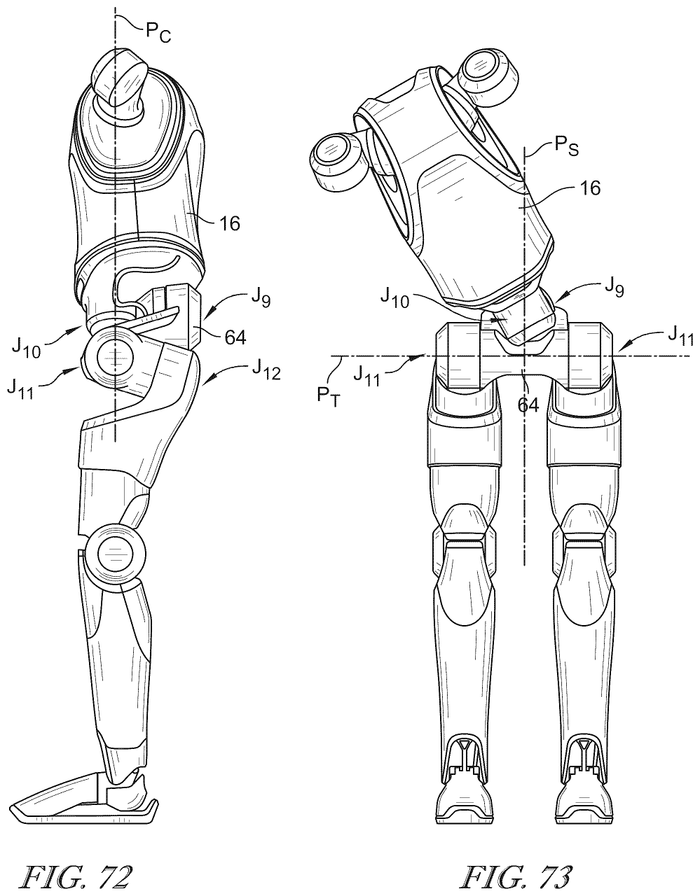

FIGS. 68-75 illustrate various movements of the spine, i.e., movements of the torso 16 relative to the pelvis 64. As shown in the figures, the robot 1 does not bend forward at its belly. To provide similar forward motion, the robot 1 utilizes the hip flex actuators 720 (J11) of the legs 6. The use of the legs of the robot 1 to perform this forward motion reduces the need for additional actuators (e.g., in some embodiments the two hip flex actuators 720 (J11) can do the work of four actuators in prior robots) and beneficially places the loads on the hip flex actuators 720 (J11) for lifting objects off the ground. Thus, the size/torque associated with the hip flex actuators 720 (J11) can be adjusted to account for this functional movement. While the robot 1 does not bend forward at its belly, it can bend sideways at its belly (as shown in FIGS. 72-75). This sideways bending is accomplished using the torso lean actuator (J9). Also, because the forward bending of the robot is done using the legs and the hip flex actuators 720 (J11), the torso lean actuator (J9) can be a smaller actuator having less torque than the hip flex actuators 720 (J11).

i. Spine Yaw Movement

FIGS. 68-71 illustrate the robot 1 of FIG. 48 in various example positions of spine or torso yaw or twist relative to the pelvis 64. This feature helps the robot 1 to be able to reach and grab objects that are positioned to its sides. Accordingly, said robot 1 can have a twisting range of motion associated with the torso twist actuator 620 (J10) that is more than about 45 degrees, preferably more than about 120 degrees, and most preferably more than about 170 degrees. In one embodiment, the torso twist actuator 620 (J10) can have a range of motion of about 180 degrees, i.e., about 90 degrees in either direction from the forward-facing, neutral position.

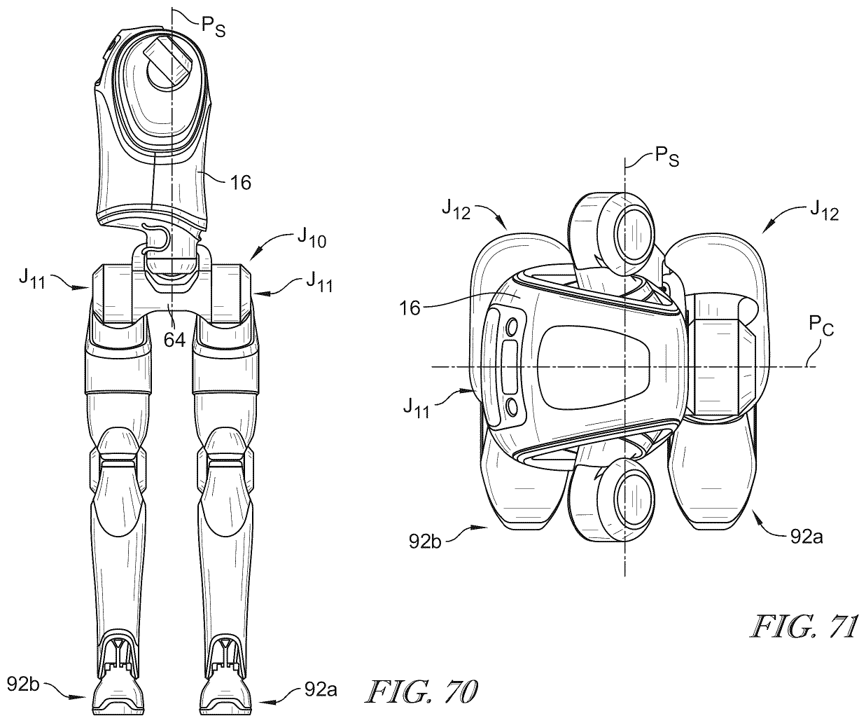

FIGS. 68 and 69 show front and top views of the robot 1 of FIG. 48 in a position where its torso 16 is twisted to its right by about 90 degrees from the neutral position using the torso twist actuator 620 (J10). FIGS. 70 and 71 illustrate front and top views of a similar configuration but in the opposite direction, i.e., twisting the torso 16 of the robot 1 to its left by about 90 degrees from the neutral position using the torso twist actuator 620 (J10). Of course, the robot 1 can be capable of achieving any other degree of torso twist between these illustrated example positions.

j. Spine Roll Movement

As noted above, the robot 1 can lean to its sides at its belly using the torso lean actuator 680 (J9). The range of motion of the torso lean actuator 680 (J9) can be between about 5 and about 50 degrees, preferably between about 15 and about 40 degrees, and most preferably between about 20 and about 40 degrees. In one embodiment, the torso lean actuator 680 (J9) can have a range of motion of about 30 degrees in either direction from the vertical, neutral position.

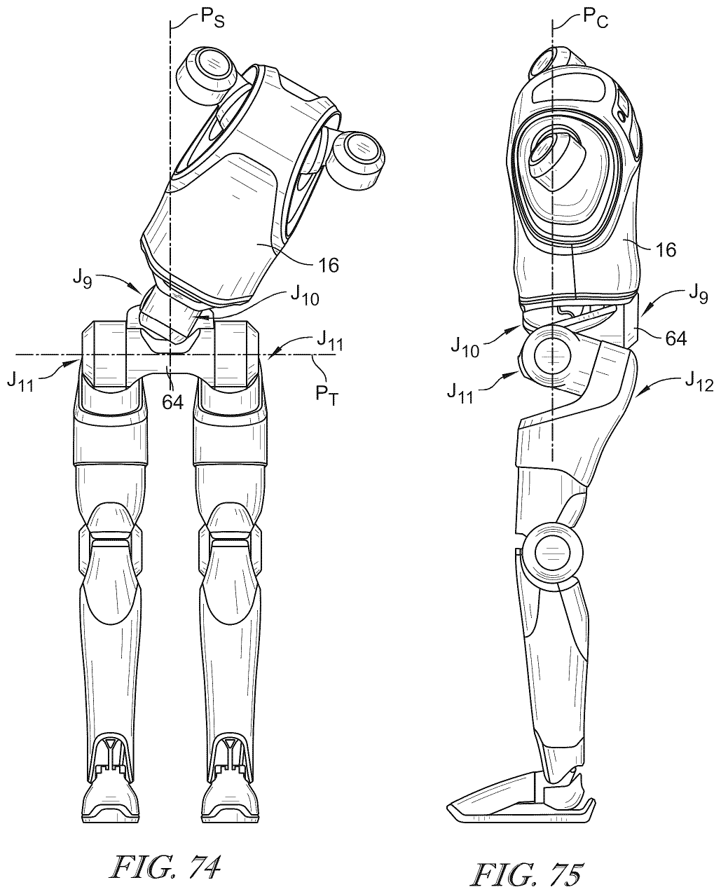

FIGS. 72 and 73, for example, show side and front views of the robot 1 of FIG. 48 in a position where its torso 16 is leaned to its right by about 30 degrees from the neutral position using the torso lean actuator 680 (J9). FIGS. 74 and 75 illustrate front and side views of a similar configuration but in the opposite direction, i.e., leaning the torso 16 of the robot 1 to its left by about 30 degrees from the neutral position using the torso lean actuator 680 (J9). Of course, the robot 1 can be capable of achieving any other degree of torso lean or spine roll between these illustrated example positions.

### 12. Alternative Embodiments

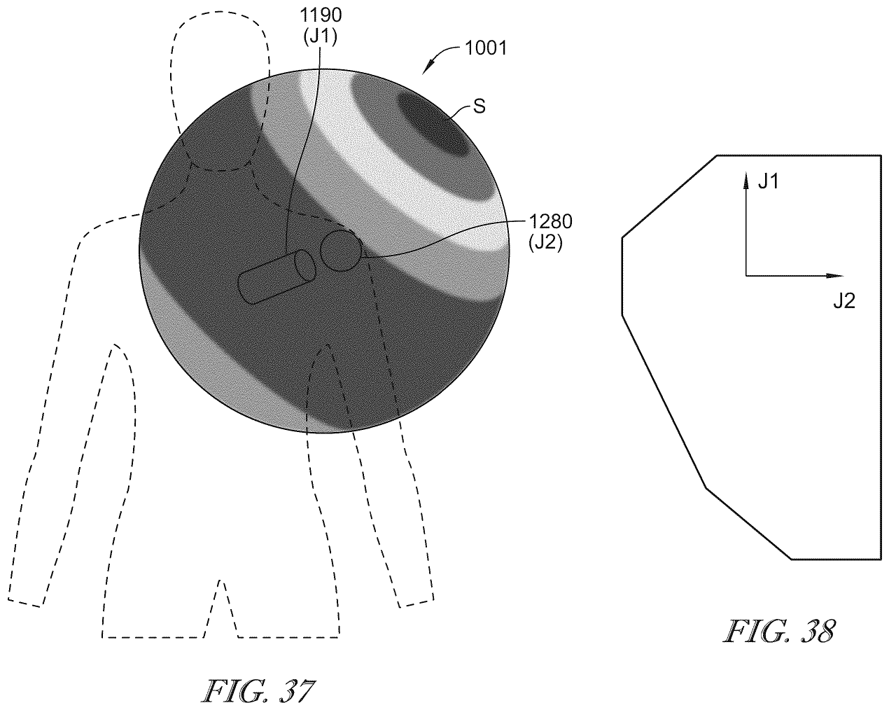

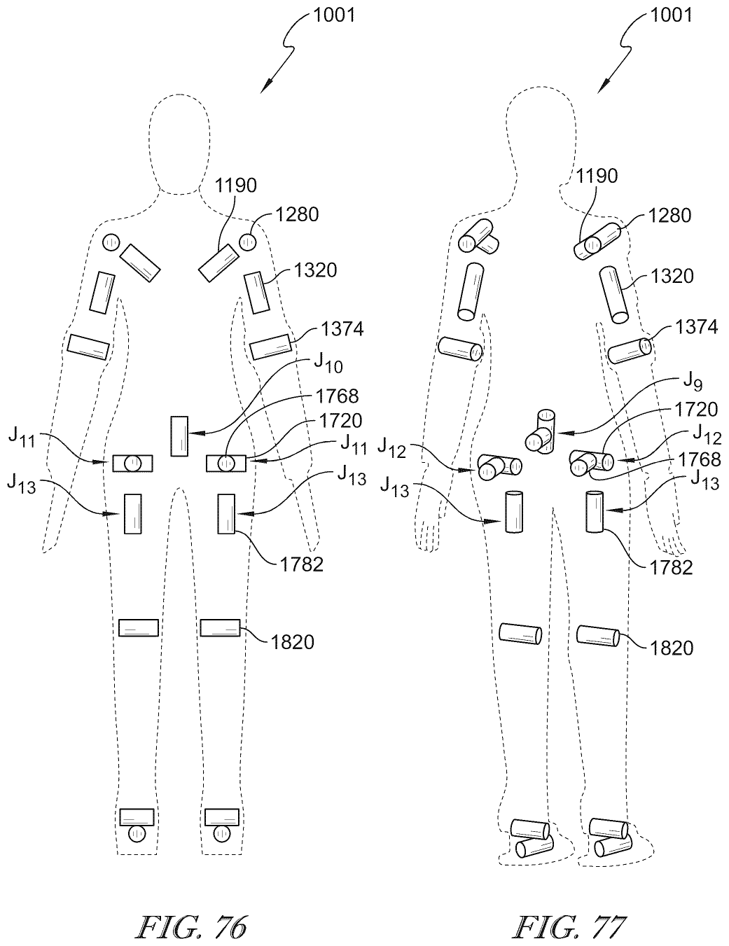

Alternative embodiments of the illustrative robot 1, which illustrate alternative robot configurations 1001, 2001, 3001, 4001, 5001, and 6001, are shown in FIGS. 37-44 and 76-85. In particular, FIGS. 37-44 illustrate various alternative embodiments for an upper portion of the robot. Similarly, FIGS. 76-85 illustrate various alternative embodiments for a leg assembly of a robot. The alternative embodiments disclosed herein may be implemented and may feature a capability to avoid, or substantially avoid, geometric configurations of the joints of the robot 1 in which one or more degrees of freedom are effectively lost due to the alignment or overlap of rotational or translational axes, namely, joint singularities. These configurations can result in a reduction in the ability of the robot 1 to maneuver, exert force, or maintain precision during task execution. In this context, alternative embodiments to provide a different range of motion to accommodate specified needs are envisioned. Although the complete robot structure of the alternative embodiments is not explicitly shown, it can be understood that the kinematic chains and kinematic maps that are illustrated in the alternative embodiments can be utilized to define actuator arrangements and supporting robot framework, structures, and components. Any of a variety of alternative configurations of robots are possible and considered with the scope of the present disclosure.

a. Alternative Embodiments-Upper Portion

Shown in FIGS. 37-40 and 76-80, a second embodiment of a robot 1001 is substantially similar to the first embodiment robot 1. For the sake of brevity, the above disclosure in connection with the robot 1 will not be repeated below, but it should be understood that across embodiments, like numbers represent like structures. In this embodiment, the robot 1001 is substantially the same as the first embodiment and includes an alternative upper and lower portion of the robot 1001.

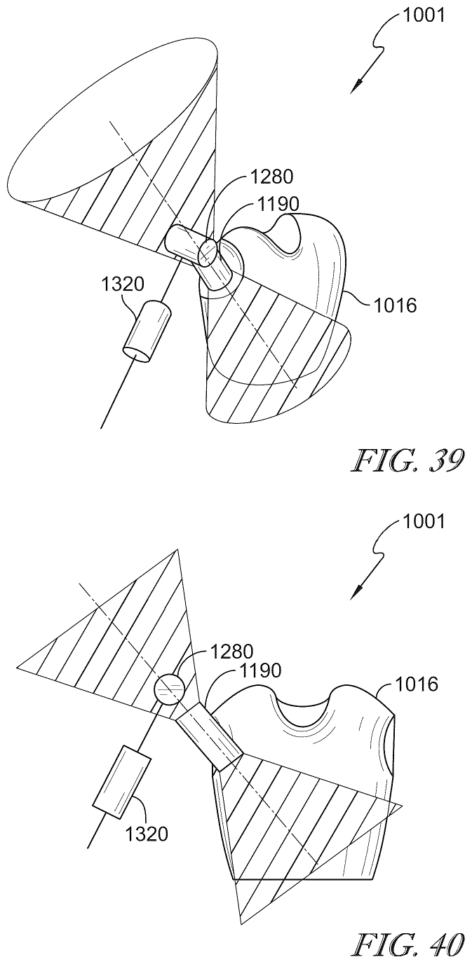

The kinematic chain and associated singularity cones for an upper portion of the second embodiment of an upper portion of the robot 1001 are shown in FIGS. 39-40. The schematic diagram shows the kinematic chain and arrangement of an arm actuator 1190 (J1), a shoulder actuator 1280 (J2), and an upper arm twist actuator 1320 (J3). In this embodiment, the arm actuator (J1) is positioned at an angle with respect to the coronal and sagittal planes, where the singularity cones surround the primary axis of the arm actuator (J1). FIG. 37 is a front view of a second embodiment of an upper portion of the robot 1001, which shows a kinematic map of the left arm of said robot with the arrangement of actuators shown in FIGS. 39-40. Further, FIG. 38 is a schematic of the movement limits of the left arm actuator (J1) and the left shoulder actuator (J2) of the second embodiment of the robot shown in FIG. 37.

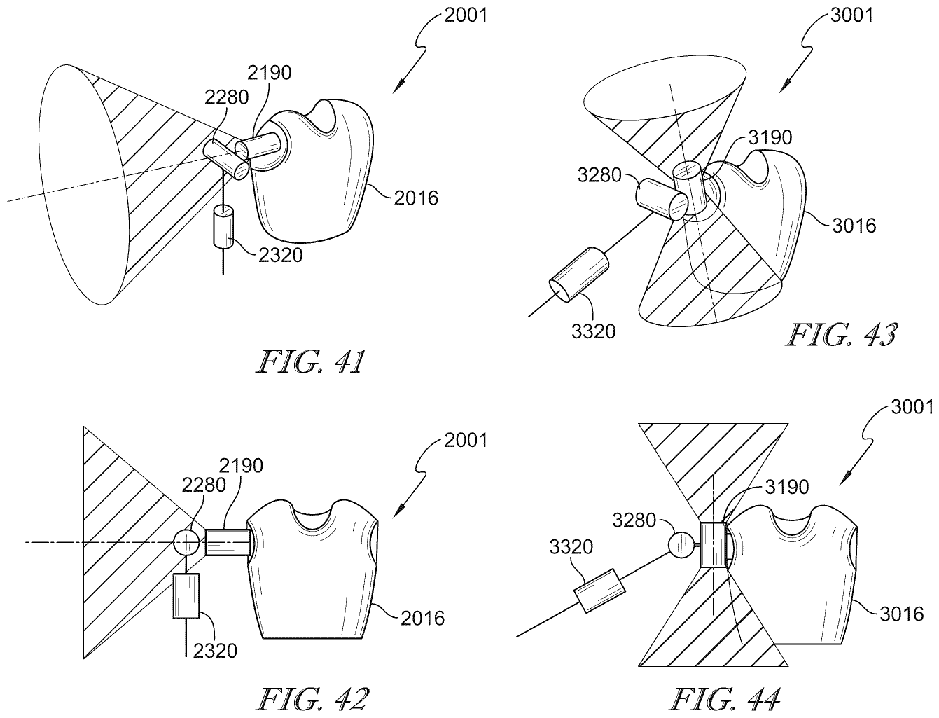

In FIGS. 41-42, a third embodiment of an upper portion of the robot 2001 is shown. In this embodiment, the arm actuator (J1) extends with the primary axis parallel to the transverse plane, and the singularity cone shown surrounding the primary axis of the arm actuator (J1). The schematic diagram shows the kinematic chain and arrangement of arm actuator 2190 (J1), shoulder actuator 2280 (J2), and upper arm twist actuator 2320 (J3).

In FIGS. 43-44, a fourth embodiment of an upper portion of a robot 3001 is shown. In this embodiment, the arm actuator (J1) is positioned with its primary axis parallel to the sagittal plane, and the singularity cones are shown surrounding the primary axis of the arm actuator (J1). The schematic diagram shows the kinematic chain and arrangement of an arm actuator 3190 (J1), a shoulder actuator 3280 (J2), and an upper arm twist actuator 3320 (J3).

b. Alternative Embodiments-Central and Lower Portions

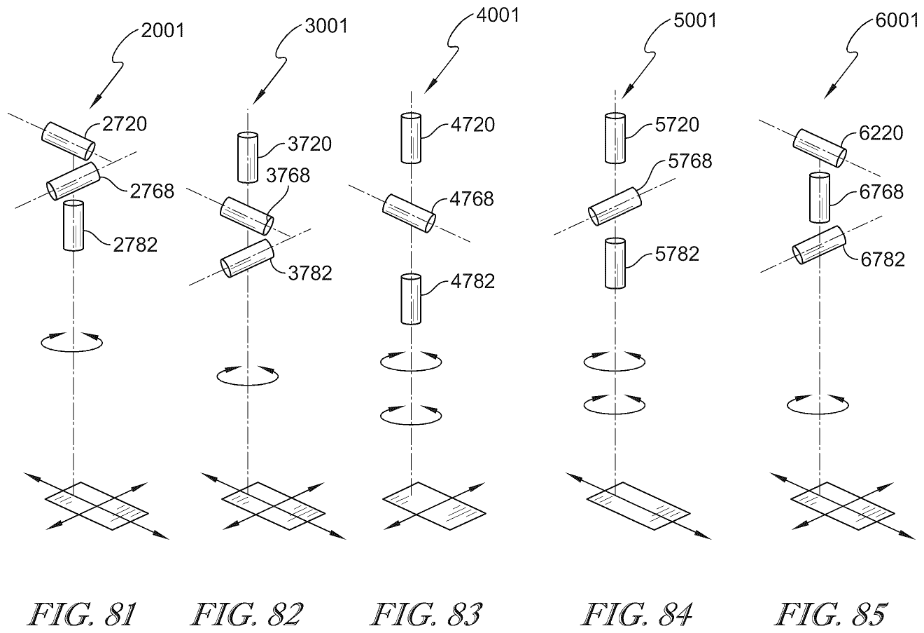

As shown in FIGS. 76-80, a second embodiment of a robot 1001 is adapted for an alternative arrangement of actuators J1-J16. In this embodiment, an axis of the hip pivot actuator (J12) is parallel (e.g., not angled) with the horizontal or transverse plane P_{T}. Similarly, FIGS. 81-85 show alternative kinematic chains to replace the leg arrangement shown in FIGS. 76-77 for the third through seventh embodiments of robots 2001, 3001, 4001, 5001, and 6001. Any of a variety of alternative configurations of robots is possible and is considered within the scope of the present disclosure.

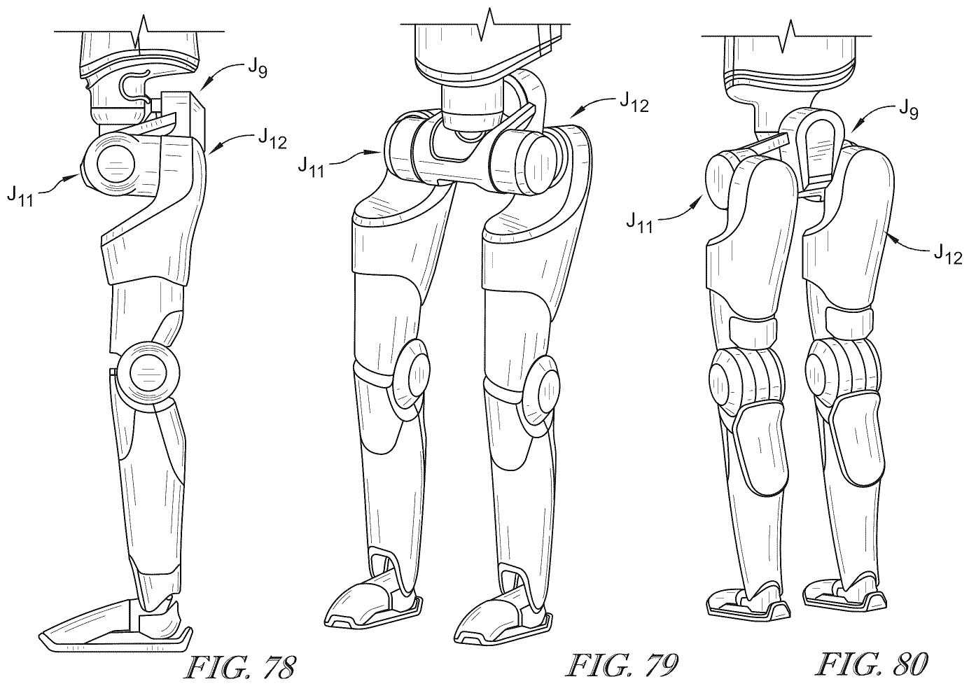

FIGS. 78-80 illustrate left side views of the second embodiment of a humanoid robot 1001 that has horizontal plane axes of hip roll actuators J12′, in comparison to the robot of FIGS. 48-49 that has angled-down axes of hip roll actuators J12. FIG. 78 illustrates a side view of the torso, shoulders, head, hips, and left leg of an embodiment of a humanoid robot. FIG. 79 illustrates a side front perspective view of the hip and left leg, and FIG. 80 illustrates a side rear perspective view of the hip and left leg. The actuators of the robot can be concealed with covers that can prevent objects from interfering with the operation of the actuators. Adjacent covers can have movement seams that can allow the rotational actuators to move without exposing any of the internal components.

Focusing on the left side components shown in the figures, the hip pitch actuator J11′ can be coupled to a left side of the hip frame, the hip roll actuator J12′ can be coupled behind the hip pitch actuator J11′ with the hip roll actuator at a 90 degree horizontal angle relative to the hip pitch actuator. The rotational axis of the leg yaw actuator J13′ can be 90 degrees from the rotational axis of the hip pitch actuator J11′ In contrast, in the above-described robot 1 of FIG. 48, the hip assembly can have the hip pivot actuators 768 (J12) angled downward from horizontal by about 18 degrees, or angled down at an angle between about 12 degrees and about 22 degrees. Thus, the normal rotational angle of the hip pivot actuators 768 (J12) can be about 72 degrees, or between about 68 degrees and about 78 degrees, from vertical. As noted above, the downward angling of the hip pivot actuators 768 (J12) can be beneficial to the performance of the robot 1 and can allow the torso 16 to be moved lower, which can allow the robot 1 to pick up packages from the ground. This angled or lower position of the hip pivot actuators 768 (J12) can also allow the legs 6 to move further in flexion rearward.

When in a squatting position with both feet on the ground, the hip flex actuators 720 (J11) can rotate at least about 160 degrees forward and upward so the leg 6 moves from a vertical orientation that extends straight down from the torso 16 to a position that extends upward where the angle between the center axis of the upper leg and the spine of the torso 16 can be about 20 degrees or less. When the upper leg moves close to the torso housing, the hip pivot actuators 768 (J12) can move the legs 6 outward at an angle of at least about 20 degrees or more from a vertical plane that extends through a left side/right side centerline of the torso 16.

FIGS. 76-77 illustrate the second embodiment of a humanoid robot 1001 that has a hip assembly that includes a hip frame coupled to left and right X-axis (roll), Y-axis (pitch), and Z-axis (yaw) rotational hip actuators. In the illustrated embodiment, Y-axis hip actuators can be coupled to the left and right sides of the hip frame, X-axis hip actuators can be coupled to a lower back portion of the Y-axis hip actuators. The Z-axis hip actuators can be coupled between the X-axis hip actuators and the upper thigh portions of the legs. Thus, the hips can move in 3 degrees of freedom. Because the Z-axis hip actuators can be coupled to the upper thigh portions of the legs, the legs can have a greater range of motion. In contrast, the robot may only require X-axis and Z-axis spine actuators for 2 degrees of freedom because the Y-axis hip actuators can perform the function of the missing Y-axis spine actuator. The omission of the Y-axis spine actuator can reduce the weight of the robot by 1-2 kilograms in some embodiments. This configuration can allow the torso volume to be much larger so that more electrical equipment can be placed in the torso housing. The larger torso volume can allow more batteries to be carried by the robot, which can allow the robot to run longer before the batteries need to be recharged. The additional batteries can allow more electrical current to be applied to the robot actuators, which can result in more actuator output force and a stronger robot.

The hip assembly can have a hip frame, a right hip portion, a left hip portion, and a spine portion. The right hip portion can include actuators that are coupled to the right side of the hip frame, and the left hip portion can include actuators that are coupled to the left side of the hip frame. The right hip and left hip portions can also each have a hip roll (X-axis) actuator J12, a hip pitch (Y-axis) actuator J11, and a hip yaw (Z-axis) actuator J13. The hip pitch actuators J11 can be coupled between the hip frame and the hip roll actuators J12. The hip yaw actuators J13 can be coupled to the bottoms or distal portions of the hip roll actuators J12.

The movements of the robot legs in space can depend on whether the leg is in contact with the ground and supporting the weight of the robot or if the leg is not in contact with the ground and the leg is free to move. When the leg is not supporting the robot weight, actuation of the connected X-axis hip roll actuator J12 can cause the robot leg to move in abduction and adduction. If the leg is supporting the weight of the robot, actuation of the connected X-axis hip roll actuator J12 can cause the torso of the robot to move in lateral flexion.

FIG. 76 illustrates a front view and FIG. 77 illustrates a perspective rear view of the second embodiment of a robot 1001. FIG. 76 illustrates the Y-axis hip pitch actuators J11 on the left and right sides of the hip frame, the Z-axis hip yaw actuators J13 below the left and right sides of the hip frame, and the Z-axis spine twist actuator J10 above the center portion of the spine frame. FIG. 77 illustrates the X-axis hip roll actuators J12 behind the Y-axis hip pitch actuators J11 and the Z-axis hip yaw actuators J13 below the X-axis and Y-axis hip actuators J12 and J11. FIG. 77 also illustrates the X-axis spine roll actuator J9 behind the Z-axis spine twist actuator J10. The axis of rotation of the Z-axis spine twist actuator J10 can be parallel to an axial vertical centerline of the robot and in a center vertical plane that divides the left and right portions of the robot. A horizontal plane can be perpendicular to the axial vertical centerline of the robot and parallel with a flat ground surface that the robot can stand on.

In this embodiment, the left hip pitch Y-axis actuator J11 can move the left leg back, and the left hip roll X-axis actuator J12 can roll the torso relative to the left leg to balance the load of the robot over the left foot. The right hip pitch Y-axis actuator J11 can move the right leg forward, which is shown bent at the right knee. This described hip assembly motion can be part of a walking or running movement. Additionally, the X-axis right hip roll actuator J12 can be actuated to rotate the torso to the right to align the weight of the robot over the right foot when the right leg is vertical. The Z-axis right hip yaw actuator J13 can also rotate the right thigh portion of the right leg to control the orientation of the right foot. The left knee can be bent and the X-axis left hip roll actuator J12 can be actuated to move the left knee outward. When the right leg is nearly vertical and the left leg is bent at the knee, and the lower leg and foot are angled outward, the left hip pitch Y-axis actuator J11 rotates the upper leg up about 90 degrees. The left hip yaw Z-axis actuator J13 is moved to a horizontal orientation and the left hip yaw Z-axis actuator J13 is actuated to move the lower leg outward.

FIGS. 81-85 illustrate schematic representations of various configurations of rotational actuators in a robot hip joint assembly for alternative embodiment robots 2001, 3001, 4001, 5001, and 6001, respectively. The configuration of the rotational actuators in the hip joint assemblies in the above-described robots can result in better performance than other rotational actuator configurations. As discussed, the above-described embodiments of the hip assembly rotation actuators can include a Y-axis hip pitch actuator (J11) that is positioned above an X-axis hip roll actuator (J12), which is above a Z-axis hip yaw actuator J13. Other configurations of rotational actuators in the hip assembly can include:

TABLE 6

| | | Robot | Robot | Robot | Robot | Robot |
|---|---|---|---|---|---|---|
| Hip Joint | | 2001 | 3001 | 4001 | 5001 | 6001 |
| Assembly | Robot 1 | (FIG. 81) | (FIG. 82) | (FIG. 83) | (FIG. 84) | (FIG. 85) |
| Upper | Y-axis Pitch | X-axis | Z-axis | Z-axis | Z-axis | X-axis |
| Actuator | (J11) | Roll | Yaw | Yaw | Yaw | Roll |
| Middle | X-axis Roll | Y-axis | X-axis | X-axis | X-axis | Z-axis |
| Actuator | (J12) | Pitch | Roll | Roll | Roll | Yaw |
| Lower | Z-axis Yaw | Z-axis | Y-axis | Z-axis | Z-axis | Y-axis |
| Actuator | (J13) | Yaw | Pitch | 2nd Yaw | 2nd Yaw | Pitch |

Table 6 shows the actuator configurations of different hip joint assemblies for third through seventh alternative embodiments of robots 2001, 3001, 4001, 5001, and 6001, each of which has a different configuration of upper, middle, and lower rotational actuators. The singularity problems of these configurations that can result in movement limitations of the robot legs are discussed below.

The third embodiment of a robot 2001 is shown in FIG. 81 and illustrates a hip assembly that has an upper X-axis hip roll actuator 2720, a middle Y-axis hip pitch actuator 2768, and a lower Z-axis hip yaw actuator 2782. Singularity can occur when the leg is pitched forward and up by 90 degrees, so that the lower Z-axis hip yaw actuator becomes parallel and aligned with the X-axis hip roll actuator. In this singularity position, the leg no longer moves sideways in roll rotation.

The fourth embodiment of a robot 3001 is shown in FIG. 82 and illustrates a hip assembly that includes a z-axis of rotation hip yaw actuator 3720 above an x-axis of rotation hip roll actuator 3768, which is above a y-axis of rotation hip pitch actuator 3782. When the leg is vertical, rotation of the hip yaw actuator twists the foot, rotation of the hip roll actuator moves the foot sideways, and rotation of the hip pitch actuator moves the foot back and forth. The joints can intersect, but the vertical order of the x, y, and z-axis of rotation actuators can be important for improved performance.

FIG. 82 illustrates the leg in a straight down position. If the Y-axis pitch hip actuator is bent to raise the thigh portion of the leg and the Y-axis pitch knee actuator is bent to keep the foot parallel with the ground, the foot can be moved up and forward. Movement of the X-axis hip roll actuator can move the leg and foot sideways. The Y-axis pitch ankle actuator can be bent to keep the X-axis roll ankle actuator axis of rotation parallel to the ground. The X-axis roll ankle actuator can also be bent to keep the foot parallel with the ground. In this configuration, the foot does not twist.

The illustrated and described embodiments of humanoid robots can have various unique structural configurations that can provide benefits over known humanoid robots. For example, a joint of a robot can have three rotational actuators that can allow the connected limb to move in 3 degrees of freedom. The alignment of the X, Y, and Z axis rotational actuators can be angularly offset to be perpendicular to each other or configured to be 90 degrees from each other. A problem with a joint assembly that is formed from X, Y, and Z axis rotational actuators can be that the joint assembly can move into a configuration where the axes of rotation of two of the actuators are parallel or nearly parallel (e.g., can be within a cone of singularity that is about 30 to about 45 degrees from parallel). When two axes of rotation are nearly parallel, a “singularity” configuration occurs, which can limit and/or complicate the joint movements. The required angular offset or adjustment to avoid singularity (e.g., possibly about 30 to about 45 degrees) can be graphically represented as a “cone of singularity”.

Singularity can occur when the axis of rotation of multiple rotational actuators are aligned and/or parallel. In order to allow the limbs of the robot 1 to move freely, the normal range of movement of the limbs can be analyzed to determine if any of the normal robot limb movements might enter a cone of singularity and have a singularity movement problem. If a normal movement of a robot limb has a singularity problem, the position of one or more of the joint rotational actuators in a joint assembly design can be adjusted to prevent the axes of rotation from entering any cone of singularity of the other connected rotational actuators in the joint assembly.

As shown in FIG. 82, the hip assembly of the robot 3001 is not in a singularity configuration because each degree of freedom of the three rotational actuators moves the foot in a different direction and each of the three rotational actuators is independent of each other. In contrast, the hip assemblies of robot 4001 and robot 5001, which are illustrated in FIGS. 83 and 84, each have two actuators that are at singularity. In FIG. 83, the lower hip actuator 4782 has been rotated into a vertical Z-axis alignment that is parallel to the upper hip actuator 4720 (hip yaw z-axis of rotation), which is a singularity. Rotational movement of both the hip actuator 4720 and the hip actuator 4782 causes the foot to twist in a Z-axis yaw rotation. To move the foot forward, the hip actuator 4720 and the hip actuator 4782 must rotate so that the middle hip actuator 4768 is properly aligned so the middle hip actuator 4768 can rotate the leg in a y-axis pitch, as shown in FIG. 84.

However, it is possible to move the hip assembly of the robot 3001 (FIG. 82) into a singularity configuration. For example, the hip roll actuator can rotate the lower leg and foot in a roll of 90 degrees, which causes the lower leg to rotate into a horizontal position. In this rolled position, the Y-axis pitch actuator has moved to a position that is aligned vertically to be parallel or near-parallel to the vertical Z-axis yaw actuator. In this singularity position, none of the actuators can twist in rotation. Ideally, the leg should not be moved in an X-axis roll rotation to cause the Y-axis pitch actuator to be moved to a position that is within about 30 degrees to about 45 degrees of vertical, so as to be near parallel to the vertical Z-axis yaw actuator. As noted above in connection with the embodiment of FIG. 48, one way to avoid this issue is to limit the amount of X-axis roll rotation to avoid the singularity configuration (e.g., provide only up to about 45 degrees of roll rotation).

As also discussed above, in some embodiments the X-axis hip roll actuators (J12) can be angled downward from horizontal by between about 12 degrees and about 22 degrees. This adjustment to the hip joint assembly can be done to prevent the axes from entering a cone of singularity. Using joint assemblies with these adjustments, robot limbs can have unhindered movement, range of motion, and performance.

The seventh embodiment of a robot 6001 is shown in FIG. 85 and illustrates a hip joint assembly that has an upper X-axis roll actuator, a middle Z-axis yaw actuator, and a lower Y-axis pitch actuator. FIG. 85 also illustrates a diagram that shows up, right, and front directions for the leg. FIG. 85 shows the hip assembly rotating the leg 90 degrees in a Z-axis yaw, which rotates the lower Y-axis pitch actuator into a parallel orientation to the X-axis roll actuator, which is a singularity configuration. The robot 6001 can encounter a problem because when the foot is rotated in the above-described manner, the leg cannot be moved forward to backward in pitch for a walking movement.

### 13. Industrial Application

While the disclosure shows illustrative embodiments of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods and systems. Additionally, one or more steps from the arrangement of components may be omitted or performed in a different order. Accordingly, the drawings, diagrams, and detailed description are to be regarded as illustrative in nature, not restrictive or limiting, of the said humanoid robot.

While the above-described robot is designed as a head for use with a general-purpose humanoid robot, it should be understood that its assemblies, components, learning capabilities, and/or kinematic capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

It should also be understood that substantially utilized herein means a deviation less than 15% and preferably less than 5%. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. A method of obtaining compensation for tasks performed by a humanoid robot associated with a first party, said method comprising the steps of:
a first party provides a humanoid robot for use at an operating location;
a humanoid robot engages in performing a plurality of tasks at the operating location; and
the first party is compensated with a specified amount of currency for a pre-determined time interval during which said humanoid robot is located at the operating location.

2. (canceled)

3. (canceled)

4. (canceled)

5. (canceled)

6. The method of claim 1, wherein the humanoid robot includes: (i) a torso, (ii) an arm actuator coupled to the torso and having: (a) a proximal end, (d) a distal end, and (c) an arm axis, and (iii) a transverse plane, and
wherein the arm axis is angled upward in relation to the transverse plane, therefore causing a portion of the distal end of the arm actuator to be positioned higher than a portion of the proximal end of the arm actuator when humanoid robot is in neutral position.

7. The method of claim 6, wherein the arm axis is angled rearward in relation to the coronal plane, therefore causing a portion of the distal end of the arm actuator to be positioned rearward than a portion of the proximal end of the arm actuator when humanoid robot is in neutral position.

8. The method of claim 1, wherein the humanoid robot further comprises a upper arm twist actuator with an upper arm twist axis and a lower arm twist actuator with a lower arm twist axis, and wherein the upper arm twist axis is co-linear with the lower arm twist axis, when the humanoid robot is in the extended position.

9. The method of claim 8, wherein the humanoid robot further comprises an elbow actuator with an elbow axis, and wherein the elbow axis is offset from a line that extends between the upper arm twist axis and the lower arm twist axis.

10. The method of claim 1, wherein the humanoid robot includes a left arm that has a singularity that is positioned above a transverse plane.

11. The method of claim 1, wherein the humanoid robot includes a left leg that is interchangeable with a right leg.

12. The method of claim 1, wherein the humanoid robot includes a number of degrees of freedom NDoF and an upper portion of the humanoid robot, wherein the upper portion includes: (a) a head and neck assembly, (b) an upper portion of a torso, (c) a left arm assembly, (d) a right arm assembly, (e) a left hand, and (f) a right hand, and wherein said upper portion of the humanoid robot includes more than 70% of the NDoF.

13. The method of claim 1, wherein the humanoid robot includes a torso is configured to house a battery that is capable of providing the humanoid robot for a minimum of 4 hours of operational time.

14. The method of claim 1, wherein the humanoid robot includes a hip pivot actuator having a hip pivot axis, and wherein an interior acute angle is formed between said hip pivot axis and a transverse plane of the humanoid robot, when the robot is in the extended position.

15. (canceled)

16. The method of claim 1, wherein the humanoid robot comprises: (i) a leg twist actuator that is positioned a first distance from a support surface, and (ii) both of a hip pivot actuator and a hip flex actuators are positioned at least a second distance from the support surface; and
wherein the first distance is less than the second distance.

17. (canceled)

18. (canceled)

19. A method of obtaining compensation for tasks performed by a humanoid robot associated with a first party, said method comprising the steps of:
a first party manufactures, assembles, or acquires a humanoid robot; and
the first party is compensated with a specified amount of currency for use of the humanoid robot.

20. (canceled)

21. (canceled)

22. (canceled)

23. The method of claim 19, wherein the humanoid robot includes at least two head actuators that are positioned within a deformable cover.

24. The method of claim 19, wherein the humanoid robot includes at least four actuators that have momentary peak torques that are greater than 298 Nm.

25. The method of claim 19, wherein the humanoid robot includes: (i) sensors that capture natural language and contextual information, and (ii) at least one algorithm that processes the captured natural language and contextual information to generate an appropriate response.

26. The method of claim 19, wherein the humanoid robot includes an arm having an arm length and a leg having a leg length, and wherein the arm length is greater than 80% of the leg length.

27. The method of claim 19, wherein the humanoid robot only includes two singularities.

28. The method of claim 19, wherein the humanoid robot includes a hip pivot actuator having a hip pivot axis, and wherein an interior acute angle is formed between said hip pivot axis and a transverse plane of the humanoid robot, when the robot is in the extended position.

29. The method of claim 19, wherein the humanoid robot includes a left arm that has a singularity that is positioned above a transverse plane.

30. The method of claim 19, wherein the humanoid robot includes: (i) a total degrees of freedom, (ii) an upper portion, (iii) a central portion, and (iv) a lower portion, and wherein the lower portion includes substantially 6% or less of the total degrees of freedom contained in the humanoid robot.

31. The method of claim 19, wherein the humanoid robot includes at least 36 electric actuators, and wherein a majority of the actuators have a momentary peak torque that is greater than 81 Nm.
